(19) United States
(12) Patent Application Publication
(10) Pub. No.: US 2016/0249056 A1
(43) Pub. Date: Aug. 25, 2016

(54) IMAGE DECODING DEVICE, IMAGE CODING DEVICE, AND CODED DATA

(71) Applicant: SHARP KABUSHIKI KAISHA, Osaka (JP)

(72) Inventors: Takeshi TSUKUBA, Osaka-shi (JP); Tomoyuki YAMAMOTO, Osaka-shi (JP); Tomohiro IKAI, Osaka-shi (JP)

(21) Appl. No.: 15/027,289

(22) PCT Filed: Oct. 8, 2014
(86) PCT No.: PCT/JP2014/076980

§ 371 Date: Apr. 5, 2016

(30) Foreign Application Priority Data
Oct. 10, 2013 (JP) 2013-213079
Oct. 18, 2013 (JP) 2013-217572
Nov. 7, 2013 (JP) 2013-231338

(51) Int. Cl. H04N 19/159; H04N 19/187; H04N 19/172; H04N 19/174

(52) U.S. Cl. CPC H04N 19/159; H04N 19/174; H04N 19/187; H04N 19/172

(57) ABSTRACT

In a case of applying a shared parameter set between layers in a certain layer set, there occurs an undecodable layer on a bitstream that is generated by a bitstream extraction process from a bitstream including the layer set and that includes only a subset layer set of the layer set.

According to an aspect of the present invention, a bitstream constraint and a dependency relationship between layers that use a shared parameter set are defined in a case of applying a shared parameter set between layers in a certain layer set.

### TECHNICAL FIELD

The present invention relates to an image decoding device decoding hierarchically coded data in which an image is hierarchically coded and to an image coding device hierarchically coding an image to generate hierarchically coded data.

### BACKGROUND ART

One of the types of information transmitted in a communication system or information recorded in a storage device is an image or a moving image. In the related art, there is known an image coding technology for transmission or storage of these images (hereinafter, include a moving image).

As a moving image coding scheme, there is known H.264/MPEG-4 advanced video coding (AVC) or high-efficiency video coding (HEVC) as a follow-up codec thereof (NPL 1).

In these moving image coding schemes, generally, a predicted image is generated on the basis of a locally decoded image obtained by coding/decoding an input image, and a prediction residual (referred to as “difference image” or “residual image”) obtained by subtracting the predicted image from the input image (source image) is coded. A method for generating the predicted image is exemplified by inter-frame prediction (inter prediction) and intra-frame prediction (intra prediction).

HEVC uses a technology that realizes temporal scalability assuming a case of performing reproduction at a temporally decimated frame rate such as a case of reproducing a 60 fps content at 30 fps. Specifically, each picture is assigned a numerical value called a temporal identifier (TemporalId; sub-layer identifier), and a constraint that a picture having a greater temporal identifier does not reference a picture having a smaller temporal identifier than the temporal identifier is placed. Accordingly, in a case of performing reproduction by decimating only pictures having a specific temporal identifier, pictures that are assigned a temporal identifier greater than the specific temporal identifier are not required to be decoded.

In recent years, there has been suggested a scalable coding technology or a hierarchical coding technology that hierarchically codes an image according to a necessary data rate. Scalable HEVC (SHVC) and multiview HEVC (MV-HEVC) are known representative scalable coding schemes.

SHVC supports spatial scalability, temporal scalability, and SNR scalability. For example, in a case of spatial scalability, an image that is downsampled from a source image to a desired resolution is coded as a lower layer. Then, inter-layer prediction is performed in a higher layer to remove inter-layer redundancy (NPL 2).

MV-HEVC supports view scalability. For example, in a case of coding three viewpoint images including a viewpoint image 0 (layer 0), a viewpoint image 1 (layer 1), and a viewpoint image 2 (layer 2), inter-layer redundancy can be removed by predicting higher layers of the viewpoint image 1 and the viewpoint image 2 from a lower layer (layer 0) using inter-layer prediction (NPL 3).

Types of inter-layer prediction used in the scalable coding schemes such as SHVC and MV-HEVC include inter-layer image prediction and inter-layer motion prediction. In inter-layer image prediction, a target layer predicted image is generated by using texture information (image) of a previously decoded lower layer (or another layer different from the target layer) picture. In inter-layer motion prediction, a predicted value of target layer motion information is derived by using motion information of a previously decoded lower layer (or another layer different from the target layer) picture. That is, inter-layer prediction is performed by using a previously decoded lower layer (or another layer different from the target layer) picture as a target layer reference picture.

In addition to inter-layer prediction that removes inter-layer redundancy in image information or motion information, inter parameter set prediction that predicts (references or inherits) a part of coding parameters in a parameter set used for higher layer decoding/coding from a corresponding coding parameter in a parameter set used in lower layer decoding/coding to omit decoding/coding of the coding parameter is performed in order to remove inter-layer redundancy in common coding parameters in a parameter set (for example, a sequence parameter set SPS or a picture parameter set PPS) in which a set of coding parameters required for decoding/coding of coded data is defined. For example, there is a technology (referred to as inter parameter set syntax prediction) that predicts target layer scaling list information (quantization matrix) notified by an SPS or a PPS from lower layer scaling list information.

In a case of view scalability or SNR scalability, there is a technology called a shared parameter set that removes inter-layer redundancy in side information (parameter set) by using a common parameter set between different layers since many common coding parameters are included in a parameter set used in decoding/coding of each layer. For example, in NPL 2 and NPL 3, use of an SPS or a PPS that is used in decoding/coding of a lower layer having a layer identifier value nuhLayerIdA (layer identifier value of the parameter set is also nuhLayerIdA) is allowed in decoding/coding of a higher layer having a layer identifier value (nuhLayerIdB) greater than nuhLayerIdA. A layer identifier (nuh_layer_id; also referred to as layerId or lId) for identification of a layer, a temporal identifier (nuh_temporal_id_plus1; also referred to as temporalId or tId) for identification of a sub-layer belonging to a layer, and an NAL unit type (nal_unit_type) that represents the type of coded data stored in an NAL unit are notified by an NAL unit header in an NAL unit in which coded data of an image and coded data of a parameter set such as coding parameters are stored.

### CITATION LIST

### Non Patent Literature

NPL 1: “Recommendation H.265 (04/13)”, ITU-T (published on Jun. 7, 2013)
NPL 2: JCTVC-N1008 v3 “SHVC Draft 3”, Joint Collaborative Team on Video Coding (JCT-VC) of ITU-T SG16 WP3 and ISO/IEC JTC 1/SC 29/WG 11 14th Meeting: Vienna, AT, Jul. 25 to Aug. 2, 2013 (published on Aug. 20, 2013)
NPL 3: JCT3V-E1008 v5 “MV-HEVC Draft Text 5”, Joint Collaborative Team on 3D Video Coding Extension Development of ITU-T SG16 WP3 and ISO/IEC JTC 1/SC 29/WG 11 5th Meeting: Vienna, AT, Jul. 27 to Aug. 2, 2013 (published on Aug. 7, 2013)

### SUMMARY OF INVENTION

### Technical Problem

However, the following problems arise in a case where a parameter set such as a sequence parameter set (SPS) or a picture parameter set (PPS) in the technology of the related art is shared between a plurality of layers (shared parameter set).

(1) Given that a bitstream is configured of a layer A having a layer identifier value nuhLayerIdA and a layer B having a layer identifier value nuhLayerIdB, if a bitstream configured of only coded data of the layer B is extracted by bitstream extraction that destroys coded data of the layer A, a parameter set (having a layer identifier value nuhLayerIdA) of the layer A required for decoding of the layer B may be destroyed. In this case, a problem arises in that the extracted coded data of the layer B cannot be decoded.

More specifically, assume a bitstream that includes a layer set A {nuhLayerId0, nuhLayerId1, nuhLayerId2} configured of a layer 0 (nuhLayerId0 in FIG. 1(a)), a layer 1 (nuhLayerId1 in FIG. 1(a)), and a layer 2 (nuhLayerId2 in FIG. 1(a)) respectively having layer identifier values nuhLayerId0, nuhLayerId1, and nuhLayerId2 as illustrated in FIG. 1(a). Furthermore, assume that a dependency relationship between the layers in the layer set A is such that, as illustrated in FIG. 1(a), each of the layer 1 and the layer 2 is dependent on the layer 0 as a reference layer of inter-layer prediction (inter-layer image prediction or inter-layer motion prediction) (solid arrows in FIG. 1) and that the layer 2 references a parameter set (SPS or PPS) having a layer identifier value nuhLayerId1 and used in decoding of the layer 1 in decoding of the layer 2 (double dashed arrow in FIG. 1).

A sub-bitstream that includes only a layer set B {nuhLayerId0, nuhLayerId2}, a subset of the layer set A, is extracted from the bitstream including the layer set A {nuhLayerId0, nuhLayerId1, nuhLayerId2} on the basis of the layer ID {nuhLayerId0, nuhLayerId2} (bitstream extraction) (FIG. 1(b)). However, since the parameter set (SPS, PPS, or the like) that has a layer identifier value nuhLayerId1 and is used at a time of decoding coded data of the layer 2 (nuhLayerId2) in the layer set B does not exist in the extracted bitstream, it may occur that the coded data of the layer 2 cannot be decoded.

(2) A layer in which the parameter set of the layer A having a layer identifier value nuhLayerIdA is used in common (a layer to which a shared parameter set is applied) is not known until the start of decoding of the coded data. Thus, a problem arises in that a parameter set of a layer ID that is to be decoded or extracted is not known in a case where only coded data of a certain layer ID (or layer set) is decoded or extracted.

The present invention is conceived in view of the above problems, and an object thereof is to realize an image decoding device and an image coding device that define a bitstream constraint and a dependency relationship between layers using a shared parameter set in a case of applying a shared parameter set between layers in a certain layer set and that prevent occurrence of an undecodable layer on a bitstream which is generated by a bitstream extraction process from a bitstream including the layer set and which includes only a subset layer set of the layer set.

### Solution to Problem

In order to resolve the above problems, an image decoding device according to an aspect of the present invention is an image decoding device that decodes hierarchical image coded data including a plurality of layers, the device including parameter set decoding means for decoding a parameter set, slice header decoding means for decoding a slice header, and active parameter set specifying means for specifying an active parameter set from the parameter set on the basis of an active parameter set identifier that is included in the slice header or the parameter set, in which a layer identifier of the active parameter set is a layer identifier of a target layer or a dependent layer of a target layer.

### Advantageous Effects of Invention

According to an aspect of the present invention, a bitstream constraint and a dependency relationship between layers using a shared parameter set can be defined in a case of applying a shared parameter set between layers in a certain layer set, and occurrence of an undecodable layer on a bitstream that is generated by a bitstream extraction process from a bitstream including the layer set and that includes only a subset layer set of the layer set can be prevented.

### BRIEF DESCRIPTION OF DRAWINGS

FIG. 1 is a diagram illustrating an example of a problem arising at a time of extracting a layer set B, a subset of a layer set A, from a bitstream including the layer set A. FIG. 1(a) illustrates an example of the layer set A, and FIG. 1(b) illustrates an example of the layer set B after bitstream extraction.

FIG. 2 is a diagram illustrating a layer structure of hierarchically coded data according to an embodiment of the present invention. FIG. 2(a) illustrates a hierarchical moving image coding device side, and FIG. 2(b) illustrates a hierarchical moving image decoding device side.

FIG. 3 is a diagram illustrating a structure of layers and sub-layers (temporal layers) constituting a layer set.

FIG. 4 is a diagram illustrating layers and sub-layers (temporal layers) constituting a subset of a layer set extracted by a bitstream extraction process from the layer set illustrated in FIG. 3.

FIG. 5 is a diagram illustrating an example of a data structure constituting an NAL unit layer.

FIG. 6 is a diagram illustrating an example of syntax included in the NAL unit layer. FIG. 6(a) illustrates an example of syntax constituting the NAL unit layer, and FIG. 6(b) illustrates an example of syntax of an NAL unit header.

FIG. 7 is a diagram illustrating a relationship between NAL unit type values and NAL unit types according to the embodiment of the present invention.

FIG. 8 is a diagram illustrating an example of an NAL unit configuration included in an access unit.

FIG. 9 is a diagram illustrating a configuration of hierarchically coded data according to the embodiment of the present invention. FIG. 9(a) is a diagram illustrating a sequence layer predefining a sequence SEQ, FIG. 9(b) is a diagram illustrating a picture layer defining a picture PICT, FIG. 9(c) is a diagram illustrating a slice layer defining a slice S, FIG. 9(d) is a diagram illustrating a slice data layer defining slice data, FIG. 9(e) is a diagram illustrating a coding tree layer defining a coding tree unit included in the slice data, and FIG. 9(f) is a diagram illustrating a coding unit layer defining a coding unit (CU) included in the coding tree.

FIG. 10 is a diagram illustrating a shared parameter set according to the present embodiment.

FIG. 11 is a diagram illustrating a reference picture list and a reference picture. FIG. 11(a) is a conceptual diagram illustrating an example of a reference picture list, and FIG. 11(b) is a conceptual diagram illustrating an example of a reference picture.

FIG. 12 is an example of a VPS syntax table according to the embodiment of the present invention.

FIG. 13 is an example of a VPS extension data syntax table according to the embodiment of the present invention.

FIG. 14 is a diagram illustrating a layer dependency type according to the present embodiment. FIG. 14(a) illustrates an example of a dependency type including the presence of non-VCL dependency, and FIG. 14(b) illustrates an example of a dependency type including the presence of a shared parameter set and the presence of inter parameter set prediction.

FIG. 15 is an example of an SPS syntax table according to the embodiment of the present invention.

FIG. 16 is an example of an SPS extension data syntax table according to a technology of the related art.

FIG. 17 is an example of a PPS syntax table according to the embodiment of the present invention.

FIG. 18 is an example of a slice layer syntax table according to the embodiment of the present invention. FIG. 18(a) illustrates an example of a syntax table of a slice header and slice data included in a slice layer, FIG. 18(b) illustrates an example of a slice header syntax table, and FIG. 18(c) illustrates an example of a slice data syntax table.

FIG. 19 is a schematic diagram illustrating a configuration of a hierarchical moving image decoding device according to the present embodiment.

FIG. 20 is a schematic diagram illustrating a configuration of a target layer set picture decoding unit according to the present embodiment.

FIG. 21 is a flowchart illustrating operation of a picture decoding unit according to the present embodiment.

FIG. 22 is a schematic diagram illustrating a configuration of a hierarchical moving image decoding device according to the present embodiment.

FIG. 23 is a schematic diagram illustrating a configuration of a target layer set picture decoding unit according to the present embodiment.

FIG. 24 is a flowchart illustrating operation of a picture decoding unit according to the present embodiment.

FIG. 25 is a diagram illustrating a configuration of a transmission apparatus on which the hierarchical moving image coding device is mounted and a configuration of a reception apparatus on which the hierarchical moving image decoding device is mounted. FIG. 25(a) illustrates a transmission apparatus on which the hierarchical moving image coding device is mounted, and FIG. 25(b) illustrates a reception apparatus on which the hierarchical moving image decoding device is mounted.

FIG. 26 is a diagram illustrating a configuration of a recording apparatus on which the hierarchical moving image coding device is mounted and a configuration of a reproduction apparatus on which the hierarchical moving image decoding device is mounted. FIG. 26(a) illustrates a recording apparatus on which the hierarchical moving image coding device is mounted, and FIG. 26(b) illustrates a reproduction apparatus on which the hierarchical moving image decoding device is mounted.

FIG. 27 is a modification example of the slice header syntax table according to the embodiment of the present invention.

FIG. 28 is a modification example of the PPS syntax table according to the embodiment of the present invention.

FIG. 29 is an example of an SPS extension data syntax table according to the embodiment of the present invention. FIG. 29(a) is an example of inter-layer pixel correspondence information according to the embodiment of the present invention, and FIG. 29(b) is a modification example of the inter-layer pixel correspondence information.

FIG. 30 is a diagram illustrating a relationship among a target layer picture, a reference layer picture, and inter-layer pixel correspondence offsets. FIG. 30(a) illustrates an example in which the entire reference layer picture corresponds to a part of a target layer picture, and FIG. 30(b) illustrates an example in which a part of a reference layer picture corresponds to the entire target layer picture.

FIG. 31 is a diagram illustrating an indirect reference layer.

### DESCRIPTION OF EMBODIMENTS

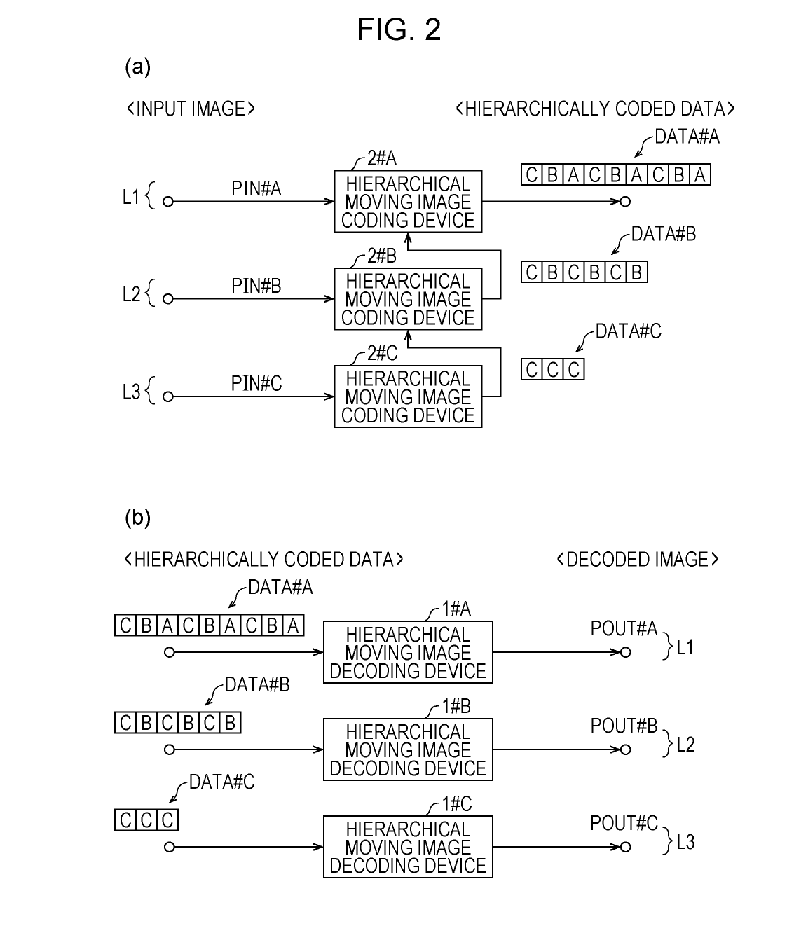

A hierarchical moving image decoding device 1 and a hierarchical moving image coding device 2 according to an embodiment of the present invention will be described below on the basis of FIG. 2 to FIG. 31.

### SUMMARY

The hierarchical moving image decoding device (image decoding device) 1 according to the present embodiment decodes coded data that is hierarchically coded by the hierarchical moving image coding device (image coding device) 2. Hierarchical coding refers to a coding scheme that hierarchically codes a moving image from low quality to high quality. Hierarchical coding is standardized in, for example, SVC or SHVC. The quality of a moving image referred hereto widely means elements that affect the subjective and objective look of a moving image. Examples of the quality of a moving image include “resolution”, “frame rate”, “definition”, and “pixel representation accuracy”. Thus, hereinafter, the quality of a moving image being different will illustratively indicate difference in “resolution” or the like, though the present embodiment is not limited to this. For example, the quality of a moving image is said to be different in a case of quantizing the moving image in different quantization steps (that is, in a case of coding the moving image with different coding noises).

A hierarchical coding technology may be classified into (1) spatial scalability, (2) temporal scalability, (3) signal-to-noise ratio (SNR) scalability, and (4) view scalability from the viewpoint of types of information hierarchized. Spatial scalability refers to a hierarchization technology with respect to a resolution or the size of an image. Temporal scalability refers to a hierarchization technology with respect to a frame rate (number of frames in a unit time). SNR scalability refers to a hierarchization technology with respect to a coding noise. View scalability refers to a hierarchization technology with respect to a viewpoint position associated with each image.

Prior to detailed descriptions of the hierarchical moving image coding device 2 and the hierarchical moving image decoding device 1 according to the present embodiment, (1) a layer structure of hierarchically coded data generated by the hierarchical moving image coding device 2 and decoded by the hierarchical moving image decoding device 1 will be first described, and (2) a specific example of a data structure usable in each layer will be described next.

[Layer Structure of Hierarchically Coded Data]

Coding and decoding of hierarchically coded data will be described below by using FIG. 2. FIG. 2 is a diagram schematically illustrating a case of hierarchically coding/decoding a moving image in three layers of a lower layer L3, an intermediate layer L2, and a higher layer L1. That is, in the example illustrated in FIGS. 2(a) and 2(b), the higher layer L1 of the three layers is the highest layer, and the lower layer L3 is the lowest layer.

Hereinafter, a decoded image that corresponds to specific quality decodable from hierarchically coded data will be referred to as a decoded image in a specific layer (or a decoded image corresponding to a specific layer) (for example, a decoded image POUT#A in the higher layer L1).

FIG. 2(a) illustrates hierarchical moving image coding devices 2#A to 2#C that respectively and hierarchically code input images PIN#A to PIN#C to generate coded data DATA#A to DATA#C. FIG. 2(b) illustrates hierarchical moving image decoding devices 1#A to 1#C that respectively decode the hierarchically coded data DATA#A to DATA#C to generate decoded images POUT#A to POUT#C.

First, the coding device side will be described by using FIG. 2(a). The input images PIN#A, PIN#B, and PIN#C that are input on the coding device side have the same source image but have different quality (resolution, frame rate, definition, and the like). The quality of the images decreases in order of the input images PIN#A, PIN#B, and PIN#C.

The hierarchical moving image coding device 2#C in the lower layer L3 codes the input image PIN#C in the lower layer L3 to generate the coded data DATA#C in the lower layer L3. The coded data DATA#C includes base information (indicated by “C” in FIG. 2) that is required for decoding of the decoded image POUT#C in the lower layer L3. Since the lower layer L3 is the lowest layer, the coded data DATA#C in the lower layer L3 is referred to as base coded data.

The hierarchical moving image coding device 2#B in the intermediate layer L2 codes the input image PIN#B in the intermediate layer L2 while referencing the lower layer coded data DATA#C to generate the coded data DATA#B in the intermediate layer L2. The coded data DATA#B in the intermediate layer L2 includes additional information (indicated by “B” in FIG. 2) that is required for decoding of the intermediate layer decoded image POUT#B, in addition to the base information “C” included in the coded data DATA#C.

The hierarchical moving image coding device 2#A in the higher layer L1 codes the input image PIN#A in the higher layer L1 while referencing the coded data DATA#B in the intermediate layer L2 to generate the coded data DATA#A in the higher layer L1. The coded data DATA#A in the higher layer L1 includes additional information (indicated by “A” in FIG. 2) that is required for decoding of the higher layer decoded image POUT#A, in addition to the base information “C” required for decoding of the decoded image POUT#C in the lower layer L3 and the additional information “B” required for decoding of the decoded image POUT#B in the intermediate layer L2.

As such, the coded data DATA#A in the higher layer L1 includes information related to decoded images of a plurality of different qualities.

Next, the decoding device side will be described with reference to FIG. 2(b). On the decoding device side, the decoding devices 1#A, 1#B, and 1#C that respectively correspond to the higher layer L1, the intermediate layer L2, and the lower layer L3 decode the coded data DATA#A, DATA#B, and DATA#C and output the decoded images POUT#A, POUT#B, and POUT#C.

A moving image can be reproduced at specific quality by extracting information about a part of the higher layer hierarchically coded data (called bitstream extraction) and decoding the extracted information in a specific lower layer decoding device.

For example, the hierarchical decoding device 1#B in the intermediate layer L2 may decode the decoded image POUT#B by extracting information required for decoding of the decoded image POUT#B (that is, “B” and “C” included in the hierarchically coded data DATA#A) from the hierarchically coded data DATA#A in the higher layer L1. In other words, on the decoding device side, the decoded images POUT#A, POUT#B, and POUT#C can be decoded on the basis of information that is included in the hierarchically coded data DATA#A in the higher layer L1.

Hierarchically coded data is not limited to the above three-layer hierarchically coded data and may be hierarchically coded in two layers or may be hierarchically coded in more than three layers.

Hierarchically coded data may be configured by coding a part of or the entirety of coded data related to a decoded image in a specific layer independently of other layers so that information about other layers is not referenced at a time of decoding the specific layer. For example, while “C” and “B” are referenced in decoding of the decoded image POUT#B in the example described by using FIGS. 2(a) and 2(b), the present embodiment is not limited to this. Hierarchically coded data may be configured in such a manner to enable decoding of the decoded image POUT#B using only “B”. For example, it is possible to configure a hierarchical moving image decoding device in which hierarchically coded data configured of only “B” and the decoded image POUT#C are input in decoding of the decoded image POUT#B.

In a case of realizing SNR scalability, hierarchically coded data can be generated in such a manner that the decoded images POUT#A, POUT#B, and POUT#C have different definition while the same source image is used as the input images PIN#A, PIN#B, and PIN#C. In this case, a lower layer hierarchical moving image coding device quantizes a prediction residual using a greater quantization range than a higher layer hierarchical moving image coding device to generate hierarchically coded data.

The following terms are defined in the present specification for convenience of description. The following terms are used to represent technical matters below unless otherwise specified.

VCL NAL unit: A video coding layer (VCL) NAL unit refers to an NAL unit that includes coded data of a moving image (video signal). For example, the VCL NAL unit includes slice data (coded data of a CTU) and header information (slice header) that is used in common through decoding of the slice.

Non-VCL NAL unit: A non-video coding layer (non-VCL) NAL unit refers to an NAL unit that includes coded data of header information or the like which is a set of coding parameters used at a time of decoding each sequence or picture, such as a video parameter set VPS, a sequence parameter set SPS, and a picture parameter set PPS.

Layer identifier: A layer identifier (referred to as a layer ID) is for identification of a layer and is in one-to-one correspondence with a layer. Hierarchically coded data includes an identifier that is used to select partially coded data required for decoding of a decoded image in a specific layer. A subset of hierarchically coded data that is correlated with a layer identifier corresponding to a specific layer is called a layer representation.

Generally, decoding of a decoded image in a specific layer uses a layer representation of the layer and/or a layer representation that corresponds to a lower layer below the layer. That is, decoding of a target layer decoded image uses a layer representation of a target layer and/or a layer representation of one or more layers included in the lower layers below the target layer.

Layer: A layer is a set of a VCL NAL unit having a layer identifier value (nuh_layer_id or nuhLayerId) of a specific layer and a non-VCL NAL unit correlated with the VCL NAL unit or is a set of syntax structures having a hierarchical relationship.

Higher layer: One layer that is positioned higher than another layer is referred to as a higher layer. For example, the intermediate layer L2 and the higher layer L1 in FIG. 2 are higher layers above the lower layer L3. A higher layer decoded image refers to a decoded image of higher quality (for example, high resolution, high frame rate, or high definition).

Lower layer: One layer that is positioned lower than another layer is referred to as a lower layer. For example, the intermediate layer L2 and the lower layer L3 in FIG. 2 are lower layers below the higher layer L1. A lower layer decoded image refers to a decoded image of lower quality.

Target layer: A target layer refers to a layer that corresponds to a decoding or coding target. A decoded image that corresponds to a target layer is called a target layer picture. A pixel that constitutes a target layer picture is called a target layer pixel.

Reference layer: A reference layer refers to a specific lower layer that is referenced in decoding of a decoded image corresponding to a target layer. A decoded image that corresponds to a reference layer is called a reference layer picture. A pixel that constitutes a reference layer is called a reference layer pixel.

In the example illustrated in FIGS. 2(a) and 2(b), the intermediate layer L2 and the lower layer L3 are reference layers for the higher layer L1. However, the present embodiment is not limited to this, and hierarchically coded data can be configured in such a manner that not all lower layers are referenced in decoding of the specific layer. For example, hierarchically coded data can be configured in such a manner that one of the intermediate layer L2 and the lower layer L3 is a reference layer for the higher layer L1. The reference layer can also be represented as a layer that is different from the target layer and used (referenced) at a time of predicting a coding parameter and the like used in decoding of the target layer. A reference layer that is directly referenced in inter-layer prediction of the target layer is called a direct reference layer. A direct reference layer B that is referenced in inter-layer prediction of a direct reference layer A for the target layer is called an indirect reference layer for the target layer.

Base layer: A base layer refers to a layer that is positioned lowest. A base layer decoded image is a decoded image of the lowest quality decodable from coded data and is called a base decoded image. In other words, a base decoded image refers to a decoded image that corresponds to the lowest layer. Partially coded data of the hierarchically coded data required for decoding of the base decoded image is called base coded data. For example, the base information “C” included in the hierarchically coded data DATA#A in the higher layer L1 is the base coded data.

Enhancement layer: An enhancement layer refers to a higher layer above the base layer.

Inter-layer prediction: Inter-layer prediction refers to prediction of a syntax element value of the target layer or a coding parameter and the like used in decoding of the target layer, based on a syntax element value included in a layer representation of a layer (reference layer) different from a layer representation of the target layer, a value derived from the syntax element value, and a decoded image. Inter-layer prediction that predicts information related to motion prediction from information about the reference layer is referred to as inter-layer motion information prediction. Inter-layer prediction that performs prediction from a lower layer decoded image is referred to as inter-layer image prediction (or inter-layer texture prediction). A layer used in inter-layer prediction is illustratively a lower layer below the target layer. Prediction performed in the target layer without use of the reference layer is referred to as intra-layer prediction.

Temporal identifier: A temporal identifier (referred to as a temporal ID, a sub-layer ID, or a sub-layer identifier) refers to an identifier for identification of a layer (hereinafter, a sub-layer) that is related to temporal scalability. A temporal identifier is for identification of a sub-layer and is in one-to-one correspondence with a sub-layer. Coded data includes the temporal identifier that is used to select partially coded data required for decoding of a decoded image in a specific sub-layer. Particularly, a temporal identifier of the highermost (highest) sub-layer is referred to as a highermost (highest) temporal identifier (highest TemporalId or highestTid).

Sub-layer: A sub-layer refers to a layer that is related to temporal scalability and specified by the temporal identifier. Hereinafter, such a layer will be referred to as a sub-layer (also referred to as a temporal layer) in order to be distinguished from other types of scalability such as spatial scalability and SNR scalability. In addition, hereinafter, temporal scalability is assumed to be realized by a sub-layer included in base layer coded data or in hierarchically coded data required for decoding of a certain layer.

Layer set: A layer set refers to a set of layers configured of one or more layers.

Bitstream extraction process: A bitstream extraction process refers to a process that removes (destroys) from a certain bitstream (hierarchically coded data or coded data) an NAL unit which is not included in a set (called a target set) defined by a target highermost temporal identifier (highest TemporalId or highestTid) and a layer ID list (referred to as LayerSetLayerIdList[ ]) representing layers included in a target layer set and that extracts a bitstream (referred to as a sub-bitstream) configured of an NAL unit included in the target set. The bitstream extraction process is also called sub-bitstream extraction. Layer IDs included in a layer set are assumed to be stored in ascending order in each element of the layer ID list LayerSetLayerIdList[K] (where K=0 . . . N−1 and N is the number of layers included in the layer set).

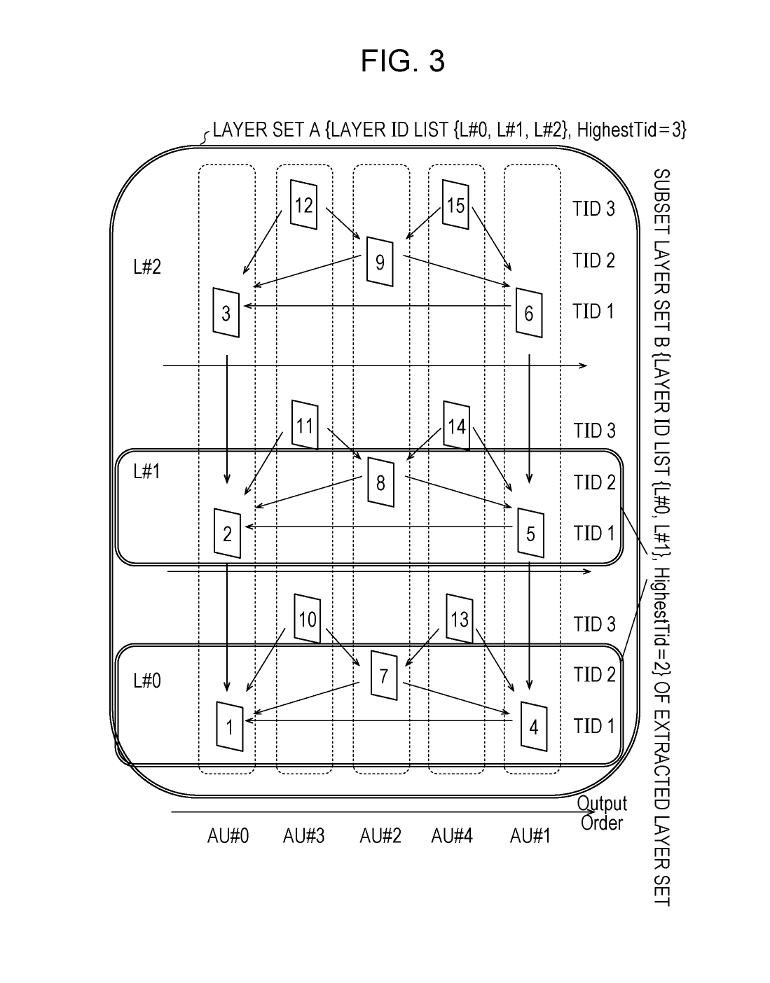

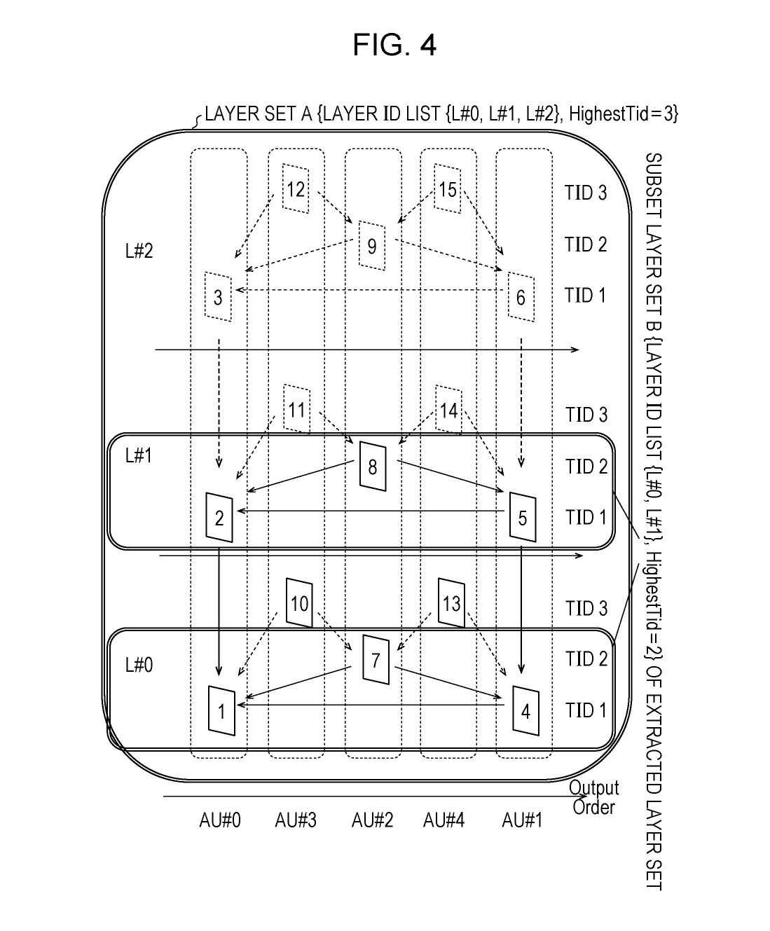

Next, an example of extracting hierarchically coded data that includes a layer set B (called a target set), a subset of a layer set A, from hierarchically coded data that includes the layer set A by performing the bitstream extraction process (referred to as sub-bitstream extraction) will be described with reference to FIG. 3 and FIG. 4.

FIG. 3 illustrates a configuration of the layer set A that is configured of three layers (L#0, L#1, and L#2), each of which is configured of three sub-layers (TID1, TID2, and TID3). Hereinafter, layers and sub-layers constituting a layer set will be represented as {layer ID list {L#0, . . . , L#N}, highermost temporal ID (HighestTid=K)}. For example, the layer set A in FIG. 3 is represented as {layer ID list {L#0, L#1, L#2}, highermost temporal ID=3}. The reference sign L#N indicates a layer N, each box in FIG. 3 represents a picture, and the numbers in the boxes represent an example of a decoding order. Hereinafter, a picture of a number N will be represented as P#N (also applies in FIG. 4).

Arrows between each picture indicate the direction of dependency between pictures (reference relationship). Arrows within the same layer indicate reference pictures that are used in inter prediction. Arrows between layers indicate reference pictures (referred to as reference layer pictures) that are used in inter-layer prediction.

The reference sign AU in FIG. 3 represents an access unit, and the reference sign #N represents an access unit number. Given that AU#0 is the AU at a certain starting point (for example, a point at which random access is started), AU#N represents the (N−1)-th access unit and represents the order of AUs included in a bitstream. That is, in the example of FIG. 3, access units are stored in the order of AU#0, AU#1, AU#2, AU#3, AU#4, . . . on the bitstream. The access unit represents a set of NAL units aggregated in accordance with a specific classification rule. AU#0 in FIG. 3 can be regarded as a set of VCL NALs that includes coded data of pictures P#1, P#1, and P#3. The access unit will be described in detail later.

In the example of FIG. 3, the target set (layer set B) is represented as the layer ID list {L#0, L#1} with the highermost temporal ID=2. Thus, the layer that is not included in the target set (layer set B) and the sub-layers having a temporal ID greater than the highermost temporal ID=2 are destroyed by the bitstream extraction from the bitstream including the layer set A. That is, the layer L#2 that is not included in the layer ID list and the NAL units having the sub-layer (TID3) are destroyed, and finally, the bitstream including the layer set B is extracted as illustrated in FIG. 4. In FIG. 4, dashed boxes represent destroyed pictures, and dashed arrows indicate the direction of dependency between the destroyed pictures and the reference pictures. Since the NAL units constituting the pictures of the layer L#3 and the sub-layer TID3 are previously destroyed, the dependency relationships thereof are previously disconnected.

Concepts of “layer” and “sub-layer” are introduced into SHVC or MV-HEVC in order to realize SNR scalability, spatial scalability, temporal scalability, and the like. In a case of realizing temporal scalability by changing the frame rate, first, coded data of a picture (having the highermost temporal ID (TID3)) that is not referenced from other pictures is destroyed by the bitstream extraction process as previously described in FIG. 3 and FIG. 4. In the case of FIG. 3 and FIG. 4, coded data having a frame rate reduced in half is generated by destroying coded data of the pictures (10, 13, 11, 14, 12, and 15).

In a case of realizing SNR scalability, spatial scalability, or view scalability, the granularity of each scalability can be changed by destroying coded data of a layer that is not included in the target set using the bitstream extraction. Coded data having a coarse granularity of scalability is generated by destroying the coded data (3, 6, 9, 12, and 15 in FIG. 3 and FIG. 4). Repeating this process allows stepwise adjustment of the granularity of layers and sub-layers.

The above terms are for convenience of description only. The above technical matters may be represented by other terms.

[Data Structure of Hierarchically Coded Data]

Hereinafter, HEVC and an HEVC extension scheme will be illustratively used as a coding scheme for generation of coded data in each layer. However, the present embodiment is not limited to this, and the coded data in each layer may be generated by a coding scheme such as MPEG-2 or H.264/AVC.

A lower layer and a higher layer may be coded by different coding schemes. The coded data in each layer may be supplied to the hierarchical moving image decoding device 1 through different transmission paths or may be supplied to the hierarchical moving image decoding device 1 through the same transmission path.

For example, in a case of transmitting an ultra-high-definition video (moving image or 4K video data) by scalable coding using a base layer and one enhancement layer, video data resulting from downscaling and interlacing the 4K video data may be coded by MPEG-2 or H.264/AVC and transmitted through a television broadcasting network in the base layer, and the 4K video (progressive) may be coded by HEVC and transmitted through the Internet in the enhancement layer.

<Structure of Hierarchically Coded Data DATA>

A data structure of hierarchically coded data DATA generated by the image coding device 2 and decoded by the image decoding device 1 will be described prior to detailed descriptions of the image coding device 2 and the image decoding device 1 according to the present embodiment.

(NAL Unit Layer)

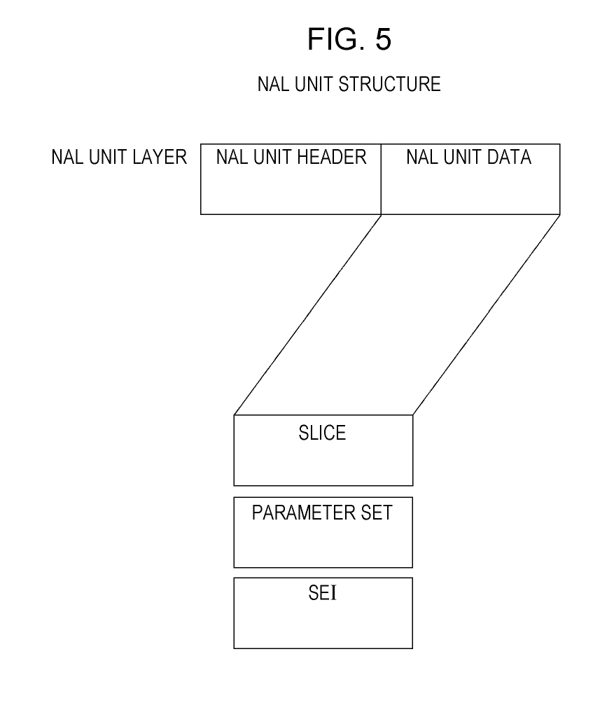

FIG. 5 is a diagram illustrating a layer structure of data in the hierarchically coded data DATA. The hierarchically coded data DATA is coded in units called network abstraction layer (NAL) units.

The NAL is a layer that is disposed to abstract communication between a video coding layer (VCL) which is a layer in which a moving image coding process is performed and a lower system which transmits and stores coded data.

The VCL is a layer in which an image coding process is performed, and coding is performed in the VCL. The lower system referred hereto corresponds to H.264/AVC and HEVC file formats or to the MPEG-2 system. In the example described below, the lower system corresponds to a decoding process performed in the target layer and in the reference layer. In the NAL, a bitstream generated in the VCL is divided in units called NAL units and is transmitted to the destination lower system.

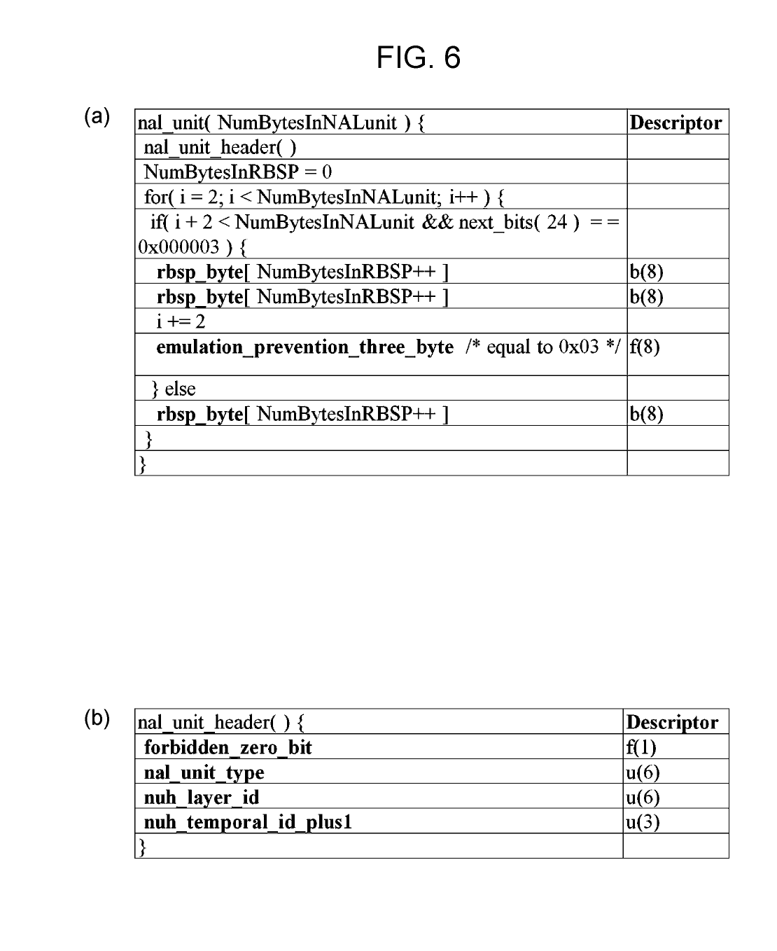

FIG. 6(a) illustrates a syntax table of the network abstraction layer (NAL) unit. The NAL unit includes coded data that is coded in the VCL and includes a header (NAL unit header; nal_unit_header( )) for appropriate delivery of the coded data to the destination lower system. The NAL unit header is represented by, for example, the syntax illustrated in FIG. 6(b). In the NAL unit header, described are “nal_unit_type” that represents the type of coded data stored in the NAL unit, “nuh_temporal_id_plus1” that represents the identifier (temporal identifier) of a sub-layer to which the stored coded data belongs, and “nuh_layer_id” (or nuh_reserved_zero_6bits) that represents the identifier (layer identifier) of a layer to which the stored coded data belongs. The NAL unit data includes a parameter set, SEI, a slice, and the like described later.

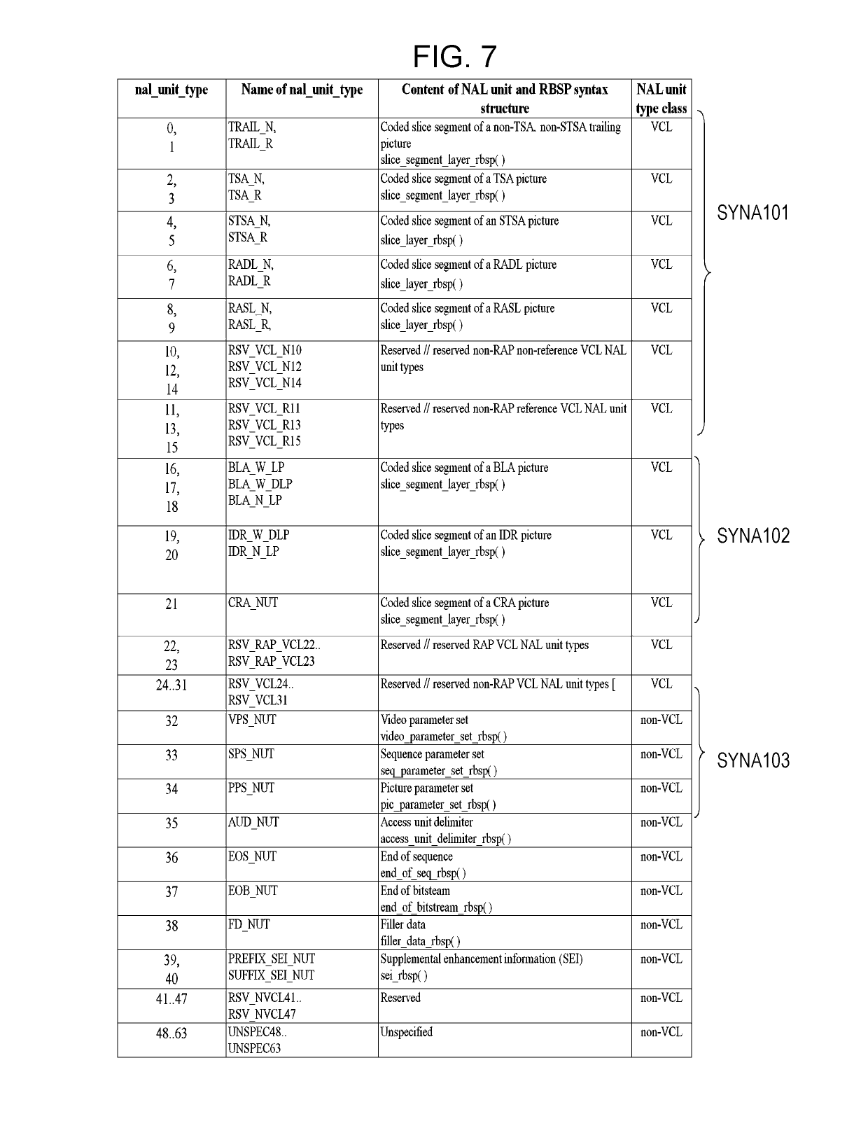

FIG. 7 is a diagram illustrating a relationship between NAL unit type values and NAL unit types. As illustrated in FIG. 7, NAL units having an NAL unit type value of 0 to 15 illustrated in SYNA101 correspond to slices of a non random access picture (RAP). NAL units having an NAL unit type values of 16 to 21 illustrated in SYNA102 correspond to slices of a random access picture (RAP or IRAP picture). The RAP picture broadly includes a BLA picture, an IDR picture, and a CRA picture, and the BLA picture is classified into BLA_W_LP, BLA_W_DLP, and BLA_N_LP. The IDR picture is classified into IDR_W_DLP and IDR_N_LP. Pictures other than the RAP picture include a leading picture (LP picture), a temporal access picture (TSA picture or STSA picture), a trailing picture (TRAIL picture), and the like. The coded data in each layer is multiplexed in the NAL by storing the coded data in the NAL unit and is transmitted to the hierarchical moving image decoding device 1.

Each NAL unit is classified into data (VCL data) constituting a picture and other data (non-VCL) according to the NAL unit type as illustrated in FIG. 7, particularly in NAL unit type class. All pictures are classified into VCL NAL units independently of picture types such as the random access picture, the leading picture, and the trailing picture. A parameter set that is data required for decoding of a picture, SEI that is supplemental information about a picture, an access unit delimiter (AUD) that represents a boundary of a sequence, an end-of-sequence (EOS), an end-of-bitstream (EOB), and the like are classified into non-VCL NAL units.

(Access Unit)

A set of NAL units aggregated in accordance with a specific classification rule is called an access unit. If the number of layers is one, the access unit is a set of NAL units constituting one picture. If the number of layers is greater than one, the access unit is a set of NAL units constituting pictures in a plurality of layers at the same time. The coded data may include an NAL unit called an access unit delimiter in order to indicate a boundary of the access unit. The access unit delimiter is included in the coded data between a set of NAL units constituting one access unit and a set of NAL units constituting another access unit.

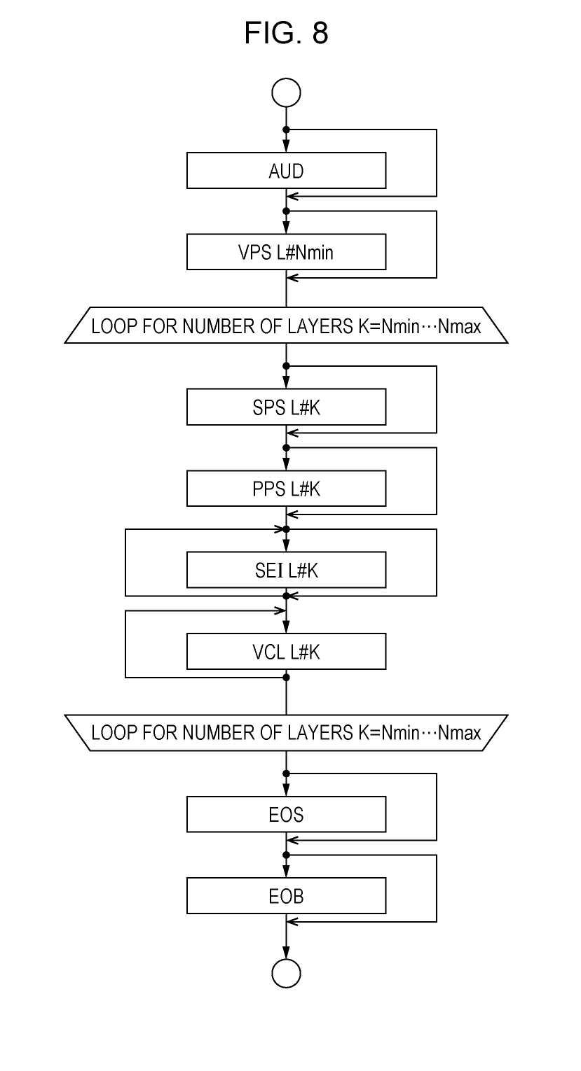

FIG. 8 is a diagram illustrating an example of an NAL unit configuration included in the access unit. As illustrated in FIG. 8, the AU is configured of NAL units such as the access unit delimiter (AUD) indicating the start of the AU, various parameter sets (VPS, SPS, and PPS), various pieces of SEI (Prefix SEI and Suffix SEI), a VCL (slice) constituting one picture if the number of layers is one, a VCL constituting pictures in number corresponding to the number of layers if the number of layers is greater than one, the end-of-sequence (EOS) indicating the end of a sequence, and the end-of-bitstream (EOB) indicating the end of a bitstream. In FIG. 8, the reference sign L#K (where K=Nmin . . . Nmax) after “VPS”, “SPS”, “SEI”, and “VCL” represents a layer ID. In the example of FIG. 8, the SPS, the PPS, the SEI, and the VCL of each of the layers L#Nmin to L#Nmax exist in the AU in ascending order of layer IDs except for the VPS. The VPS is transmitted by only the lowermost layer ID. In FIG. 8, an arrow indicates whether a specific NAL unit exists in the AU or an iteration exists. For example, if a specific NAL unit exists in the AU, this is indicated by an arrow passing through the NAL unit, and if a specific NAL unit does not exist in the AU, this is indicated by an arrow skipping the NAL unit. For example, an arrow directed to the VPS without passing through the AUD indicates that the AUD does not exist in the AU. While the VPS having a layer ID other than the lowermost layer ID may be included in the AU, the image decoding device is assumed to ignore the VPS having a layer ID other than the lowermost layer ID. Various parameter sets (VPS, SPS, and PPS) or the SEI which is supplemental information may be included as a part of the access unit as in FIG. 8 or may be transmitted to a decoder by means other than a bitstream.

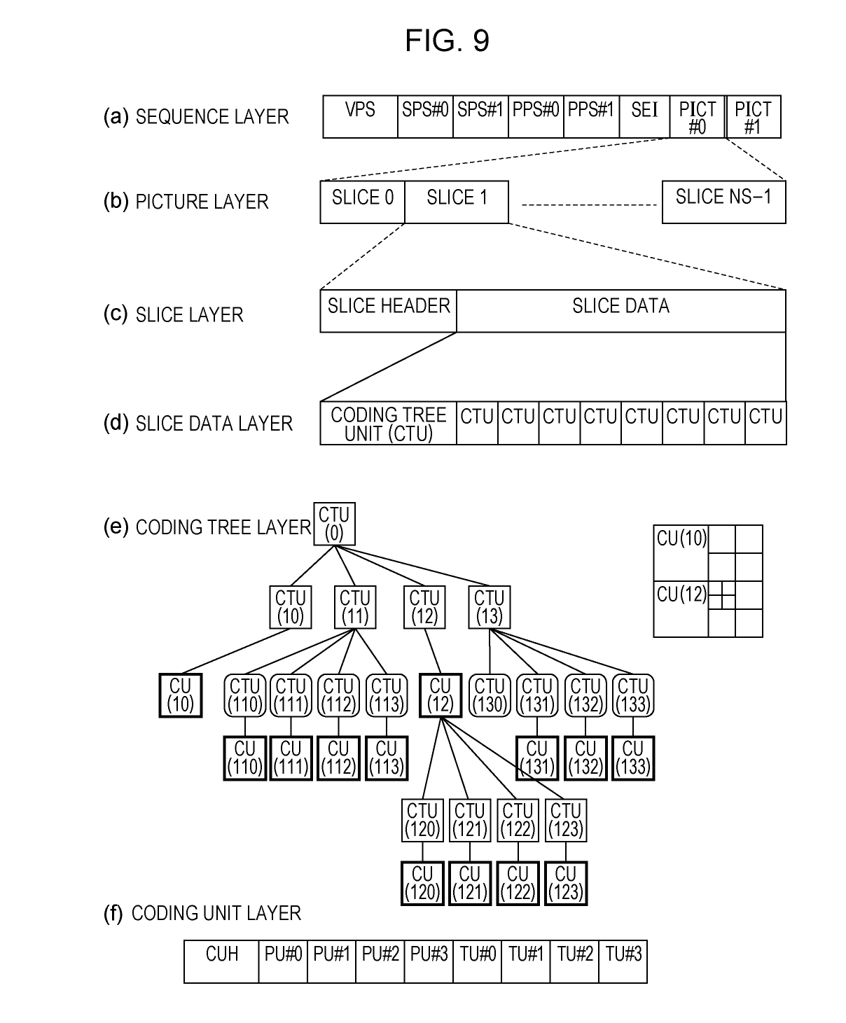

FIG. 9 is a diagram illustrating a layer structure of data in the hierarchically coded data DATA. The hierarchically coded data DATA illustratively includes a sequence and a plurality of pictures constituting the sequence. FIGS. 9(a) to 9(f) are diagrams respectively illustrating a sequence layer predefining a sequence SEQ, a picture layer defining a picture PICT, a slice layer defining a slice S, a slice data layer defining slice data, a coding tree layer defining a coding tree unit included in the slice data, and a coding unit layer defining a coding unit (CU) included in the coding tree.

(Sequence Layer)

The sequence layer defines a set of data that is referenced by the image decoding device 1 in order to decode the processing target sequence SEQ (hereinafter, referred to as a target sequence). The sequence SEQ includes the video parameter set, the sequence parameter set SPS, the picture parameter set PPS, the picture PICT, and the supplemental enhancement information SEI as illustrated in FIG. 9(a). The value illustrated after “#” indicates a layer ID. While FIG. 9 illustrates an example in which there exist coded data of #0 and coded data of #1, that is, coded data having a layer ID of zero and coded data having a layer ID of one, types of layers and the number of layers are not limited to this.

The video parameter set VPS defines a set of coding parameters that is referenced by the image decoding device 1 in order to decode the coded data configured of one or more layers. For example, a VPS identifier (video_parameter_set_id) used for identification of the VPS referenced by the sequence parameter set or other syntax elements described later, the number of layers (vps_max_layers_minus1) included in the coded data, the number of sub-layers (vps_sub_layers_minus1) included in a layer, the number of layer sets (vps_num_layer_sets_minus1) defining a set of layers configured of one or more layers represented in the coded data, layer set configuration information (layer_id_included_flag[i][j]) defining a set of layers constituting a layer set, and an inter-layer dependency relationship (direct dependency flag direct_dependency_flag[i][j] and layer dependency type direct_dependency_type[i][j]) are defined. The VPS may exist in plural quantities in the coded data. In this case, the VPS used in decoding is selected from a plurality of candidates for each target sequence. The VPS used in decoding of a specific sequence belonging to a certain layer is called an active VPS. The VPS for the base layer (layer ID=0) may be called an active VPS, and the VPS for the enhancement layer (layer ID>0) may be called an active layer VPS in order to distinguish the VPS applied to the base layer from the VPS applied to the enhancement layer. Hereinafter, the VPS will mean the active VPS for the target sequence belonging to a certain layer unless otherwise specified. The VPS of layer ID=nuhLayerIdA that is used in decoding of the layer of layer ID=nuhLayerIdA may be used in decoding of a layer having a layer ID greater than nuhLayerIdA (nuhLayerIdB; nuhLayerIdB>nuhLayerIdA). Hereinafter, constraints (referred to as bitstream constraints) stating that the layer ID of the VPS is zero (nuhLayerId=0) and that the temporal ID thereof is zero (tId=0) will be assumed to be imposed between a decoder and an encoder unless otherwise specified.

The sequence parameter set SPS defines a set of coding parameters that is referenced by the image decoding device 1 in order to decode the target sequence. For example, an active VPS identifier (sps_video_parameter_set_id) representing the active VPS referenced by the target SPS, an SPS identifier (sps_seq_parameter_set_id) used for identification of the SPS referenced by the picture parameter set or other syntax elements described later, and the width and the height of a picture are defined. The SPS may exist in plural quantities in the coded data. In this case, the SPS used in decoding is selected from a plurality of candidates for each target sequence. The SPS used in decoding of a specific sequence belonging to a certain layer is called an active SPS. The SPS for the base layer may be called an active SPS, and the SPS for the enhancement layer may be called an active layer SPS in order to distinguish the SPS applied to the base layer from the SPS applied to the enhancement layer. Hereinafter, the SPS will mean the active SPS for use in decoding of the target sequence belonging to a certain layer unless otherwise specified. The SPS of layer ID=nuhLayerIdA that is used in decoding of a sequence belonging to the layer of layer ID=nuhLayerIdA may be used in decoding of a sequence belonging to a layer having a layer ID greater than nuhLayerIdA (nuhlayerIdB; nuhLayerIdB>nuhLayerIdA). Hereinafter, a constraint (referred to as a bitstream constraint) stating that the temporal ID of the SPS is zero (tId=0) will be assumed to be imposed between a decoder and an encoder unless otherwise specified.

The picture parameter set PPS defines a set of coding parameters that is referenced by the image decoding device 1 in order to decode each picture in the target sequence. For example, an active SPS identifier (pps_seq_parameter_set_id) representing the active SPS referenced by the target PPS, a PPS identifier (pps_pic_parameter_set_id) used for identification of the PPS referenced by the slice header or other syntax elements described later, a reference value (pic_init_qp_minus26) of a quantization range used in decoding of a picture, a flag (weighted_pred_flag) indicating whether to apply weighted prediction, and a scaling list (quantization matrix) are included. The PPS may exist in plural quantities. In this case, one of the plurality of PPSs is selected from each picture in the target sequence. The PPS used in decoding of a specific picture belonging to a certain layer is called an active PPS. The PPS for the base layer may be called an active PPS, and the PPS for the enhancement layer may be called an active layer PPS in order to distinguish the PPS applied to the base layer from the PPS applied to the enhancement layer. Hereinafter, the PPS will mean the active PPS for a target picture belonging to a certain layer unless otherwise specified. The PPS of layer ID=nuhLayerIdA that is used in decoding of a picture belonging to the layer of layer ID=nuhLayerIdA may be used in decoding of a picture belonging to a layer having a layer ID greater than nuhLayerIdA (nuhLayerIdB; nuhLayerIdB>nuhLayerIdA).

The active SPS and the active PPS may be set to a different SPS and a PPS for each layer. That is, a decoding process can be performed by referencing a different SPS and a PPS for each layer.

(Picture Layer)

The picture layer defines a set of data that is referenced by the hierarchical moving image decoding device 1 in order to decode the processing target picture PICT (hereinafter, referred to as a target picture). The picture PICT includes slices S0 to SNS−1 (where NS is the total number of slices included in the picture PICT) as illustrated in FIG. 9(b).

Hereinafter, unless required to distinguish the slices S0 to SNS−1 from each other, the suffix of the reference sign may be omitted in description. This also applies to other data that is included in the hierarchically coded data DATA described below and appended with a suffix.

(Slice Layer)

The slice layer defines a set of data that is referenced by the hierarchical moving image decoding device 1 in order to decode the processing target slice S (referred to as a target slice). The slice S includes a slice header SH and slice data SDATA as illustrated in FIG. 9(c).

The slice header SH includes a coding parameter group that is referenced by the hierarchical moving image decoding device 1 in order to determine a decoding method for the target slice. For example, an active PPS identifier (slice_pic_parameter_set_id) that specifies the PPS (active PPS) to be referenced for decoding of the target slice is included. The SPS referenced by the active PPS is specified by the active SPS identifier (pps_seq_parameter_set_id) included in the active PPS. The VPS (active VPS) referenced by the active SPS is specified by the active VPS identifier (sps_video_parameter_set_id) included in the active SPS.

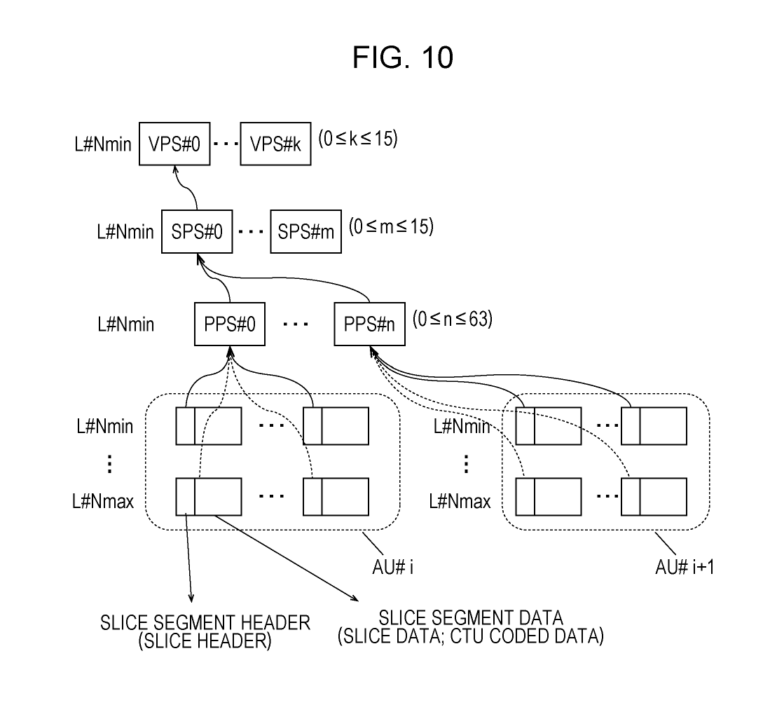

Sharing of a parameter set (shared parameter set) between layers in the present embodiment will be described with FIG. 10 as an example. FIG. 10 illustrates a reference relationship between header information and the coded data constituting the access unit (AU). In the example of FIG. 10, each slice constituting a picture belonging to the layer L#K (where K=Nmin . . . Nmax) in each AU includes the active PPS identifier specifying the PPS to be referenced in the slice header, and the identifier specifies (or activates) the PPS (active PPS) used in decoding at the start of decoding of each slice. The slices in the same picture have to reference the same identifier of each of the PPS, the SPS, and the VPS. The activated PPS includes the active SPS identifier that specifies the SPS (active SPS) to be referenced for a decoding process, and the identifier specifies (activates) the SPS (active SPS) used in decoding. Similarly, the activated SPS includes the active VPS identifier that specifies the VPS (active VPS) to be referenced for performing a decoding process on the sequence belonging to each layer, and the identifier specifies (activates) the VPS (active VPS) used in decoding. By the procedure described heretofore, the parameter sets required for performing a decoding process on the coded data in each layer are confirmed. In the example of FIG. 10, the layer identifier of each parameter set (VPS, SPS, and PPS) is assumed to be the lowermost layer ID L#Nmin belonging to a certain layer set. The slice of layer ID=L#Nmin references the parameter sets having the same layer ID. That is, in the example of FIG. 10, the slice of layer ID=L#Nmin in the AU#i references the PPS of layer ID=L#Nmin and PPS identifier=0, the PPS references the SPS of layer ID=L#Nmin and SPS identifier=0, and the SPS references the VPS of layer ID=L#Nmin and VPS identifier=0. Meanwhile, the slice of layer ID=L#K (L#Nmax in FIG. 10) (where K>Nmin) in the AU#i can reference the PPS and the SPS having the same layer ID (=L#K) and can also reference the PPS and the SPS in the layer L#M (M=Nmin; L#Nmin in FIG. 10) lower than L#K (where K>M). That is, by referencing a parameter set in common between layers, a parameter set including the same coding parameters as in the lower layer is not required to be transmitted in a duplicate manner in the higher layer. Thus, the amount of coding related to a duplicate parameter set can be reduced, and the amount of processing related to decoding/coding can be reduced. The identifier of a higher layer parameter set referenced by each piece of header information (slice header, PPS, and SPS) is not limited to the example of FIG. 10. The identifier may be selected from VPS identifiers k=0 . . . 15 for the VPS, may be selected from SPS identifiers m=0 . . . 15 for the SPS, and may be selected from PPS identifiers n=0 . . . 63 for the PPS.

Slice type specification information (slice_type) that specifies a slice type is an example of the coding parameters included in the slice header SH.

Examples of the slice types specifiable by the slice type specification information include (1) an I slice in which only intra prediction is used at the time of coding, (2) a P slice in which either uni-directional prediction or intra prediction is used at the time of coding, and (3) a B slice in which either uni-directional prediction, bi-directional prediction, or intra prediction is used at the time of coding.

(Slice Data Layer)

The slice data layer defines a set of data that is referenced by the hierarchical moving image decoding device 1 in order to decode the processing target slice data SDATA. The slice data SDATA includes coded tree blocks (CTB) as illustrated in FIG. 9(d). A CTB is a fixed-size block (for example, 64×64) constituting a slice and is also called a largest cording unit (LCU).

(Coding Tree Layer)

The coding tree layer, as illustrated in FIG. 9(e), defines a set of data that is referenced by the hierarchical moving image decoding device 1 in order to decode a processing target coding tree block. The coding tree unit is split by recursive quadtree subdivision. A tree structure of nodes obtained by recursive quadtree subdivision is referred to as a coding tree. An intermediate note of the quadtree corresponds to the coded tree unit (CTU), and the coding tree block is also defined as the highest CTU. The CTU includes a split flag (split_flag) and, if split_flag is equal to one, is split into four coding tree units CTUs. If split_flag is equal to zero, the coding tree unit CTU is split into four coded units (CU). The coding unit CU is a terminal node of the coding tree layer and is not split further in this layer. The coding unit CU is the base unit of a coding process.

The size of the coding tree unit CTU and the possible size of each coding unit are dependent on minimum coding node size specification information included in the sequence parameter set SPS and the difference between hierarchy depths of a maximum coding node and a minimum coding node. For example, if the size of the minimum coding node is 8×8 pixels and the difference between the hierarchy depths of the maximum coding node and the minimum coding node is three, the size of the coding tree unit CTU is 64×64 pixels, and the size of a coding node may be one of four sizes, that is, 64×64 pixels, 32×32 pixels, 16×16 pixels, and 8×8 pixels.

A partial region of the target picture that is decoded from the coding tree unit is called a coding tree block (CTB). The CTB that corresponds to a luma picture which is a luma component of the target picture is called a luma CTB. In other words, a partial region of the luma picture decoded from the CTU is called a luma CTB. Meanwhile, a partial region that is decoded from the CTU and corresponds to a chroma picture is called a chroma CTB. Generally, if a color format of an image is determined, the size of the luma CTB can be converted from and into the size of the chroma CTB. For example, if the color format is 4:2:2, the size of the chroma CTB is half the size of the luma CTB. Hereinafter, the size of the CTB will mean the size of the luma CTB in description unless otherwise specified. The size of the CTU corresponds to the size of the luma CTB corresponding to the CTU.

(Coding Unit Layer)

The coding unit layer, as illustrated in FIG. 9(f), defines a set of data that is referenced by the hierarchical moving image decoding device 1 in order to decode a processing target coding unit. Specifically, the coding unit CU is configured of a CU header CUH, a prediction tree, and a transform tree. The CU header CUH defines whether the coding unit is a unit in which intra prediction is used or a unit in which inter prediction is used. The coding unit is the root of the prediction tree (PT) and the transform tree (TT). A region of a picture corresponding to the CU is called a coding block (CB). The CB of the luma picture is called a luma CB, and the CB of the chroma picture is called a chroma CB. The size of the CU (size of the coding node) means the size of the luma CB.

(Transform Tree)

The transform tree (hereinafter, abbreviated as TT) results from splitting of the coding unit CU into one or a plurality of transform blocks and defines the position and the size of each transform block. In other words, a transform block is one or a plurality of non-overlapping regions constituting the coding unit CU. The transform tree includes one or a plurality of transform blocks obtained by the above splitting. Information related to the transform tree included in the CU and information included in the transform tree are called TT information.

Splitting in the transform tree includes allocation of a region having the same size as the coding unit as the transform block and recursive quadtree subdivision as in the above splitting of tree blocks. A transform process is performed for each transform block. Hereinafter, the transform block that is the unit of transformation will be referred to as a transform unit (TU).

The transform tree TT includes TT split information SP_TT that specifies a pattern of splitting of the target CU into each transform block and includes quantized prediction residuals QD1 to QDNT (where NT is the total number of transform units TUs included in the target CU).

The TT split information SP_TT, specifically, is information for determination of the form of each transform block included in the target CU and the position thereof in the target CU. For example, the TT split information SP_TT can be realized from information (split_transform_unit_flag) indicating whether to split a target node and information (trafoDepth) indicating the depth of the splitting. For example, if the size of the CU is 64×64, each transform block obtained by splitting may have a size of 4×4 pixels to 32×32 pixels.

Each quantized prediction residual QD is coded data that is generated by the following Processes 1 to 3 performed by the hierarchical moving image coding device 2 on a target block which is a processing target transform block.

Process 1: Perform frequency transformation (for example, discrete cosine transform (DCT) and discrete sine transform (DST)) on a prediction residual that results from subtracting a predicted image from a coding target image.

Process 2: Quantize a transform coefficient obtained by Process 1.

Process 3: Code the transform coefficient quantized by Process 2 in a variable-length code.

The above quantization parameter qp represents the size of a quantization step QP (QP=2qp/6) that is used when the hierarchical moving image coding device 2 quantizes the transform coefficient.

(Prediction Tree)

The prediction tree (hereinafter, abbreviated as PT) results from splitting the coding unit CU into one or a plurality of prediction blocks and defines the position and the size of each prediction block. In other words, a prediction block is one or a plurality of non-overlapping regions constituting the coding unit CU. The prediction tree includes one or a plurality of prediction blocks obtained by the above splitting. Information related to the prediction tree included in the CU and information included in the prediction tree are called PT information.

A prediction process is performed for each prediction block. Hereinafter, the prediction block that is the unit of prediction will be referred to as a prediction unit (PU).

Splittings in the prediction tree are broadly of two types, one in a case of intra prediction and the other in a case of inter prediction. Intra prediction refers to prediction performed in the same picture, and inter prediction refers to a prediction process performed between different pictures (for example, between different display times or between different layer images). That is, in the inter prediction, a predicted image is generated from a decoded image on a reference picture by using either a reference picture in the same layer as the target layer (intra-layer reference picture) or a reference picture in the reference layer for the target layer (inter-layer reference picture).

In a case of intra prediction, split methods include 2N×2N (the same size as the coding unit) and N×N.

In a case of inter prediction, split methods are coded by part_mode in the coded data and include 2N×2N (the same size as the coding unit), 2N×N, 2N×nU, 2N×nD, N×2N, nL×2N, nR×2N, N×N, and the like. N is equal to 2m (where m is an arbitrary integer greater than or equal to one). Since the number of splittings is either one, two, or four, the number of PUs included in the CU is one to four. These PUs will be represented as PU0, PU1, PU2, and PU3 in order.

(Prediction Parameter)

A predicted image of the prediction unit is derived by using prediction parameters belonging to the prediction unit. The prediction parameters include intra prediction parameters and inter prediction parameters.

The intra prediction parameters are parameters for restoration of the intra prediction (prediction mode) in each intra PU. Parameters for restoration of a prediction mode include mpm_flag that is a flag related to the most probable mode (hereinafter, MPM), mpm_idx that is an index for selection of the MPM, and rem_idx that is an index for specification of a prediction mode other than the MPM. The MPM is a prediction mode that is estimated to have the strong possibility of being selected in a target partition. For example, the MPM may include a prediction mode that is estimated on the basis of prediction modes assigned to the partitions around the target partition or include a DC mode or a Planar mode that generally has a high probability of occurrence. Hereinafter, “prediction mode”, if simply written herein, will refer to a luma prediction mode unless otherwise specified. A chroma prediction mode will be written as “chroma prediction mode” in order to be distinguished from the luma prediction mode. The parameters for restoration of a prediction mode include chroma_mode that is a parameter for specification of the chroma prediction mode.

The inter prediction parameters are configured of prediction list utilization flags predFlagL0 and predFlagL1, reference picture indexes refIdxL0 and refIdxL1, and vectors mvL0 and mvL1. The prediction list utilization flags predFlagL0 and predFlagL1 are flags respectively indicating whether reference picture lists called an L0 reference list and an L1 reference list are used, and if the value thereof is one, the corresponding reference picture list is used. If two reference picture lists are used, that is, in a case of predFlagL0=1 and predFlagL1=1, this corresponds to bi-prediction. If one reference picture list is used, that is, in a case of either (predFlagL0, predFlagL1)=(1, 0) or (predFlagL0, predFlagL1)=(0, 1), this corresponds to uni-prediction.

Syntax elements for derivation of the inter prediction parameters included in the coded data include, for example, a partitioning mode part_mode, a merge flag merge_flag, a merge index merge_idx, an inter prediction identifier inter_pred_idc, a reference picture index refIdxLX, a prediction vector index mvp_LX_idx, and a difference vector mvdLX. The value of each prediction list utilization flag is derived as follows on the basis of the inter prediction identifier.

predFlagL0=inter prediction identifier&1

predFlagL1=inter prediction identifier>>1

where “&” denotes a logical product and “>>” denotes a right shift.

(Example of Reference Picture List)

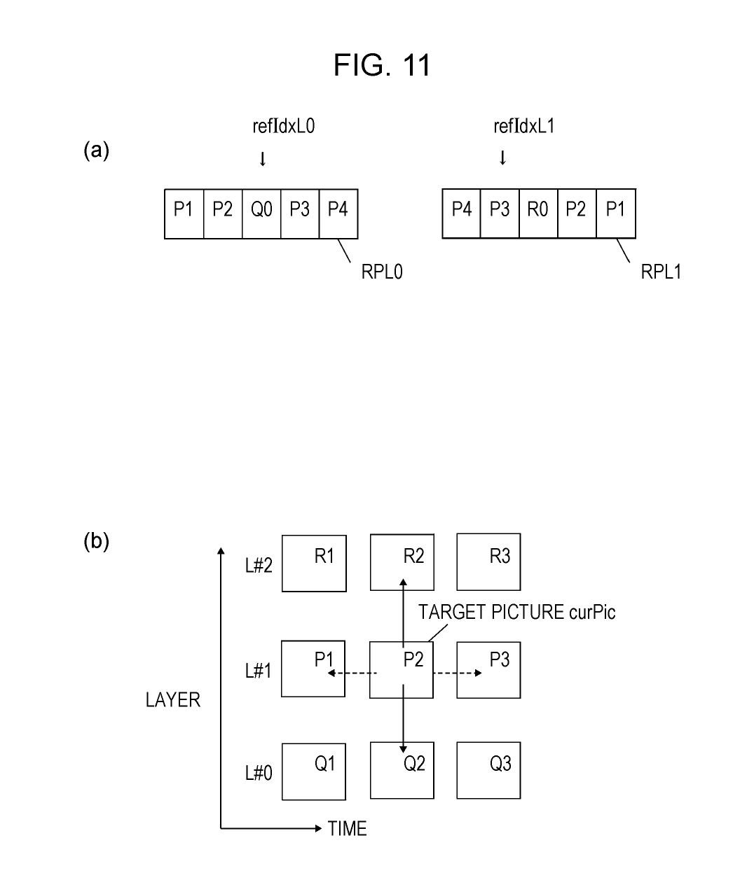

Next, an example of the reference picture list will be described. The reference picture list is an array that is configured of reference pictures stored in a decoded picture buffer. FIG. 11(a) is a conceptual diagram illustrating an example of the reference picture list. In a reference picture list RPL0, each of the five rectangles that are linearly arranged left to right indicates a reference picture. The reference signs P1, P2, Q0, P3, and P4 illustrated in order from the left end to the right end are reference signs that respectively indicate reference pictures. Similarly, in a reference picture list RPL1, the reference signs P4, P3, R0, P2, and P1 illustrated in order from the left end to the right end are reference signs that respectively indicate reference pictures. The letter P in P1 and the like indicates a target layer P, and the letter Q in Q0 indicates a layer Q that is different from the target layer P. Similarly, the letter R in R0 indicates a layer R that is different from the target layer P and the layer Q. The suffixes of P, Q, and R indicate a picture order count POC. The downward arrow immediately below refIdxL0 indicates that the reference picture index refIdxL0 is an index referencing the reference picture Q0 from the reference picture list RPL0 in the decoded picture buffer. Similarly, the downward arrow immediately below refIdxL1 indicates that the reference picture index refIdxL1 is an index referencing the reference picture P3 from the reference picture list RPL1 in the decoded picture buffer.

(Example of Reference Picture)

Next, an example of the reference picture used at the time of vector derivation will be described. FIG. 11(b) is a conceptual diagram illustrating an example of the reference picture. In FIG. 11(b), a horizontal axis indicates a display time, and a vertical axis indicates the number of layers. Each rectangle illustrated in vertically three rows and horizontally three columns (total nine) indicates a picture. Of the nine rectangles, the rectangle of the lower row in the second column from the left illustrates a decoding target picture (target picture), and the remaining eight rectangles respectively illustrate reference pictures. Reference pictures Q2 and R2 that are indicated by a downward arrow from the target picture are pictures displayed at the same time as the target picture but in different layers from the target picture. The reference picture Q2 or R2 is used in inter-layer prediction that uses a target picture curPic (P2) as a reference. The reference picture P1 that is indicated by a leftward arrow from the target picture is a past picture in the same layer as the target picture. The reference picture P3 that is indicated by a rightward arrow from the target picture is a future picture in the same layer as the target picture. The reference picture P1 or P3 is used in motion prediction that uses the target picture as a reference.

(Merge Prediction and AMVP Prediction)

A decoding (coding) method for the inter prediction parameters includes a merge prediction (merge) mode and an adaptive motion vector prediction (AMVP) mode, and the merge flag merge_flag is used for identification of these modes. Either in the merge prediction mode or in the AMVP mode, the prediction parameters of the target PU are derived by using the prediction parameters of a previously processed block. The merge prediction mode is a mode in which previously derived prediction parameters are used as is without including a prediction list utilization flag predFlagLX (inter prediction identifier inter_pred_idc), the reference picture index refIdxLX, and a vector mvLX in the coded data, and the AMVP mode is a mode in which the inter prediction identifier inter_pred_idc, the reference picture index refIdxLX, and the vector mvLX are included in the coded data. The vector mvLX is coded as the prediction vector index mvp_LX_idx and the difference vector (mvdLX) indicating a prediction vector.

The inter prediction identifier inter_pred_idc is data indicating types and the number of reference pictures and has one of the values Pred_L0, Pred_L1, and Pred_Bi. Pred_L0 and Pred_L1 respectively indicate use of the reference pictures stored in the reference picture lists called the L0 reference list and the L1 reference list, and both indicate use of one reference picture (uni-prediction). Prediction that uses the L0 reference list is called L0 prediction, and prediction that uses the L1 reference list is called L1 prediction. Pred_Bi indicates use of two reference pictures (bi-prediction) and indicates use of two reference pictures respectively stored in the L0 reference list and in the L1 reference list. The prediction vector index mvp_LX_idx is an index indicating a prediction vector, and the reference picture index refIdxLX is an index indicating a reference picture stored in the reference picture list. LX is a manner of representation that is used in a case where L0 prediction and L1 prediction are not distinguished from each other, and replacing LX with L0 or L1 allows parameters for the L0 reference list to be distinguished from parameters for the L1 reference list. For example, refIdxL0 represents a reference picture index used in L0 prediction, refIdxL1 represents a reference picture index used in L1 prediction, and refIdx (refIdxLX) is a representation used in a case where refIdxL0 and refIdxL1 are not distinguished from each other.

The merge index merge_idx is an index that indicates which prediction parameter of prediction parameter candidates (merge candidates) derived from a previously processed block is used as a prediction parameter of the decoding target block.

(Motion Vector and Disparity Vector)

The vector mvLX includes a motion vector and a disparity vector (parallax vector). The motion vector is a vector that indicates a positional shift between the position of a block in a picture at a certain display time in a certain layer and the position of a corresponding block in a picture at a different display time (for example, an adjacent discrete time) in the same layer. The disparity vector is a vector that indicates a positional shift between the position of a block in a picture at a certain display time in a certain layer and the position of a corresponding block in a picture at the same display time in a different layer. Pictures in different layers indicate, for example, a case where the pictures have the same resolution but have different quality, a case where the pictures have different viewpoints, or a case where the pictures have different resolutions. Particularly, the disparity vector that corresponds to the pictures having different viewpoints is called a parallax vector. Hereinafter, the motion vector and the disparity vector will be simply called the vector mvLX in description if the motion vector and the disparity vector are not distinguished from each other. The prediction vector and the difference vector related to the vector mvLX are respectively called a prediction vector mvpLX and the difference vector mvdLX. A determination of whether the vector mvLX and the difference vector mvdLX are motion vectors or disparity vectors is performed by using the reference picture index refIdxLX belonging to the vectors.

The parameters described heretofore may be individually coded, or a plurality of parameters may be integrally coded. In a case of integrally coding a plurality of parameters, an index is assigned to a combination of the parameter values, and the assigned index is coded. If a parameter can be derived from another parameter or previously decoded information, coding of the parameter can be omitted.

[Hierarchical Moving Image Decoding Device]

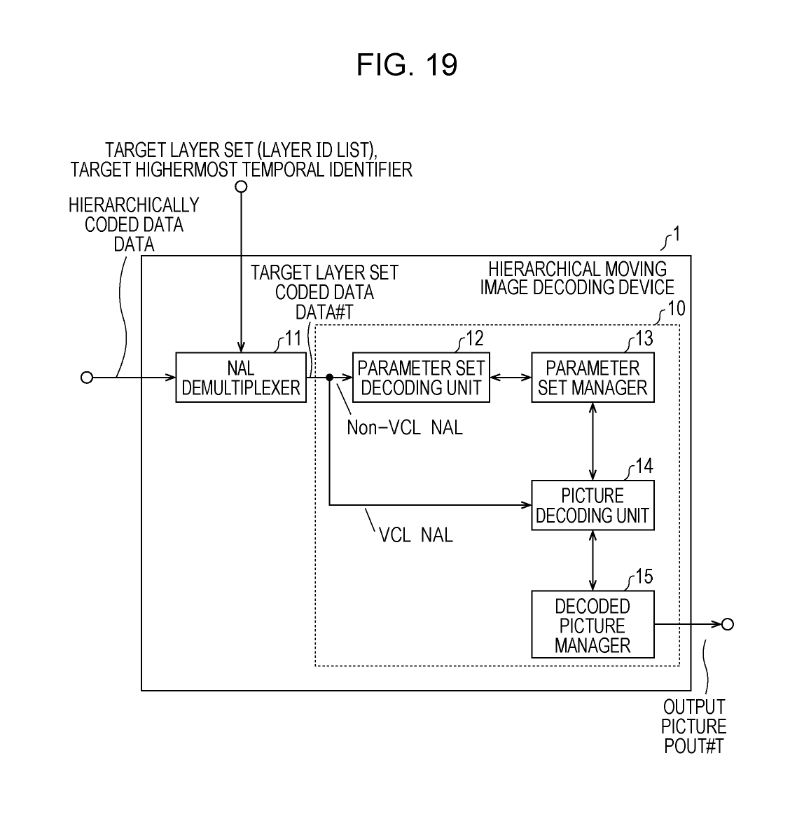

Hereinafter, a configuration of the hierarchical moving image decoding device 1 according to the present embodiment will be described with reference to FIG. 19 to FIG. 21.

(Configuration of Hierarchical Moving Image Decoding Device)

A configuration of the hierarchical moving image decoding device 1 according to the present embodiment will be described. FIG. 19 is a schematic diagram illustrating a configuration of the hierarchical moving image decoding device 1 according to the present embodiment. The hierarchical moving image decoding device 1 generates a decoded image POUT#T in each layer included in the target layer set by decoding the hierarchically coded data DATA, supplied from the hierarchical moving image coding device 2, on the basis of the decoding target layer set (layer ID list) included in the externally supplied hierarchically coded data DATA and the highermost temporal layer identifier specifying a sub-layer belonging to the decoding target layer. That is, the hierarchical moving image decoding device 1 decodes coded data of pictures in each layer in ascending order from the lowermost layer ID to the highermost layer ID included in the target layer set and generates decoded images (decoded pictures) of the coded data. In other words, coded data of pictures in each layer is decoded in the order of the layer ID list LayerSetLayerIdList[0] . . . LayerSetIdList[N−1] (where N is the number of layers included in the target layer set) of the target layer set.

Hereinafter, description will be provided assuming that the target layer is an enhancement layer that uses the base layer as the reference layer. Thus, the target layer is also a higher layer above the reference layer. Conversely, the reference layer is also a lower layer below the target layer.

The hierarchical moving image decoding device 1 is configured to include an NAL demultiplexer 11 and a target layer set picture decoding unit 10 as illustrated in FIG. 19. The target layer set picture decoding unit 10 is configured to include a parameter set decoding unit 12, a parameter set manager 13, a picture decoding unit 14, and a decoded picture manager 15. The NAL demultiplexer 11 includes a bitstream extractor 17 which is not illustrated.

The hierarchically coded data DATA, in addition to the NAL generated by the VCL, includes NALs that include parameter sets (VPS, SPS, and PPS), the SEI, and the like. These NALs are called non-VCL NALs in contrast to the VCL NAL.

The bitstream extractor 17 included in the NAL demultiplexer 11 performs the bitstream extraction process on the basis of the externally supplied decoding target layer set (layer ID list) and the highermost temporal layer identifier, removes (destroys) from the hierarchically coded data DATA an NAL unit that is not included in the set (called the target set) defined by the highermost temporal identifier (highest TemporalId or highestTid) and the layer ID list representing the layers included in the target layer set, and extracts target layer set coded data DATA#T that is configured of the NAL units included in the target set.

The NAL demultiplexer 11 demultiplexes the target layer set coded data DATA#T extracted by the bitstream extractor 17, references the NAL unit type, the layer identifier (layer ID), and the temporal identifier (temporal ID) included in the NAL unit, and supplies the NAL unit included in the target layer set to the target layer set picture decoding unit 10.

The target layer set picture decoding unit 10, of the supplied NALs included in the target layer set coded data DATA#T, supplies the non-VCL NAL to the parameter set decoding unit 12 and the VCL NAL to the picture decoding unit 14. That is, the target layer set picture decoding unit 10 decodes the header of the supplied NAL unit (NAL unit header) and, on the basis of the NAL unit type, the layer identifier, and the temporal identifier included in the decoded NAL unit header, supplies the non-VCL coded data to the parameter set decoding unit 12 and the VCL coded data to the picture decoding unit 14 along with the NAL unit type, the layer identifier, and the temporal identifier decoded.

The parameter set decoding unit 12 decodes parameter sets, that is, the VPS, the SPS, and the PPS, from the input non-VCL NAL and supplies the parameter sets to the parameter set manager 13. Processing in the parameter set decoding unit 12 that has high relevance to the present invention will be described in detail later.

The parameter set manager 13 retains coding parameters of the decoded parameter sets for each parameter set identifier. Specifically, for the VPS, the parameter set manager 13 retains the coding parameters of the VPS for each VPS identifier (video_parameter_set_id). For the SPS, the parameter set manager 13 retains the coding parameters of the SPS for each SPS identifier (sps_seq_parameter_set_id). For the PPS, the parameter set manager 13 retains the coding parameters of the PPS for each PPS identifier (pps_pic_parameter_set_id).

The parameter set manager 13 supplies to the picture decoding unit 14 the coding parameters of the parameter set (active parameter set) that is referenced by the picture decoding unit 14, described later, in order to decode a picture. Specifically, first, the active PPS is specified by the active PPS identifier (slice_pic_parameter_set_id) that is included in the slice header SH decoded by the picture decoding unit 14. Next, the active SPS is specified by the active SPS identifier (pps_seq_parameter_set_id) that is included in the specified active PPS. Finally, the active VPS is specified by the active VPS identifier (sps_video_parameter_set_id) that is included in the active SPS. Then, the coding parameters of the active PPS, the active SPS, and the active VPS specified are supplied to the picture decoding unit 14. Specification of parameter sets that are referenced for decoding of a picture is also called “activation of parameter sets”. For example, specification of the active PPS, the active SPS, and the active VPS is respectively called “activation of the PPS”, “activation of the SPS”, and “activation of the VPS”.

The picture decoding unit 14 generates a decoded picture on the basis of the input VCL NAL, the active parameter sets (active PPS, active SPS, and active VPS), and the reference picture and supplies the decoded picture to the decoded picture manager 15. The decoded picture supplied is recorded in a buffer in the decoded picture manager 15. A detailed description of the picture decoding unit 14 will be described later.

The decoded picture manager 15 records the input decoded picture in an internal decoded picture buffer (DPB) and performs generation of a reference picture list and determination of an output picture. The decoded picture manager 15 outputs the decoded picture recorded in the DPB as the output picture POUT#T to an external unit at a predetermined timing.

(Parameter Set Decoding Unit 12)

The parameter set decoding unit 12 decodes parameter sets (VPS, SPS, and PPS) used in decoding of the target layer set from the input target layer set coded data. The coding parameters of the decoded parameter sets are supplied to the parameter set manager 13 and are recorded for each parameter set identifier.

Generally, decoding of a parameter set is performed on the basis of a predefined syntax table. That is, a bit string is read from the coded data in accordance with a procedure defined by the syntax table, and the syntax value of the syntax included in the syntax table is decoded. If necessary, a variable that is derived on the basis of the decoded syntax value may be derived and included in the output parameter set. Accordingly, the parameter sets output from the parameter set decoding unit 12 can be represented as a set of the syntax value of the syntax related to the parameter sets (VPS, SPS, and PPS) included in the coded data and the variable derived from the syntax value.

Hereinafter, of the syntax tables used for decoding in the parameter set decoding unit 12, syntax tables that have high relevance to the present invention will be mainly described.

(Video Parameter Set VPS)

The video parameter set VPS is a parameter set for defining parameters used in common in a plurality of layers and includes maximum layer number information, layer set information, and inter-layer dependency information as layer information and the VPS identifier for identification of each VPS.

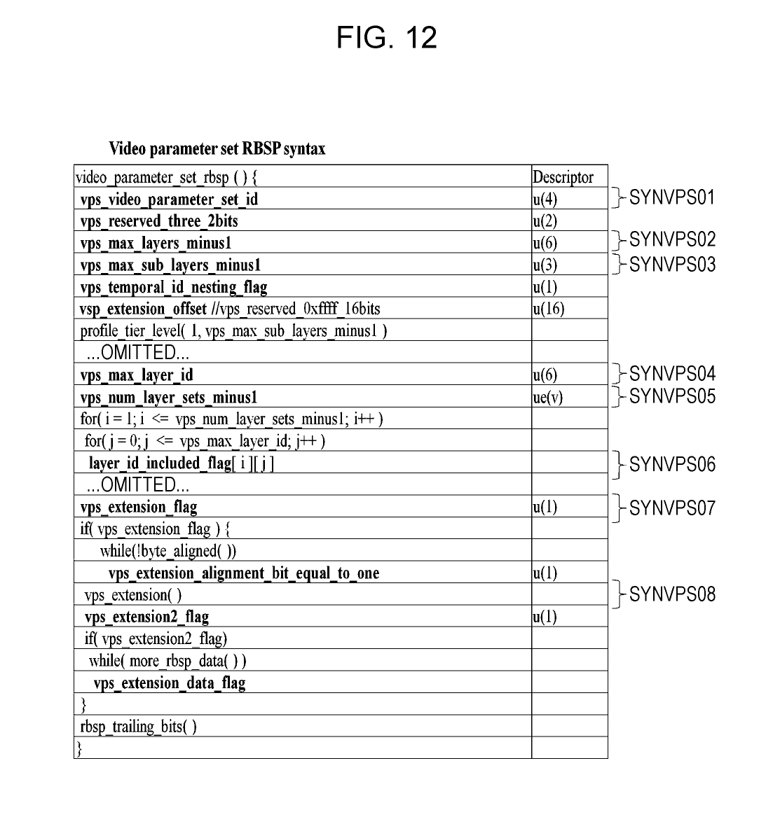

The VPS identifier is an identifier for identification of each VPS and is included as the syntax “video_parameter_set_id” (SYNVPS01 in FIG. 12) in the VPS. The VPS that is specified by the active VPS identifier (sps_video_parameter_set_id) included in the SPS described later is referenced at the time of performing a decoding process on the coded data of the target layer in the target layer set.

The maximum layer number information is information that represents the maximum number of layers in the hierarchically coded data and is included as the syntax “vps_max_layers_minus1” (SYNVPS02 in FIG. 12) in the VPS. The maximum number of layers (hereinafter, a maximum layer number MaxNumLayers) in the hierarchically coded data is set to the value of (vps_max_layers_minus1+1). The maximum number of layers defined here is the maximum number of layers related to the scalability (SNR scalability, spatial scalability, view scalability, and the like) other than temporal scalability.

Maximum sub-layer number information is information that represents the maximum number of sub-layers in the hierarchically coded data and is included as the syntax “vps_max_sub_layers_minus1” (SYNVPS03 in FIG. 12) in the VPS. The maximum number of sub-layers (hereinafter, a maximum sub-layer number MaxNumSubLayers) in the hierarchically coded data is set to the value of (vps_max_num_sub_layers_minus1+1). The maximum number of sub-layers defined here is the maximum number of layers related to temporal scalability.

Maximum layer identifier information is information that represents the layer identifier (layer ID) of the highermost layer included in the hierarchically coded data and is included as the syntax “vps_max_layer_id” (SYNVPS04 in FIG. 12) in the VPS. In other words, the maximum layer identifier information is the maximum value of the layer ID (nuh_layer_id) of the NAL unit included in the hierarchically coded data.

Layer set number information is information that represents the total number of layer sets included in the hierarchically coded data and is included as the syntax “vps_num_layer_sets_minus1” (SYNVPS05 in FIG. 12) in the VPS. The number of layer sets (hereinafter, a layer set number NumLayerSets) in the hierarchically coded data is set to the value of (vps_num_layer_sets_minus1+1).

The layer set information is a list (hereinafter, a layer ID list LayerSetLayerIdList) that represents a set of layers constituting a layer set included in the hierarchically coded data and is decoded from the VPS. The VPS includes the syntax “layer_id_included_flag[i][j]” (SYNVPS06 in FIG. 12) that indicates whether the layer having a layer identifier value of j (nuhLayerId=j) is included in the i-th layer set, and a layer set is configured of layers having a layer identifier for which the value of the syntax is one. That is, the layer j constituting the layer set i is included in the layer ID list LayerSetLayerIdList[i].

A VPS extension data present flag “vps_extension_flag” (SYNVPS07 in FIG. 12) is a flag that indicates whether the VPS further includes VPS extension data vps_extension( ) (SYNVPS08 in FIG. 12). If the expression “flag that indicates whether XX is present” or “flag for the presence of XX” is used in the present specification, the presence of XX will be indicated by the value one, and the absence of XX will be indicated by the value zero. In a logical complement, a logical product, and the like, the value one will be regarded as true and the value zero as false (the same applies hereinafter). However, other values can also be used for the values of true and false in a real-world device or a method.

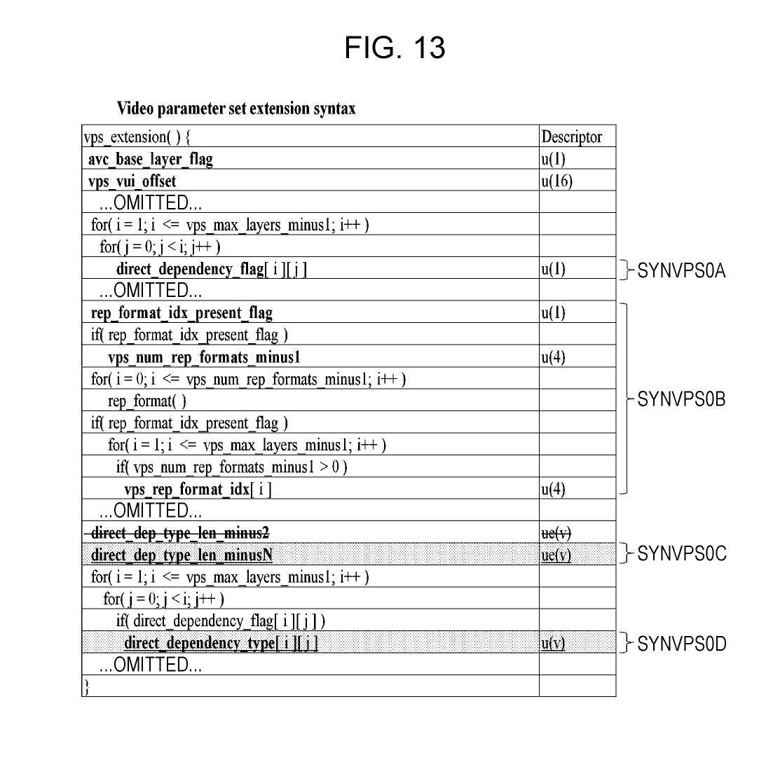

The inter-layer dependency information is decoded from the VPS extension data (vps_extension( )) included in the VPS. The inter-layer dependency information included in the VPS extension data will be described with reference to FIG. 13. FIG. 13 is a part of a syntax table referenced at the time of VPS extension decoding and illustrates a part related to the inter-layer dependency information.

The VPS extension data (vps_extension( )) includes a direct_dependency_flag “direct_dependency_flag[i][j]” (SYNVPS0A in FIG. 13) as the inter-layer dependency information. The direct_dependency_flag “direct_dependency_flag[i][j]” indicates whether the i-th layer is directly dependent on the j-th layer and has the value one if the i-th layer is directly dependent on the j-th layer or the value zero if the i-th layer is not directly dependent on the j-th layer. If the i-th layer is directly dependent on the j-th layer, this means there is a possibility that parameter sets, decoded pictures, and previously decoded relevant syntax related to the j-th layer are directly referenced by the target layer in a case of performing a decoding process on the i-th layer as the target layer. Conversely, if the i-th layer is not directly dependent on the j-th layer, this means that parameter sets, decoded pictures, and previously decoded relevant syntax related to the j-th layer are not directly referenced in a case of performing a decoding process on the i-th layer as the target layer. In other words, if the direct dependency flag of the i-th layer with respect to the j-th layer is equal to one, the j-th layer may be a direct reference layer for the i-th layer. A set of layers that may be a direct reference layer for a specific layer, that is, a set of layers having the value of a corresponding direct dependency flag equal to one, is called a direct dependent layer set. Since the layer with i=0, that is, the zeroth layer (base layer), is not in a direct dependency relationship with the j-th layer (enhancement layer), the value of the direct dependency flag “direct_dependency_flag[i][j]” is zero, and decoding/coding of the direct_dependency_flag of the j-th layer (enhancement layer) with respect to the zeroth layer (base layer) can be omitted as perceived from the loop including SYNVPS0A in FIG. 13 that starts from i=1.

A reference layer ID list RefLayerId[iNuhLId][ ] that indicates a direct reference layer set with respect to the i-th layer (layer identifier iNuhLId=nunLayerId1) and a direct reference layer IDX list DirectRefLayerIdx[iNuhLId][ ] that indicates the position in ascending order of an element corresponding to the j-th layer, which is a reference layer for the i-th layer, in the direct reference layer set are derived by an expression described later. The reference layer ID list RefLayerId[ ][ ] is a two-dimensional array in which the first array element stores the layer identifier of the target layer (layer i) and the second array element stores the layer identifier of the k-th reference layer in the direct reference layer set in ascending order. The direct reference layer IDX list DirectRefLayerIdx[ ][ ] is a two-dimensional array in which the first array element stores the layer identifier of the target layer (layer i) and the second array element stores an index (direct reference layer IDX) that indicates the position in ascending order of an element corresponding to the layer identifier in the direct reference layer set.

The reference layer ID list and the direct reference layer IDX list are derived by the pseudocode below. The layer identifier nuhLayerId of the i-th layer is represented by the syntax “layer_id_in_nuh[i]” (not illustrated in FIG. 13) in the VPS. Hereinafter, the layer identifier of the i-th layer “layer_id_in_nuh[i]” will be represented as “nuhLId#i” for simplification of representation. For layer_id_in_nuh[j], “nuhLId#j” will be used. An array NumDirectRefLayers[ ] represents the number of direct reference layers that are referenced by the layer having a layer identifier iNuhLId.

(Derivation of Reference Layer ID List and Direct Reference Layer IDX List)

Derivation of the reference layer ID list and the direct reference layer IDX list is performed by the following pseudocode.
for (i=0; i<vps_max_layers_minus1+1; i++){
iNuhLId=nuhLId#i;
NumDirectRefLayers[iNuhLId]=0;
for (j=0; j<i; j++){
if (direct_dependency_flag[i][j]){
RefLayerId[iNuhLId][NumDirectRefLayers[iNuhLId]]=nuhLId#j;
NumDirectRefLayers[iNuhLId]++;
DirectRefLayerIdx[iNuhLId][nuhLId#j]=
NumDirectRefLayers[iNuhLId]−1;
}
} // end of loop on for (j=0; j<i; i++)
} // end of loop on for (i=0; i<vps_max_layers_minus1+1; i++)

The above pseudocode may be represented in the following steps.

(SL01) Step SL01 is the starting point of a loop that is related to derivation of the reference layer ID list and the direct reference layer IDX list related to the i-th layer. The variable i is initialized to zero before the start of the loop. Processing inside the loop is performed when the variable i is less than the number of layers “vps_max_layers_minus1+1”, and the variable i is incremented by “1” each time the processing inside the loop is performed once.

(SL02) The variable iNuhLid is set to the layer identifier nuhLID#i of the i-th layer. The number NumDirectRefLayers[iNuhLID] of direct reference layers of the layer identifier nuhLID#i is set to zero. (SL03) Step SL03 is the starting point of a loop that is related to addition of the j-th layer as an element into the reference layer ID list and the direct reference layer IDX list related to the i-th layer. The variable j is initialized to zero before the start of the loop. Processing inside the loop is performed when the variable j (j-th layer) is less than the i-th layer (j<i), and the variable j is incremented by “1” each time the processing inside the loop is performed once.

(SL04) The direct_dependency_flag (direct_dependency_flag[i][j]) of the j-th layer with respect to the i-th layer is determined. If the direct dependency flag is equal to one, a transition is made to Step SL05 in order to perform the processes of Step SL05 to Step SL07. If the direct_dependency_flag is equal to zero, the processes of Step SL05 to SL07 are omitted, and a transition is made to Step SL0A.

(SL05) The NumDirectRefLayers[iNuhLId]-th element of the reference layer ID list RefLayerId[iNuhLId][ ] is set to the layer identifier nuhLID#j, that is, RefLayerId[iNuhLId][NumDirectRefLayers[iNuhLId]]=nuhLId#j;.

(SL06) The value of the number NumDirectRefLayers[iNuhLId] of direct reference layers is incremented by “1”, that is, NumDirectRefLayers[iNuhLId]++;.

(SL07) The nuhLId#j-th element of the direct reference layer IDX list DirectRefLayerIdx[iNuhLid][ ] is set to “number of direct reference layers−1” as the direct reference layer index (direct reference layer IDX), that is, DirectRefLayerIdx[iNuhLId][nuhLId#j]=NumDirectRefLayers[iNuhLId]−1;.

(SL0A) Step SL0A is the ending point of the loop that is related to addition of the j-th layer as an element into the reference layer ID list and the direct reference layer IDX list related to the i-th layer.

(SL0B) Step SL0B is the ending point of the loop that is related to derivation of the reference layer ID list and the direct reference layer IDX list of the i-th layer.

Use of the reference layer ID list and the direct reference layer IDX list described heretofore allows recognition of the position of an element (direct reference layer IDX) corresponding to the layer ID of the k-th layer of the direct reference layer set in all layers and, conversely, recognition of the position of an element corresponding to the direct reference layer IDX in the direct reference layer set. The derivation procedure is not limited to the above steps and may be changed to the extent possible.

(Derivation of Indirect Dependency Flag and Dependency Flag)

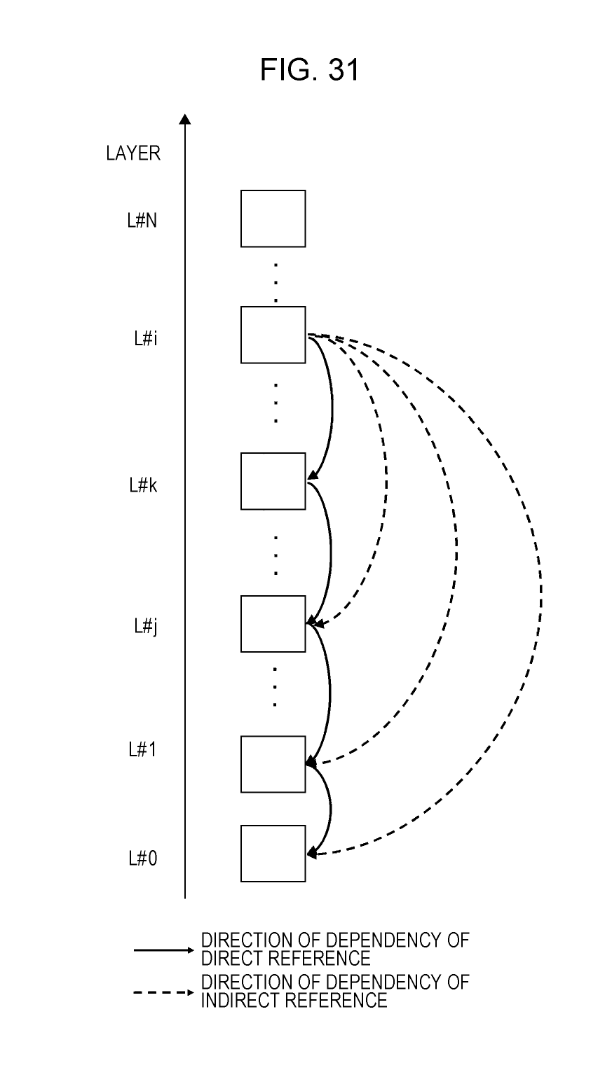

An indirect dependency flag (IndirectDependencyFlag[i][j]) that indicates a dependency relationship such as whether the i-th layer is indirectly dependent on the j-th layer (whether the j-th layer is an indirect reference layer for the i-th layer) can be derived by pseudocode described later by referencing the direct dependency flag (direct_dependency_flag[i][j]). Similarly, a dependency flag (DependencyFlag[i][j]) that indicates a dependency relationship such as whether the i-th layer is directly dependent on the j-th layer (if the direct dependency flag is equal to one, the j-th layer is said to be a direct reference layer for the i-th layer) or is indirectly dependent on the j-th layer (if the indirect dependency flag is equal to one, the j-th layer is said to be an indirect reference layer for the i-th layer) can be derived by pseudocode described later by referencing the direct_dependency_flag (direct_dependency_flag[i][j]) and the indirect dependency flag (IndirectDepdendencyFlag[i][j]). The indirect reference layer will be described with reference to FIG. 31. In FIG. 31, the number of layers is N+1, and the j-th layer (L#j in FIG. 31; called a layer j) is a lower layer below the i-th layer (L#i in FIG. 31; called a layer i) (j<i). In addition, there is a layer k (L#k in FIG. 31) that is higher than the layer j and lower than the layer i (j<k<i). In FIG. 31, the layer k is directly dependent on the layer j (a solid arrow in FIG. 31; the layer j is a direct reference layer for the layer k; direct_dependency_flag[k][j]==1), and the layer i is directly dependent on the layer k (the layer k is a direct reference layer for the layer j;

direct_dependency_flag[i][k]==1). Since the layer i is indirectly dependent on the layer j through the layer k (a dashed arrow in FIG. 31), the layer j is called an indirect reference layer for the layer i. In the example of FIG. 31, the layer j is directly dependent on a layer 1 (L#1 in FIG. 31), and the layer 1 is directly dependent on a layer 0 (L#0 in FIG. 31; base layer). Since the layer i is indirectly dependent on the layer 1 through the layer j, the layer 1 is an indirect reference layer for the layer i. Since the layer i is indirectly dependent on the layer 0 through the layer k, the layer j, and the layer 1, the layer 0 is an indirect reference layer for the layer i. In other words, if the layer i is indirectly dependent on the layer j through one or a plurality of layers k (i<k<j), the layer j is an indirect reference layer for the layer i.

The indirect dependency flag IndirectDependencyFlag[i][j] indicates whether the i-th layer is indirectly dependent on the j-th layer and has the value one if the i-th layer is indirectly dependent on the j-th layer or the value zero if the i-th layer is not indirectly dependent on the j-th layer. If the i-th layer is indirectly dependent on the j-th layer, this means there is a possibility that parameter sets, decoded pictures, and previously decoded relevant syntax related to the j-th layer are indirectly referenced by the target layer in a case of performing a decoding process on the i-th layer as the target layer. Conversely, if the i-th layer is not indirectly dependent on the j-th layer, this means that parameter sets, decoded pictures, and previously decoded relevant syntax related to the j-th layer are not indirectly referenced in a case of performing a decoding process on the i-th layer as the target layer. In other words, if the indirect dependency flag of the i-th layer with respect to the j-th layer is equal to one, the j-th layer may be an indirect reference layer for the i-th layer. A set of layers that may be an indirect reference layer for a specific layer, that is, a set of layers having the value of a corresponding indirect dependency flag equal to one, is called an indirect dependent layer set. Since the layer with i=0, that is, the zeroth layer (base layer), is not in an indirect dependency relationship with the j-th layer (enhancement layer), the value of the indirect dependency flag “IndirecctDepedencyFlag[i][j]” is zero, and derivation of the indirect dependency flag of the j-th layer (enhancement layer) with respect to the zeroth layer (base layer) can be omitted.

The dependency flag “DependencyFlag[i][j]” indicates whether the i-th layer is dependent on the j-th layer and has the value one if the i-th layer is dependent on the j-th layer or the value zero if the i-th layer is not dependent on the j-th layer. Reference or dependency related to the dependency flag DependencyFlag[i][j] is assumed to include both direct and indirect manners (direct reference, indirect reference, direct dependency and indirect dependency) unless otherwise specified. If the i-th layer is dependent on the j-th layer, this means there is a possibility that parameter sets, decoded pictures, and previously decoded relevant syntax related to the j-th layer are referenced by the target layer in a case of performing a decoding process on the i-th layer as the target layer. Conversely, if the i-th layer is not dependent on the j-th layer, this means that parameter sets, decoded pictures, and previously decoded relevant syntax related to the j-th layer are not referenced in a case of performing a decoding process on the i-th layer as the target layer. In other words, if the dependency flag of the i-th layer with respect to the j-th layer is equal to one, the j-th layer may be either a direct reference layer or an indirect reference layer for the i-th layer. A set of layers that may be either a direct reference layer or an indirect reference layer for a specific layer, that is, a set of layers having the value of a corresponding dependency flag equal to one, is called a dependent layer set. Since the layer with i=0, that is, the zeroth layer (base layer), is not in a dependency relationship with the j-th layer (enhancement layer), the value of the dependency flag “DepedencyFlag[i][j]” is zero, and derivation of the dependency flag of the j-th layer (enhancement layer) with respect to the zeroth layer (base layer) can be omitted.

```
  (Pseudocode)
  for(i = 0; i < vps_max_layers_minus1 + 1; i++){
  for (j = 0; j < i; j++){
  IndirectDependencyFlag[i][j] = 0;
  DependencyFlag[i][j] = 0;
  for (k = j + 1; k < i; k++){
  if(direct_dependency_flag[k][j] &&
  direct_dependency_flag[i][k] &&
  !direct_dependency_flag[i][j]){
  IndirectDependencyFlag[i][j] = 1;
  }
  }
  DependencyFlag[i][j] =
  (direct_dependency_flag[i][j] |
IndirectDependencyFlag[i][j]);
  } // end of loop on for (j = 0; j < i; i++)
  } // end of loop on for (i = 0; i <
vps_max_layers_minus1 + 1; i++)
```

The above pseudocode may be represented in the following steps.

(SN01) Step SN01 is the starting point of a loop that is related to derivation of the indirect dependency flag and the dependency flag related to the i-th layer. The variable i is initialized to zero before the start of the loop. Processing inside the loop is performed when the variable i is less than the number of layers “vps_max_layers_minus1+1”, and the variable i is incremented by “1” each time the processing inside the loop is performed once.

(SN02) Step SN02 is the starting point of a loop that is related to derivation of the indirect dependency flag and the dependency flag related to the i-th layer and the j-th layer. The variable j is initialized to zero before the start of the loop. Processing inside the loop is performed when the variable j (j-th layer) is less than the i-th layer (j<i), and the variable j is incremented by “1” each time the processing inside the loop is performed once.

(SN03) The j-th element of the indirect dependency flag IndirectDependencyFlag[i][ ] is set to zero, and the j-th element of the dependency flag DependencyFlag[i][ ] is set to zero, that is, IndirectDependencyFlag[i][j]=0 and DependencyFlag[i][j]=0.

(SN04) Step SN04 is the starting point of a loop for searching whether the j-th layer is an indirect reference layer for the i-th layer. The variable k is initialized to “j+1” before the start of the loop. Processing inside the loop is performed when the value of the variable k is less than the variable i, and the variable k is incremented by “1” each time the processing inside the loop is performed once.

(SN05) The following conditions (1) to (3) are determined in order to determine whether the j-th layer is an indirect reference layer for the i-th layer.

(1) A determination of whether the j-th layer is a direct reference layer for the k-th layer is performed. Specifically, the determination results in true (the j-th layer is a direct reference layer for the k-th layer) if the direct_dependency_flag of the j-th layer with respect to the k-th layer (direct_dependency_flag[k][j]) is equal to one or results in false if the direct_dependency_flag is equal to zero (the j-th layer is not a direct reference layer for the k-th layer).

(2) A determination of whether the k-th layer is a direct reference layer for the i-th layer is performed. Specifically, the determination results in true (the k-th layer is a direct reference layer for the i-th layer) if the direct_dependency_flag of the k-th layer with respect to the i-th layer (direct_dependency_flag[i][k]) is equal to one or results in false if the direct_dependency_flag is equal to zero (the k-th layer is not a direct reference layer for the i-th layer).

(3) A determination of whether the j-th layer is not a direct reference layer for the i-th layer is performed. Specifically, the determination results in true if the direct_dependency_flag of the j-th layer with respect to the i-th layer (direct_dependency_flag[i][j]) is equal to zero (the j-th layer is not a direct reference layer for the i-th layer) or results in false if the direct_dependency_flag is equal to one (the j-th layer is a direct reference layer for the i-th layer).

A transition is made to Step SN06 if all of the above conditions (1) to (3) result in true (that is, if the direct dependency flag direct_dependency_flag[k][j] of the j-th layer with respect to the k-th layer is equal to one, the direct_dependency_flag direct_dependency_flag[i][k] of the k-th layer with respect to the i-th layer is equal to one, and the direct_dependency_flag direct_dependency_flag[i][j] of the j-th layer with respect to the i-th layer is equal to zero). Otherwise (if any one of (1) to (3) results in false, that is, if the direct_dependency_flag direct_dependency_flag[k][j] of the j-th layer with respect to the k-th layer is equal to zero, the direct dependency flag direct_dependency_flag[i][k] of the k-th layer with respect to the i-th layer is equal to zero, or the direct dependency flag direct_dependency_flag[i][j] of the j-th layer with respect to the i-th layer is equal to one), the process of Step SN06 is omitted, and a transition is made to Step SN07.

(SN06) If all of the above conditions (1) to (3) result in true, the j-th layer is determined to be an indirect reference layer for the i-th layer, and the value of the j-th element of the indirect dependency flag IndirectDependencyFlag[i][ ] is set to one, that is, IndirectDependencyFlag[i][j]=1.

(SN07) Step SN07 is the ending point of the loop for searching whether the j-th layer is an indirect reference layer for the i-th layer.

(SN08) The value of the dependency flag (DependencyFlag[i][j]) is set on the basis of the direct dependency flag (direct_dependency_flag[i][j]) and the indirect dependency flag (IndirectDependencyFlag[i][j]). Specifically, the value of the dependency flag (DependencyFlag[i][j]) is set to the value resulting from the logical sum of the value of the direct_dependency_flag (direct_dependency_flag[i][j]) and the value of the indirect dependency flag (direct_dependency_flag[i][j]). That is, derivation is performed by the expression below. The value of the dependency flag is set to one if the value of the direct_dependency_flag is one or the value of the indirect dependency flag is one. Otherwise (if the value of the direct_dependency_flag is zero and the value of the indirect dependency flag is zero), the value of the dependency flag is set to zero. The following derivation expression is merely an example and can be changed to the extent resulting in the same values set for the dependency flag.

DependencyFlag[i][j]=(direct_dependency_flag[i][j]|IndirectDependencyFlag[i][j]);

(SN0A)) Step SN0A is the ending point of the loop that is related to derivation of the indirect dependency flag and the dependency flag related to the i-th layer and the j-th layer.

(SN0B) Step SN0B is the ending point of the loop that is related to derivation of the indirect dependency flag and the dependency flag related to the i-th layer.

As described heretofore, derivation of the indirect dependency flag (IndirectDependencyFlag[i][j]) which indicates a dependency relationship in a case where the i-th layer is indirectly dependent on the j-th layer allows recognition of whether the j-th layer is an indirect reference layer for the i-th layer. In addition, derivation of the dependency flag (DependencyFlag[i][j]) which indicates a dependency relationship in a case where the i-th layer is dependent on the j-th layer (in a case where the direct_dependency_flag is equal to one or the indirect dependency flag is equal to one) allows recognition of whether the j-th layer is a direct reference layer or an indirect reference layer for the i-th layer. The derivation procedure is not limited to the above steps and may be changed to the extent possible. For example, derivation of the indirect dependency flag and the dependency flag may be performed by the following pseudocode.

```
  (Pseudocode)
  // derive indirect reference layers of layer i
  for(i = 2; i < vps_max_layers_minus1 + 1; i++){
  for (k = 1; k < i; k++){
  for(j = 0; j < k; j++){
  if((direct_dependency_flag[k][j] ||
  IndirectDependencyFlag[k][j])
  direct_dependency_flag[i][k] &&
  !direct_dependency_flag[i][j]){
  IndirectDependencyFlag[i][j] = 1;
  }
  } // end of loop on for(j = 0; j < k; j++)
  } // end of loop on for (k = 1; k < i; k++)
  } // end of loop on for (i = 2; i <
vps_max_layers_minus1 + 1; i++)
  // derive dependent layers (direct or indirect
reference layers) of layer i
  for(i = 0; i < vps_max_layers_minus1 + 1; i++){
  for (j = 0; j < i; j++){
  DependencyFlag[i][j] =
  (direct_dependency_flag[i][j] |
IndirectDependencyFlag[i][j]);
  } // end of loop on for (j = 0; j < i; i++)
  } // end of loop on for (i = 0; i <
vps_max_layers_minus1 + 1; i++)
```

The above pseudocode may be represented in the following steps. The values of all elements of the indirect dependency flag IndirectDependencyFlag[ ][ ] and the dependency flag DependencyFlag[ ][ ] are assumed to be previously initialized to zero before the start of Step SO01.

(SO01) Step SO01 is the starting point of a loop that is related to derivation of the indirect dependency flag related to the i-th layer (layer i). The variable i is initialized to two before the start of the loop. Processing inside the loop is performed when the variable i is less than the number of layers “vps_max_layers_minus1+1”, and the variable i is incremented by “1” each time the processing inside the loop is performed once. The reason why the variable i starts from two is that an indirect reference layer occurs only if the number of layers is greater than or equal to three.

(SO02) Step SO02 is the starting point of a loop that is related to the k-th layer (layer k) which is a lower layer below the i-th layer (layer i) and a higher layer above the j-th layer (layer j) (j<k<i). The variable i is initialized to one before the start of the loop. Processing inside the loop is performed when the variable k (layer k) is less than the layer i (k<i), and the variable k is incremented by “1” each time the processing inside the loop is performed once. The reason why the variable k starts from one is that an indirect reference layer occurs only if the number of layers is greater than or equal to three.

(SO03) Step SO03 is the starting point of a loop for searching whether the layer j is an indirect reference layer for the layer i. The variable j is initialized to zero before the start of the loop. Processing inside the loop is performed when the variable j (layer j) is less than the layer k (j<k), and the variable j is incremented by “1” each time the processing inside the loop is performed once.

(SO04) The following conditions (1) to (3) are determined in order to determine whether the layer j is an indirect reference layer for the layer i.

(1) A determination of whether the layer j is a direct reference layer or an indirect reference layer for the layer k is performed. Specifically, the determination results in true (the layer j is either a direct reference layer or an indirect reference layer for the layer k) if the direct dependency flag of the layer j with respect to the layer k (direct_dependency_flag[k][j]) is equal to one or the indirect dependency flag of the layer j with respect to the layer k (IndirectDependencyFlag[k][j]) is equal to one. The determination results in false if the direct_dependency_flag is equal to zero (the layer j is not a direct reference layer for the layer k) and the indirect dependency flag is equal to zero (the layer j is not an indirect reference layer for the layer k).

(2) A determination of whether the layer k is a direct reference layer for the layer i is performed. Specifically, the determination results in true (the layer k is a direct reference layer for the layer i) if the direct dependency flag of the layer k with respect to the layer i (direct_dependency_flag[i][k]) is equal to one or results in false if the direct_dependency_flag is equal to zero (the layer k is not a direct reference layer for the layer i).

(3) A determination of whether the layer j is not a direct reference layer for the layer i is performed. Specifically, the determination results in true if the direct_dependency_flag of the layer j with respect to the layer i (direct_dependency_flag[i][j]) is equal to zero (the layer j is not a direct reference layer for the layer i) or results in false if the direct_dependency_flag is equal to one (the layer j is a direct reference layer for the layer i).

A transition is made to Step SN06 if all of the above conditions (1) to (3) result in true (that is, if the direct dependency flag or the indirect dependency flag of the layer j with respect to the layer k is equal to one, the direct dependency flag direct_dependency_flag[i][k] of the layer with respect to the layer i is equal to one, and the direct dependency flag direct_dependency_flag[i][j] of the layer with respect to the layer i is equal to zero). Otherwise (if any one of (1) to (3) results in false, that is, if the direct_dependency_flag and the indirect dependency flag of the layer j with respect to the layer k are equal to zero, the direct_dependency_flag direct_dependency_flag[i][k] of the layer with respect to the layer i is equal to zero, or the direct_dependency_flag direct_dependency_flag[i][j] of the layer with respect to the layer i is equal to one), the process of Step SO05 is omitted, and a transition is made to Step SO06.

(SO05) If all of the above conditions (1) to (3) result in true, the layer j is determined to be an indirect reference layer for the layer i, and the value of the j-th element of the indirect dependency flag IndirectDependencyFlag[i][ ] is set to one, that is, IndirectDependencyFlag[i][j]=1.

(SO06) Step SO06 is the ending point of the loop for searching whether the layer j is an indirect reference layer for the layer i.

(SO07) Step SO07 is the ending point of the loop that is related to the layer k which is a lower layer below the layer i and a higher layer above the layer j (j<k<i).

(SO08) Step SO08 is the ending point of the loop that is related to derivation of the indirect dependency flag related to the layer i.

(SO0A) Step SO0A is the starting point of a loop that is related to derivation of the dependency flag related to the layer i. The variable i is initialized to zero before the start of the loop. Processing inside the loop is performed when the variable i is less than the number of layers “vps_max_layers_minus1+1”, and the variable i is incremented by “1” each time the processing inside the loop is performed once.

(SO0B) Step SO0B is the starting point of a loop that searches whether the layer j is a dependent layer (direct reference layer or indirect reference layer) of the layer i. The variable j is initialized to zero before the start of the loop. Processing inside the loop is performed when the variable j is less than the variable i (j<i), and the variable j is incremented by “1” each time the processing inside the loop is performed once.

(SO0C) The value of the dependency flag (DependencyFlag[i][j]) is set on the basis of the direct dependency flag (direct_dependency_flag[i][j]) and the indirect dependency flag (IndirectDependencyFlag[i][j]). Specifically, the value of the dependency flag (DependencyFlag[i][j]) is set to the value resulting from the logical sum of the value of the direct_dependency_flag (direct_dependency_flag[i][j]) and the value of the indirect dependency flag (direct_dependency_flag[i][j]). That is, derivation is performed by the expression below. The value of the dependency flag is set to one if the value of the direct_dependency_flag is one or the value of the indirect dependency flag is one. Otherwise (if the value of the direct_dependency_flag is zero and the value of the indirect dependency flag is zero), the value of the dependency flag is set to zero. The following derivation expression is merely an example and can be changed to the extent resulting in the same values set for the dependency flag.

DependencyFlag[i][j]=(direct_dependency_flag[i][j]|IndirectDependencyFlag[i][j]);

(SO0D) Step SO0D is the ending point of the loop that searches whether the layer j is a dependent layer (direct reference layer or indirect reference layer) of the layer i.

(SO0E) Step SO0E is the ending point of the loop that is related to derivation of the dependency flag related to the layer i.

As described heretofore, derivation of the indirect dependency flag (IndirectDependencyFlag[i][j]) which indicates a dependency relationship in a case where the layer i is indirectly dependent on the layer j allows recognition of whether the layer j is an indirect reference layer for the layer i. In addition, derivation of the dependency flag (DependencyFlag[i][j]) which indicates a dependency relationship in a case where the layer i is dependent on the layer j (in a case where the direct dependency flag is equal to one or the indirect dependency flag is equal to one) allows recognition of whether the layer j is a dependent layer (direct reference layer or indirect reference layer) of the layer i. The derivation procedure is not limited to the above steps and may be changed to the extent possible.

While, in the above example, the dependency flag DipendecyFlag[i][j] which indicates whether the j-th layer is a direct reference layer or an indirect reference layer for the i-th layer is derived with respect to the indexes i and j in all layers, a dependency flag between layer identifiers (inter layer identifier dependency flag) LIdDipendencyFlag[ ][ ] may be derived as the layer identifier nuhLId#i of the i-th layer and the layer identifier nuhLId#j of the j-th layer. In this case, in Step SN08, the value of the inter layer identifier dependency flag (LIdDependencyFlag[nuhLId#i][nuhLId#j]) is derived by using the layer identifier nuhLId#i of the i-th layer as the first element of the inter layer identifier dependency flag (LIdDependencyFlag[ ][ ]) and using the layer identifier nuhLId#j of the j-th layer as the second element thereof. That is, as illustrated by the following expression, the value of the inter layer identifier dependency flag is set to one if the value of the direct_dependency_flag is one or the value of the indirect dependency flag is one. Otherwise (if the value of the direct_dependency_flag is zero and the value of the indirect dependency flag is zero), the value of the inter layer identifier dependency flag is set to zero.

LIdDependencyFlag[nuhLId#i][nuhLId#j]=(direct_dependency_flag[i][j]|IndirectDependencyFlag[i][j]);

As described heretofore, derivation of the inter layer identifier dependency flag (Lid0DependencyFlag[nuhLId#i][nuhLId#j]) which indicates whether the i-th layer having the layer identifier nuhLId#i is directly or indirectly dependent on the j-th layer having the layer identifier nuhLId#j allows recognition of whether the j-th layer having the layer identifier nuhLId#j is a direct reference layer or an indirect reference layer for the i-th layer having the layer identifier nuhLId#i. The above procedure is not limited thereto and may be changed to the extent possible.

The inter-layer dependency information includes the syntax “direct_dependency_len_minusN” (layer dependency type bit length) (SYNVPS0C in FIG. 13) that indicates a bit length M of the layer dependency type (direct_dependency_type[i][j]) described later. N is a value determined by the total number of layer dependency types and is at least an integer greater than or equal to two. The maximum value of the bit length M is, for example, 32, and the range of the value of the direct_dependency_type[i][j] is from 0 to (2̂32−2) in a case of N=2. More generally, the range of the value of direct_dependency_type[i][j] is, if represented by using the bit length M and N which is determined by the total number of layer dependency types, from 0 to (2̂M−N).

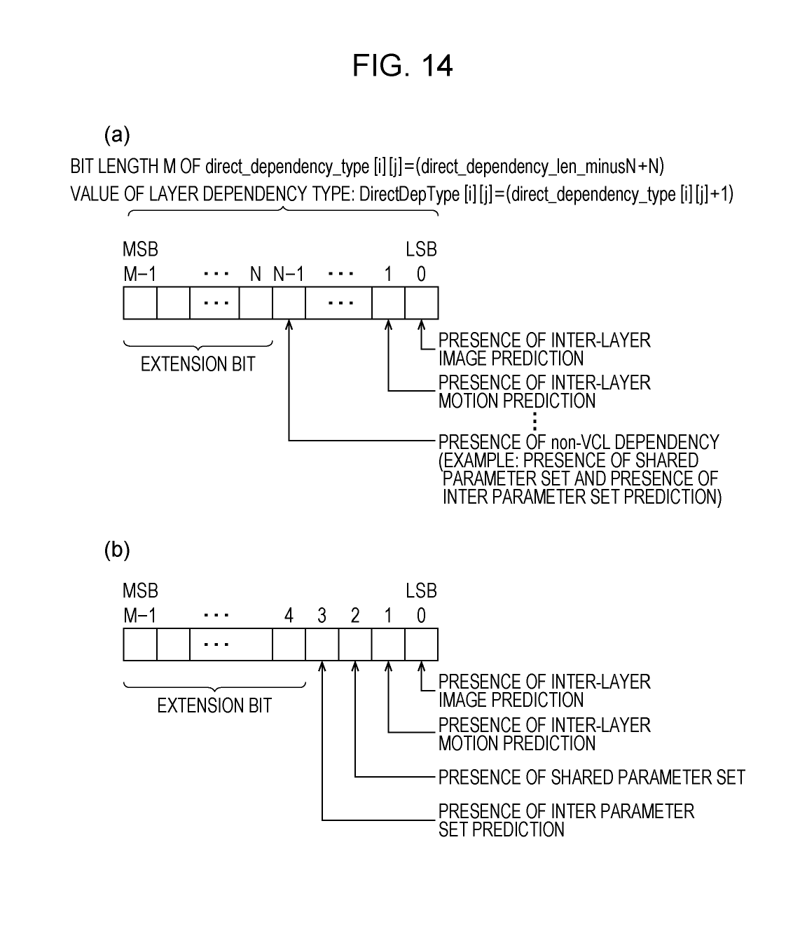

The inter-layer dependency information includes the syntax “direct_dependency_type[i][j]” (SYNVPS0D in FIG. 13) that indicates a layer dependency type indicating a reference relationship between the i-th layer and the j-th layer. Specifically, if the direct_dependency_flag direct_dependency_flag[i][j] is equal to one, each bit value of a layer dependency type (DirectDepType[i][j]=direct_dependency_type[i][j]+1) indicates a flag for the presence of layer dependency types of the j-th layer which is a reference layer for the i-th layer. For example, flags for the presence of layer dependency types include a flag for the presence of inter-layer image prediction (SamplePredEnabledFlag; inter-layer image prediction present flag), a flag for the presence of inter-layer motion prediction (MotionPredEnabledFlag; inter-layer motion prediction present flag), and a flag for the presence of non-VCL dependency (NonVCLDepEnabledFlag; non-VCL dependency present flag). The non-VCL dependency present flag indicates the presence of an inter-layer dependency relationship related to the header information (parameter sets such as the SPS and the PPS) included in the non-VCL NAL unit. For example, the presence of sharing of a parameter set (shared parameter set) between layers, described later, and the presence of syntax prediction of a part of a parameter set between layers (for example, scaling list information (quantization matrix) and the like) (referred to as inter parameter set syntax prediction or inter parameter set prediction) are included. The value coded by the syntax “direct_dependency_type[i][j]” is equal to layer dependency type value−1, that is, the value of “DirectDepType[i][j]−1”, in the example of FIG. 14.

An example of a correspondence between the layer dependency type value (DirectDepType[i][j]=direct_dependency_type[i][j]+1) and layer dependency types according to the present embodiment is illustrated in FIG. 14(a). As illustrated in FIG. 14(a), the value of the least significant bit (bit 0) indicates the presence of inter-layer image prediction, the value of the first bit from the least significant bit indicates the presence of inter-layer motion prediction, and the value of the (N−1)-th bit from the least significant bit indicates the presence of non-VCL dependency. Each bit of the N-th bit to the most significant bit ((M−1)-th bit) from the least significant bit is a dependency type extension bit.

The flags for the presence of each layer dependency type of the reference layer j with respect to the target layer i (layer identifier iNuhLId=nunLayerId1) are derived by the following expression.

SamplePredEnabledFlag[iNuhLId][j]=((direct_dependency_type[i][j]+1)&1);

MotionPredEnabledFlag[iNuhLId][j]=((direct_dependency_type[i][j]+1)&2)>>1;

NonVCLDepEnabledFlag[iNuhLid][j]=((direct_dependency_type[i][j]+1)&(1<<(N−1)))>>(N−1);

Alternatively, the flags can be represented by the following expression by using the variable

DirectDepType[i][j] instead of (direct_dependency_type[i][j]+1).

SamplePredEnabledFlag[iNuhLId][j]=((DirectDepType[i][j])&1);

MotionPredEnabledFlag[iNuhLId][j]=((DirectDepType[i][j])&2)>>1;

NonVCLDepEnabledFlag[iNuhLid][j]=((DirectDepType[i][j])&(1<<(N−1)))>>(N−1);

While the (N−1)-th bit is used for the non-VCL dependency type (non-VCL dependency present flag) in the example of FIG. 14(a), the present embodiment is not limited to this. For example, the second bit from the least significant bit may be used as a bit representing the presence of the non-VCL dependency type with N=3. The position of the bit indicating the flag for the presence of each dependency type may be changed to the extent possible. Derivation of above each present flag may be performed by performing Step SL08 in (Derivation of Reference Layer ID List and Direct Reference Layer IDX List) described above. The derivation procedure is not limited to the above steps and may be changed to the extent possible.

A non-VCL dependent layer set (non-VCL dependent layer ID list NonVCLDepRefLayerId[iNuh][ ] and direct non-VCL dependent layer IDX list DirectNonVCLDepRefLayerIdX[iNuh][ ]) can be derived as a subset of the direct reference layer set of the i-th layer on the basis of the non-VCL dependency present flag. The non-VCL dependent layer ID list NonVCLDepRefLayerId[ ][ ] is a two-dimensional array in which the first array element stores the layer identifier of the target layer (layer i) and the second array element stores the layer identifier of the k-th reference layer having the non-VCL dependency present flag of one in the direct reference layer set. The direct non-VCL dependent layer IDX list DirectNonVCLDepRefLayerId[ ][ ] is a two-dimensional array in which the first array element stores the layer identifier of the target layer (layer i) and the second array element stores an index (direct non-VCL dependent layer IDX) that indicates the position in ascending order of an element corresponding to the layer identifier having the non-VCL dependency present flag of one in the non-VCL dependent layer set.

Basically, of non-VCL NAL units, a non-VCL NAL unit that has dependency on picture decoding is a parameter set. That is, of non-VCL NAL units, the SEI which is supplemental information and the AUD, the EOS, and the EOB which indicate boundaries of a stream do not affect a picture decoding operation. Thus, while the flag that indicates non-VCL dependency is introduced above for more general definition, a flag that indicates parameter set dependency may be more directly defined instead of the flag indicating non-VCL dependency. In a case of defining the flag that indicates parameter set dependency, assignment of the flag to the direct_dependency_type[ ][ ] is processed in the same manner as in a case of non-VCL dependency (the same applies hereinafter). In a case of defining the flag for parameter set dependency, the name of the list derived may be changed from NonVCLDepRefLayerId to ParameterSetDepRefLayerId or the like.

(Derivation of Non-VCL Dependent Layer ID List and Direct Non-VCL Dependent Layer IDX List)

Derivation of the non-VCL dependent layer ID list is performed by the following pseudocode.

```
  for(i = 1; i < vps_max_layers_minus1 + 1; i++){
  iNuhLId = nuhLId#i;
  NumNonVCLDepRefLayers[iNuhLId] = 0;
  for (j = 0; j < i; j++){
  if(NonVCLDepEnabledFlag[i][j]){
  NonVCLDepRefLayerId[iNuhLId][NumNonVCLDepRefLayers[iNuh
LId]] = nuhLId#j;
  NumNonVCLDepRefLayers[iNuhLId]++;
  DirectNonVCLDepRefLayerIdx[iNuhLId][nuhLId#j] =
NumNonVCLDepRefLayers[iNuhLId] − 1;
  }
  } // end of loop on for (j = 0; j < i; i++)
  } // end of loop on for (i = 1; i <
vps_max_layers_minus1 + 1; i++)
```

The above pseudocode may be represented in the following steps.

(SN01) Step SN01 is the starting point of a loop that is related to derivation of the non-VCL dependent layer ID list and the direct non-VCL layer IDX list related to the i-th layer. The variable i is initialized to zero before the start of the loop. Processing inside the loop is performed when the variable i is greater than or equal to one and less than the number of layers “vps_max_layers_minus1+1”, and the variable i is incremented by “1” each time the processing inside the loop is performed once. In a case of variable i=0, this indicates the base layer that is not dependent on an enhancement layer, and thus, the processing is omitted.

(SN02) The variable iNuhLid is set to the layer identifier nuhLID#i of the i-th layer. A number NumDirectNonVCLDepRefLayers[iNuhLID] of direct non-VCL dependent layers of the layer identifier nuhLID#i is set to zero.

(SN03) Step SN03 is the starting point of a loop that is related to addition of the j-th layer as an element into the non-VCL dependent layer ID list and the direct non-VCL dependent layer IDX list related to the i-th layer. The variable j is initialized to zero before the start of the loop. Processing inside the loop is performed when the variable i is less than i-th layer−1 “i−1”, and the variable j is incremented by “1” each time the processing inside the loop is performed once. (SN04) A determination of the non-VCL dependency present flag of the j-th layer with respect to the i-th layer (NonVCLDepEnabledFlag[i][j]) is performed. If the non-VCL dependency present flag is equal to one, a transition is made to Step SN05 in order to perform the processes of Step SN05 to Step SN0X. If the non-VCL dependency present flag is equal to zero, the processes of Step SN05 to Step SN07 are omitted, and a transition is made to SN0A.

(SN05) The NumDirectNonVCLDepRefLayers[iNuhLId]-th element of the non-VCL dependent layer ID list NonVCLDepRefLayerId[iNuhLId][ ] is set to the layer identifier nuhLID#j, that is, NonVCLDepRefLayerId[iNuhLId][NumDirectnonVCLDepRefLayers[iNuhLId]]=nuhLId#j;.

(SN06) The value of the number NumDirectNonVCLDepRefLayers[iNuhLId] of direct non-VCL dependent layers is incremented by “1”, that is, NumDirectNonVCLDepRefLayers[iNuhLId]++;.

(SN07) The nuhLId#j-th element of the direct non-VCL dependent layer IDX list DirectNonVCLDepRefLayerIdX[iNuhLid][ ] is set to the value of “number of direct non-VCL dependent layers−1” as the direct non-VCL dependent layer IDX, that is, DirectNonVCLDepRefLayerIdX[iNuhLId][nuhLId#j]=NumDirectNonVCLDepRefLayers[iNuhLId]−1;.

(SN0A) Step SN0A is the ending point of the loop that is related to addition of the j-th layer as an element into the non-VCL dependent layer ID list and the direct non-VCL dependent layer IDX list related to the i-th layer.

(SN0B) Step SN0B is the ending point of the loop that is related to derivation of the non-VCL dependent layer ID list and the direct non-VCL dependent layer IDX list of the i-th layer.

In a case of variable i=0, the value of the number NumDirectNonVCLDepRefLayers[0] of direct non-VCL dependent layers is zero, that is, “NumDirectNonVCLDepRefLayers[0]=0”.

Use of the non-VCL dependent layer ID list and the direct non-VCL layer IDX list described heretofore allows recognition of the position of an element (direct non-VCL dependent layer IDX) corresponding to the layer ID of the k-th layer of the direct reference layer set having the non-VCL dependency present flag of one in all layers and, conversely, recognition of the position of an element corresponding to the direct non-VCL dependent layer IDX having the non-VCL dependency present flag of one in the direct reference layer set. The derivation procedure is not limited to the above steps and may be changed to the extent possible.

(Effect of Non-VCL Dependency Type)

As described heretofore, the non-VCL dependency type that indicates the presence of the dependency type between non-VCLs is newly introduced in the present embodiment as a layer dependency type in addition to the dependency type between VCLs (inter-layer image prediction and inter-layer motion prediction). Types of dependency between non-VCLs include sharing of a parameter set (shared parameter set) between different layers and prediction (inter parameter set syntax prediction) of a part of syntax between parameter sets in different layers.

Explicit notification of the presence of the non-VCL dependency type (non-VCL dependency type) accomplishes the effect that a decoder can recognize which layer in the layer set is a dependent layer of the target layer in the non-VCL (non-VCL dependent layer) by decoding the VPS extension data. That is, since recognition of whether the non-VCL of the layer A having the layer identifier value of nuhLayerIdA is referenced from the layer B having the layer identifier nuhLayerIdB different from nuhLayerIdA can be performed before the start of decoding of the non-VCL other than the VPS, it is possible to recognize a layer ID of which the non-VCL is to be decoded or extracted, in a case of decoding or extracting only the coded data of a certain layer ID (or a layer set). That is, what can be resolved is a problem that arises in a technology of the related art in that a parameter set of a layer ID that is to be decoded or extracted is not known in a case where only coded data of a certain layer ID (or layer set) is decoded or extracted because a layer in which the parameter set of the layer A having the layer identifier value of nuhLayerIdA is used in common (a layer to which a shared parameter set is applied) is not known until the start of decoding of the coded data.

Similarly, it is possible to recognize whether a parameter set of the layer A having the layer identifier nuhLayerIdA is referenced from the layer B having the layer identifier nuhLayerIdB different from nuhLayerIdA on the basis of the non-VCL dependency type. In other words, it is possible to recognize whether a parameter set of the layer A having the layer identifier nuhLayerIdA is referenced as a shared parameter set from the layer B having the layer identifier nuhLayerIdB different from nuhLayerIdA on the basis of the non-VCL dependency type. Similarly, it is possible to recognize whether a parameter set of the layer A having the layer identifier nuhLayerIdA is referenced by inter parameter set prediction from the layer B having the layer identifier nuhLayerIdB different from nuhLayerIdA.

(Bitstream Constraints Related to Non-VCL Dependency Type)

Introduction of the presence of the dependency type between non-VCLs allows explicit representation of the following bitstream constraints between a decoder and an encoder. A bitstream conformance refers to a condition that a bitstream decoded by a hierarchical moving image decoding device (hierarchical moving image decoding device according to the embodiment of the present invention) is required to satisfy.

That is, a bitstream has to satisfy the following condition CX1 as the bitstream conformance.

CX1: “When the non-VCL having the layer identifier nuhLayerIdA is a non-VCL that is used by the layer having the layer identifier nuhLayerIdB, the layer having the layer identifier nuhLayerIdA is a direct reference layer for the layer identifier nuhLayerIdB and has the non-VCL dependency present flag equal to one”.

The condition CX1 can also be represented as the following condition CX1′.

CX1′: “When the non-VCL having the layer identifier nuh_layer_id equal to nuhLayerIdA is a non-VCL that is used (referenced) by the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

In other words, the bitstream constraint CX1 states that the non-VCL of a layer that can be referenced by the target layer is a non-VCL having the layer identifier of a direct reference layer for the target layer.

The expression “the non-VCL of a layer that can be referenced by the target layer is a non-VCL having the layer identifier of a direct reference layer for the target layer” means forbidding “reference of the non-VCL of a layer included in the layer set A but not included in the layer set B by a layer in the layer set B which is a subset of the layer set A”.

That is, since “reference of the non-VCL of a layer included in the layer set A but not included in the layer set B by a layer in the layer set B which is a subset of the layer set A” can be forbidden when the layer set B, which is a subset, is extracted from the layer set A by using the bitstream extraction, the non-VCL of a different layer that is referenced by a layer included in the layer set B is not destroyed. Therefore, what can be resolved is the problem that a layer that references the non-VCL of a different layer cannot be decoded in a sub-bitstream generated by the bitstream extraction.

If the condition CX1 is limited to a shared parameter set, a bitstream has to satisfy the following condition CX2 as the bitstream conformance.

CX2: “When the parameter sets having the layer identifier nuhLayerIdA are the active parameter sets of the layer having the layer identifier nuhLayerIdB, the layer having the layer identifier nuhLayerIdA is a direct reference layer for the layer identifier nuhLayerIdB and has the non-VCL dependency present flag equal to one”.

The condition CX2 can also be represented as the following condition CX2′.

CX2′: “When the parameter sets having the layer identifier nuh_layer_id equal to nuhLayerIdA are the active parameter sets of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

If the constraint condition CX2 is limited to a shared parameter set related to the SPS and a shared parameter set related to the PPS, a bitstream has to satisfy each of the following conditions CX3 and CX4 as the bitstream conformance.

CX3: “When the SPS having the layer identifier nuhLayerIdA is the active SPS of the layer having the layer identifier nuhLayerIdB, the layer having the layer identifier nuhLayerIdA is a direct reference layer for the layer identifier nuhLayerIdB and has the non-VCL dependency present flag equal to one”.

CX4: “When the PPS having the layer identifier nuhLayerIdA is the active PPS of the layer having the layer identifier nuhLayerIdB, the layer having the layer identifier nuhLayerIdA is a direct reference layer for the layer identifier nuhLayerIdB and has the non-VCL dependency present flag equal to one”.

The conditions CX3 and CX4 can also be respectively represented as the following conditions CX3′ and CX4′.

CX3′: “When the PPS having the layer identifier nuh_layer_id equal to nuhLayerIdA is the active PPS of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

CX4′: “When the SPS having the layer identifier nuh_layer_id equal to nuhLayerIdA is the active SPS of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

In other words, the bitstream constraints CX2 to CX4 state that a parameter set that can be used as a shared parameter set is a parameter set having the layer identifier of a direct reference layer for the target layer.

The expression “a parameter set that can be used as a shared parameter set is a parameter set having the layer identifier of a direct reference layer for the target layer” means forbidding “reference of the parameter sets of a layer included in the layer set A but not included in the layer set B by a layer in the layer set B which is a subset of the layer set A”.

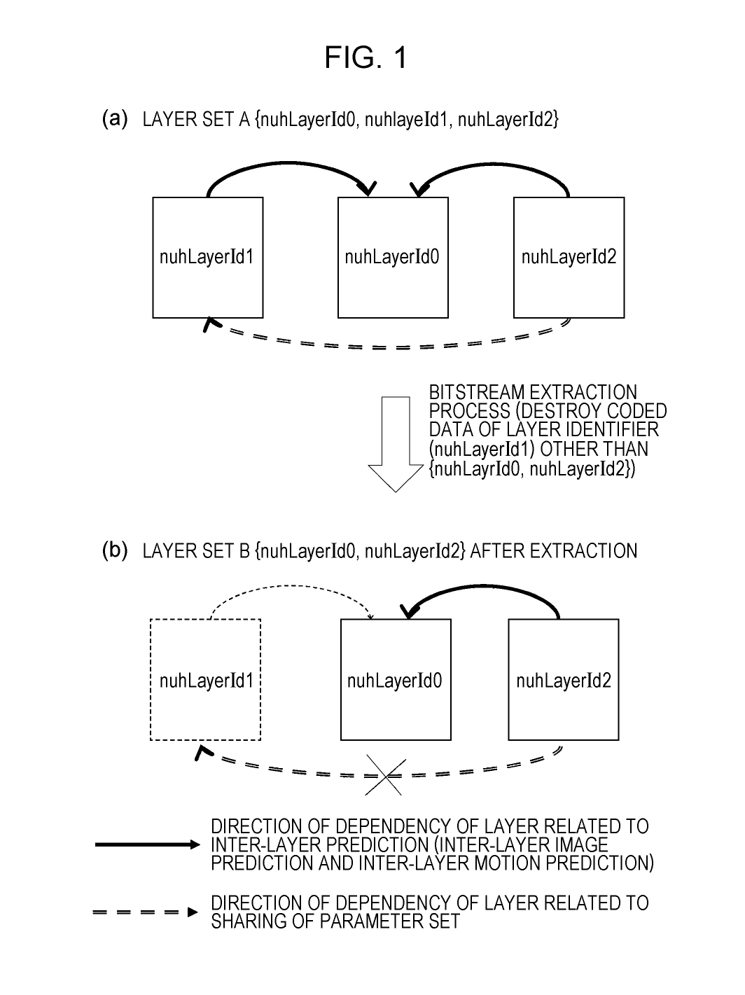

That is, since “reference of the parameter sets of a layer included in the layer set A but not included in the layer set B by a layer in the layer set B which is a subset of the layer set A” can be forbidden when the layer set B, which is a subset, is extracted from the layer set A by using the bitstream extraction, the parameter sets of a different layer that is referenced by a layer included in the layer set B are not destroyed. Therefore, what can be resolved is the problem that a layer that uses a shared parameter set cannot be decoded in a sub-bitstream generated by the bitstream extraction. That is, the problem that may arise at the time of the bitstream extraction in the technology of the related art described with FIG. 1 can be resolved.

(Sequence Parameter Set SPS)

The sequence parameter set SPS defines a set of coding parameters that is referenced by the image decoding device 1 in order to decode the target sequence.

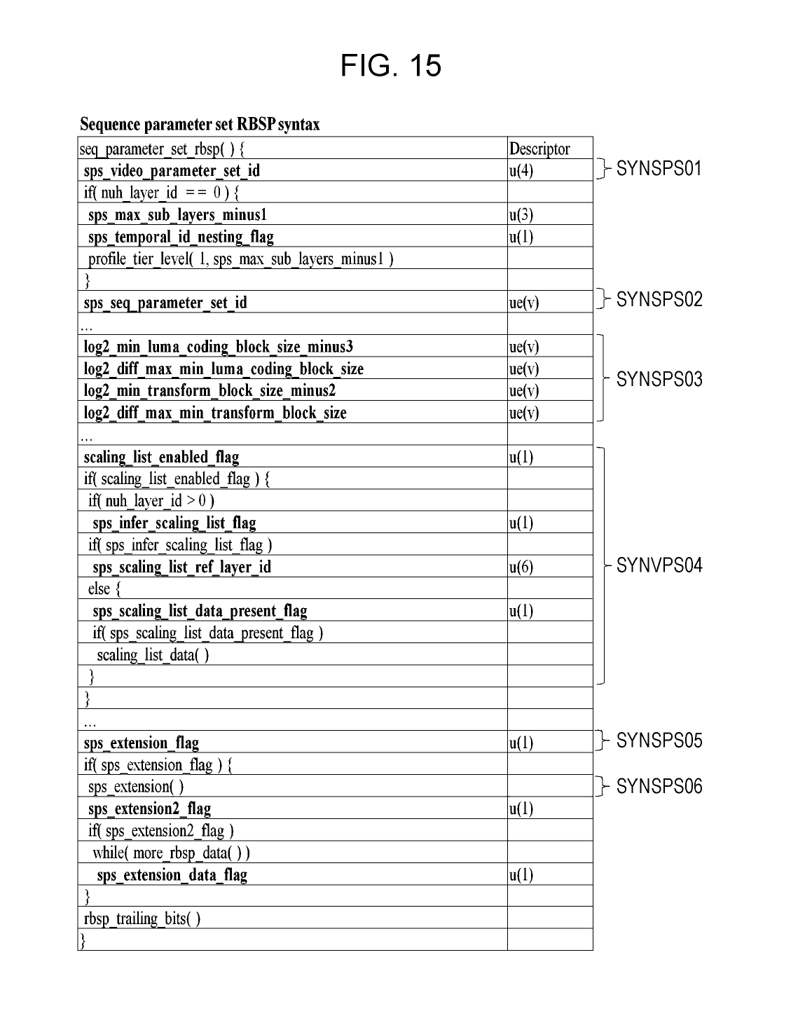

The active VPS identifier is an identifier that specifies the active VPS referenced by the target SPS and is included as the syntax “sps_video_parameter_set_id” (SYNSPS01 in FIG. 15) in the SPS. The parameter set decoding unit 12 may read the coding parameters of the active VPS specified by the active VPS identifier from the parameter set manager 13 and reference the coding parameters of the active VPS at the time of decoding each syntax of the subsequent decoding target SPS, along with decoding the active VPS identifier included in the decoding target sequence parameter set SPS. If each syntax of the decoding target SPS is not dependent on the coding parameters of the active VPS, the activation process for the VPS is not required at the time of decoding the active VPS identifier of the decoding target SPS.

The SPS identifier is an identifier for identification of each SPS and is included as the syntax “sps_seq_parameter_set_id” (SYNSPS02 in FIG. 15) in the SPS. The SPS that is specified by the active SPS identifier (pps_seq_parameter_set_id) included in the PPS described later is referenced at the time of performing a decoding process on the coded data of the target layer in the target layer set.

(Picture Information)

The SPS includes picture information as information that defines the size of the target layer decoded picture. For example, the picture information includes information that represents the width and the height of the target layer decoded picture. The picture information that is decoded from the SPS includes the width of a decoded picture (pic_width_in_luma_samples) and the height of a decoded picture (pic_height_in_luma_samples) (not illustrated in FIG. 15). The value of the syntax “pic_width_in_luma_samples” corresponds to the width of a decoded picture in units of luma pixels. The value of the syntax “pic_height_in_luma_samples” corresponds to the height of a decoded picture in units of luma pixels.

The syntax group illustrated in SYNSPS04 of FIG. 15 is information (scaling list information) that is related to the scaling list (quantization matrix) used through the entire target sequence. In the scaling list information, “sps_infer_scaling_list_flag” (SPS scaling list estimate flag) is a flag that indicates whether to estimate information related to the scaling list of the target SPS from the scaling list information of the active SPS of the reference layer specified by “sps_scaling_list_ref_layer_id”. If the SPS scaling list estimate flag is equal to one, the scaling list information of the SPS is estimated (copied) from the scaling list information of the active SPS of the reference layer specified by “sps_scaling_list_ref_layer_id”. If the SPS scaling list estimate flag is equal to zero, the scaling list information is notified by the SPS on the basis of “sps_scaling_list_data_present_flag”.

An SPS extension data present flag “sps_extension_flag” (SYNSPS05 in FIG. 15) is a flag that indicates whether the SPS further includes SPS extension data sps_extension( ) (SYNSPS06 in FIG. 15).

The SPS extension data (sps_extension( )) includes inter-layer positional correspondence information.

(Inter-Layer Positional Correspondence Information)

The inter-layer positional correspondence information, schematically, indicates a positional relationship between corresponding regions in the target layer and in the reference layer. For example, if an object (object A) is included in the target layer picture and in the reference layer picture, the corresponding regions in the target layer and in the reference layer mean a region corresponding to the object A on the target layer picture and a region corresponding to the object A on the reference layer picture. The inter-layer positional correspondence information may not necessarily be information indicating an accurate positional relationship between the corresponding regions in the target layer and in the reference layer but, in general, indicates an accurate positional relationship between the corresponding regions in the target layer and in the reference layer in order to increase the accuracy of inter-layer prediction.

The inter-layer positional correspondence information includes inter-layer pixel correspondence information. The inter-layer pixel correspondence information is information indicating a positional relationship between a pixel on the reference layer picture and the corresponding pixel on the target layer picture.

(Inter-Layer Pixel Correspondence Information)

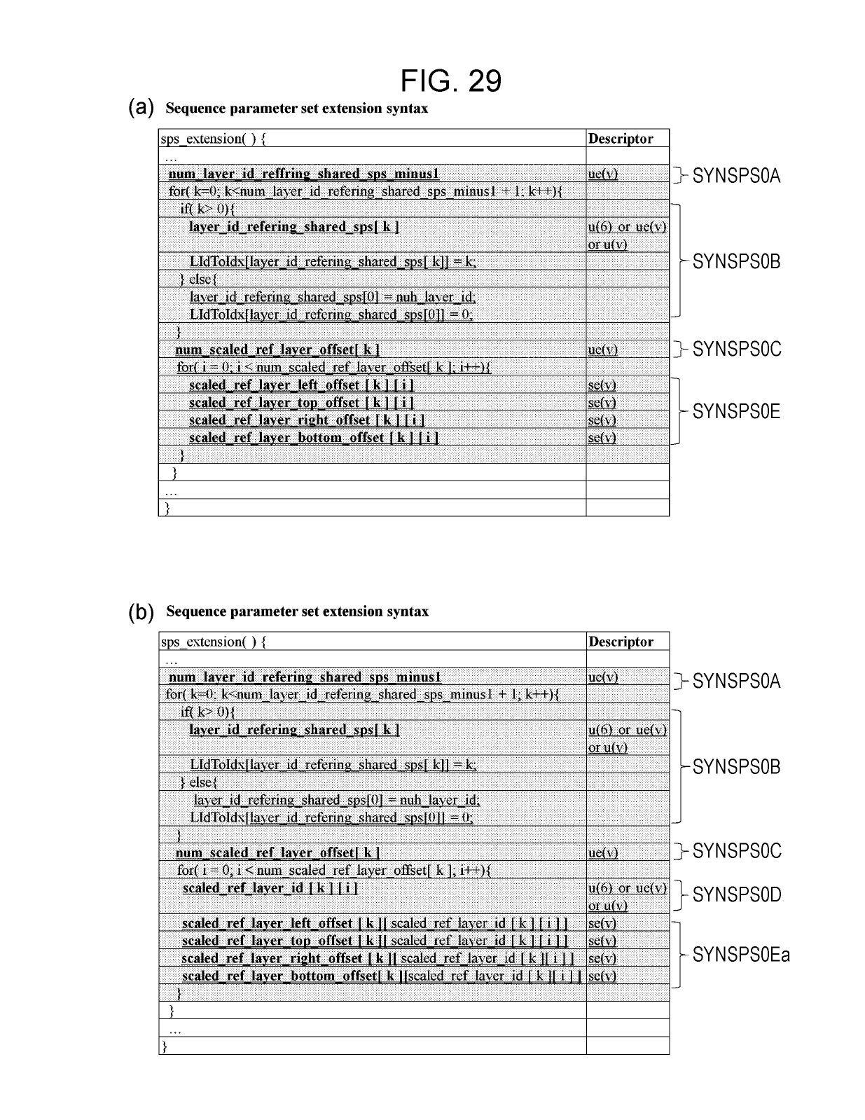

The inter-layer pixel correspondence information is decoded in accordance with, for example, the syntax table illustrated in FIG. 29(a). FIG. 29(a) is a part of the syntax table that is referenced by the parameter set decoding unit 12 at the time of SPS decoding and related to the inter-layer pixel correspondence information.

The inter-layer pixel correspondence information includes the syntax “num_layer_id_refering_shared_sps_minus1” (SYNSPS0A in FIG. 29(a)) that represents the number (parameter set referencing layer number NumLIdRefSharedSPS) of layers referencing the SPS of the layer having the layer identifier nuhLayerIdA (decoding target SPS) as a shared parameter set at the time of decoding a sequence belonging to the layer having the layer identifier nuhLayerIdB (nuhLayerIdB>=nuhLayerIdA). The parameter set referencing layer number NumLIdRefSharedSPS is set to the value of (num_layer_id_refering_shared_sps_minus1+1).

The inter-layer pixel correspondence information includes “num_scaled_ref_layer_offsets[k]” (SYNSPS0C in FIG. 29(a)) that indicates the number of pieces of the inter-layer pixel correspondence information included in the SPS extension data for each layer (layer identifier nuhLayerIdB=layer_id_referring_sps[k]) (SYNSPS0B in FIG. 29(a)) referencing the SPS of the layer having the layer identifier nuhLayerIdA (decoding target SPS) at the time of decoding a sequence belonging to the layer having the layer identifier nuhLayerIdB (nuhLayerIdB>=nuhLayerIdA). In SYNSPS0B of FIG. 29(a), since “layer_id_referring_sps[k]” corresponds to the layer having the same layer identifier nuhLayerIdA as the SPS in a case where the variable k is equal to zero, “layer_id_referring_sps[k]” is not decoded, and the value of “layer_id_referring_sps[k]” is estimated as being equal to the layer identifier nuhLayerIdA of the SPS (in FIG. 29(a), layer_id_referring_sps[0]=nuh_layer_id). That is, the effect of reducing the amount of coding related to “layer_id_referring_sps[0]” is achieved.

The inter-layer pixel correspondence information includes inter-layer pixel correspondence offsets in number corresponding to the number of pieces of the inter-layer pixel correspondence information related to the reference layer (direct reference layer) and each layer having the layer identifier nuhLayerIdB=layer_id_referring_sps[k]. That is, the inter-layer pixel correspondence information illustrated in FIG. 29(a) is layer pixel correspondence information between the target layer and a direct reference layer. The inter-layer pixel correspondence offsets include a scaled reference layer left offset (scaled_ref_layer_left_offset[k][i]), a scaled reference layer top offset (scaled_ref_layer_top_offset[k][i]), a scaled reference layer right offset (scaled_ref_layer_right_offset[k][i]), and a scaled reference layer bottom offset (scaled_ref_layer_bottom_offset[k][i]). The variable k is an index for identification of a parameter set referencing layer, and the variable i is an index for identification of a direct reference layer for the parameter set referencing layer and corresponds to the direct reference layer IDX stored in the second element of the direct reference layer IDX list DirectRefLayerIdx[layer_id_refering_shared_sps[k]][ ]. The second element of each offset (scaled_ref_layer_x_offset[k][ ] where x=left, top, right, and bottom) may be the layer identifier of a direct reference layer instead of the direct reference layer IDX of a direct reference layer. In this case, as illustrated in SYNSPS0D of FIG. 29(b), “scaled_ref_layer_id[k][i]” that indicates the layer identifier of the direct reference layer IDX is arranged immediately before the syntax related to the offsets.

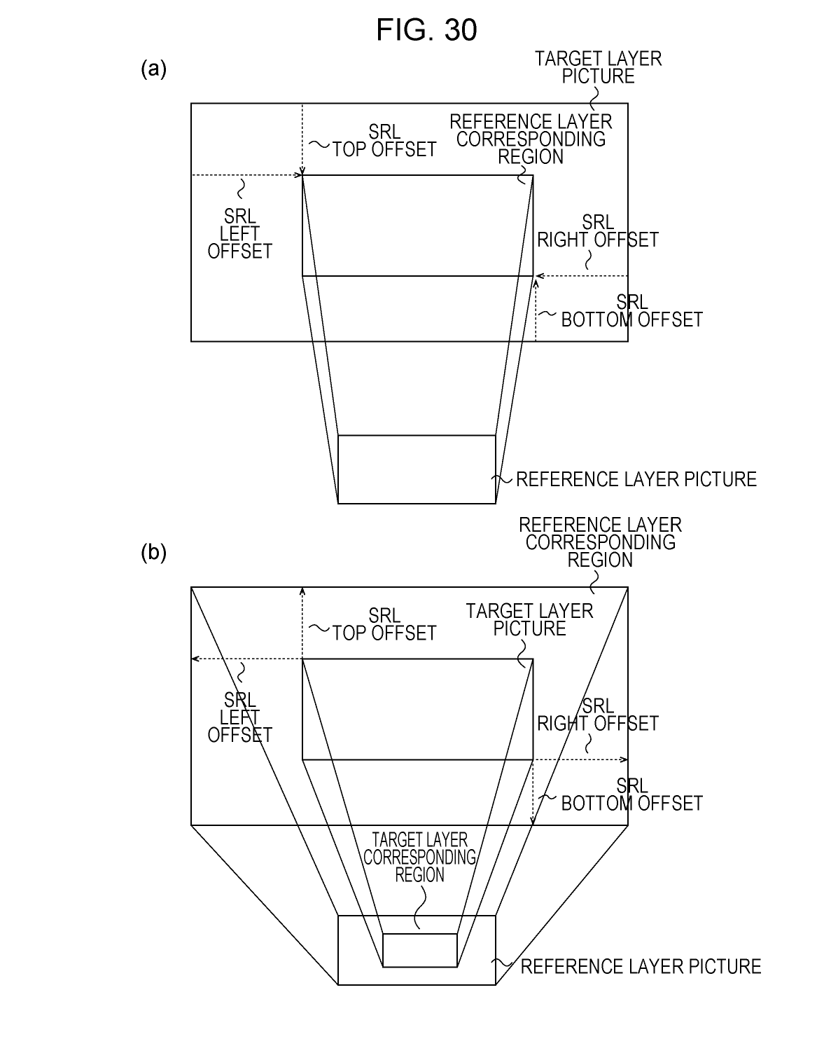

The meaning of each offset included in the inter-layer pixel correspondence offsets will be described with reference to FIG. 30. FIG. 30 is a diagram illustrating a relationship among the target layer picture, the reference layer picture, and the inter-layer pixel correspondence offsets. Each offset indicates a target region in the target layer of the target layer picture corresponding to the entirety of the reference layer picture (or a partial region thereof). FIG. 30(a) illustrates a case where the target region in the target layer corresponds to the entirety of the reference layer picture, and FIG. 30(b) illustrates a case where a target region in the reference layer corresponds to a part of the reference layer picture.

FIG. 30(a) illustrates an example in which the entirety of the reference layer picture corresponds to a part of the target layer picture. In this case, a region on the target layer (target layer corresponding region) that corresponds to the entirety of the reference layer picture is included in the target layer picture. FIG. 30(b) illustrates an example in which a part of the reference layer picture corresponds to the entirety of the target layer picture. In this case, the target layer picture is included in a reference layer corresponding region.

The scaled reference layer left offset (SRL left offset in FIG. 30) represents an offset of the left edge of the target region in the reference layer from the left edge of the target layer picture as illustrated in FIG. 30. If the SRL left offset is greater than zero, this indicates that the left edge of the target region in the reference layer is positioned on the right side of the left edge of the target layer picture.

The scaled reference layer top offset (SRL top offset in FIG. 30) represents an offset of the top edge of the target region in the reference layer from the top edge of the target layer picture. If the SRL top offset is greater than zero, this indicates that the top edge of the target region in the reference layer is positioned on the lower side of the top edge of the target layer picture.

The scaled reference layer right offset (SRL right offset in FIG. 30) represents an offset of the right edge of the target region in the reference layer from the right edge of the target layer picture. If the SRL right offset is greater than zero, this indicates that the right edge of the target region in the reference layer is positioned on the left side of the right edge of the target layer picture.

The scaled reference layer bottom offset (SRL bottom offset in FIG. 30) represents an offset of the bottom edge of the target region in the reference layer from the bottom edge of the target layer picture. If the SRL bottom offset is greater than zero, this indicates that the bottom edge of the target region in the reference layer is positioned on the upper side of the bottom edge of the target layer picture.

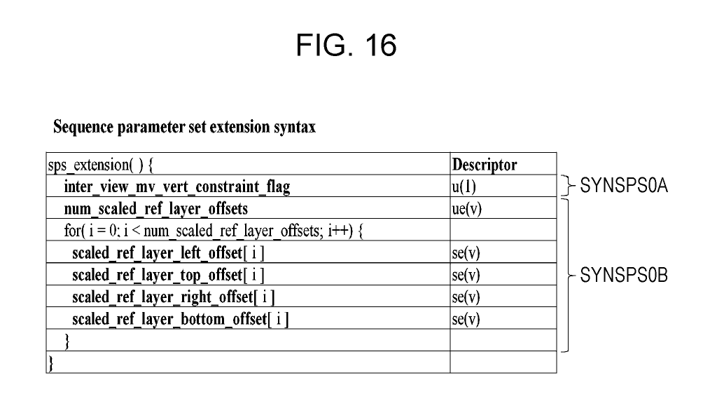

The inter-layer positional correspondence information (SYNSPS0B in FIG. 16) of the SPS according to the technology of the related art includes the inter-layer pixel correspondence information between only the layer having the same layer identifier as the SPS and a reference layer for the layer. However, if a layer having a higher layer identifier than the layer identifier of the SPS (higher layer) references the SPS as a shared parameter set, a problem arises in that there is no layer pixel correspondence position information between the higher layer and a reference layer for the higher layer. That is, the problem of a decrease in coding efficiency arises because there is no inter-layer pixel correspondence information that is required for accurate performance of inter-layer image prediction in the higher layer. In addition, a problem arises in that the higher layer can reference the SPS as a shared parameter set only in a case of non-inclusion of the inter-layer image correspondence information (num_scaled_ref_layer_offsets=0). The non-inclusion of the inter-layer image correspondence information means that the entirety of the target layer picture corresponds to the entirety of the reference layer picture.

Meanwhile, the inter-layer positional correspondence information included in the SPS according to the present embodiment includes the number of layers (parameter set referencing layers) that reference the SPS (SPS of the layer having the layer identifier nuhLayerIdA) as a shared parameter set at the time of decoding a sequence belonging to the layer having the layer identifier nuhLayerIdB (nuhLayerIdB>=nuhLayerIdA). Furthermore, the inter-layer positional correspondence information is configured to include pieces of the inter-layer pixel correspondence information in number corresponding to the number of layers on which the layer having the layer identifier of each parameter set referencing layer is dependent. Therefore, the above problems arising in the technology of the related art can be resolved. That is, a problem that arises, in a case where a layer having a higher layer identifier than the layer identifier of the SPS (higher layer) references the SPS as a shared parameter set, in that there is no layer pixel correspondence position information between the higher layer and a reference layer for the higher layer is resolved. Therefore, since the inter-layer pixel correspondence information that is required for accurate performance of inter-layer image prediction in the higher layer is included, the effect of an improvement in coding efficiency is accomplished in contrast to the technology of the related art. In addition, since the higher layer can reference the SPS as a shared parameter set without being limited to the case of non-inclusion of the inter-layer image correspondence information (num_scaled_ref_layer_offsets=0), the amount of coding related to the parameter sets of the higher layer can be reduced, and the amount of processing related to decoding/coding of the parameter set can be reduced.

(Picture Parameter Set PPS)

The picture parameter set PPS defines a set of coding parameters that is referenced by the image decoding device 1 in order to decode each picture in the target sequence.

The PPS identifier is an identifier for identification of each PPS and is included as the syntax “sps_seq_parameter_set_id” (SYNSPS02 in FIG. 15) in the PPS. The PPS that is specified by the active PPS identifier (slice_pic_parameter_set_id) included in the slice header described later is referenced at the time of performing a decoding process on the coded data of the target layer in the target layer set.

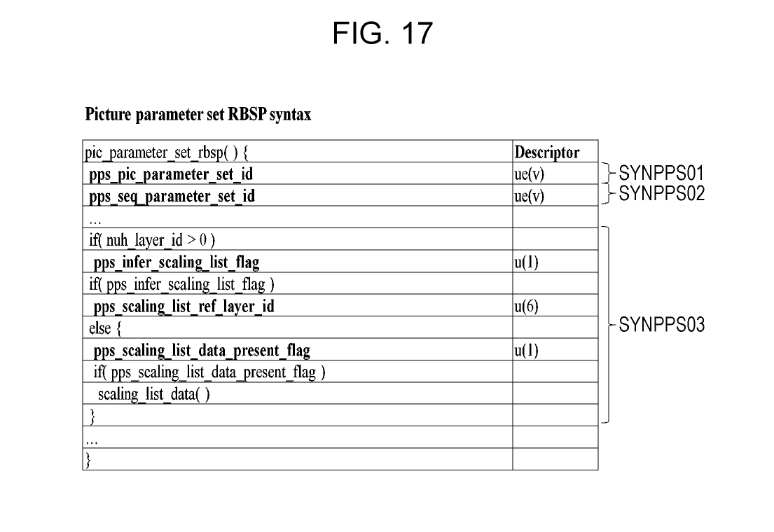

The active SPS identifier is an identifier that specifies the active SPS referenced by the target PPS and is included as the syntax “pps_seq_parameter_set_id” (SYNSPS02 in FIG. 17) in the PPS. The parameter set decoding unit 12 may read the coding parameters of the active SPS specified by the active SPS identifier from the parameter set manager 13, call the coding parameters of the active VPS referenced by the active SPS, and reference the coding parameters of the active SPS and the active VPS at the time of decoding each syntax of the subsequent decoding target PPS, along with decoding the active SPS identifier included in the decoding target picture parameter set PPS. If each syntax of the decoding target PPS is not dependent on the coding parameters of the active SPS and the active VPS, the activation processes for the SPS and the VPS are not required at the time of decoding the active PPS identifier of the decoding target PPS.

The syntax group illustrated in SYNPPS03 of FIG. 17 is information (scaling list information) that is related to the scaling list (quantization matrix) used at the time of decoding a picture which references the target PPS. In the scaling list information, “pps_infer_scaling_list_flag” (scaling list estimate flag) is a flag that indicates whether to estimate information related to the scaling list of the target PPS from the scaling list information of the active PPS of the reference layer specified by “pps_scaling_list_ref_layer_id”. If the PPS scaling list estimate flag is equal to one, the scaling list information of the PPS is estimated (copied) from the scaling list information of the active PPS of the reference layer specified by “sps_scaling_list_ref_layer_id”. If the PPS scaling list estimate flag is equal to zero, the scaling list information is notified by the PPS on the basis of “sps_scaling_list_data_present_flag”.

(Picture Decoding Unit 14)

The picture decoding unit 14 generates and outputs a decoded picture on the basis of the input VCL NAL unit and the active parameter sets.

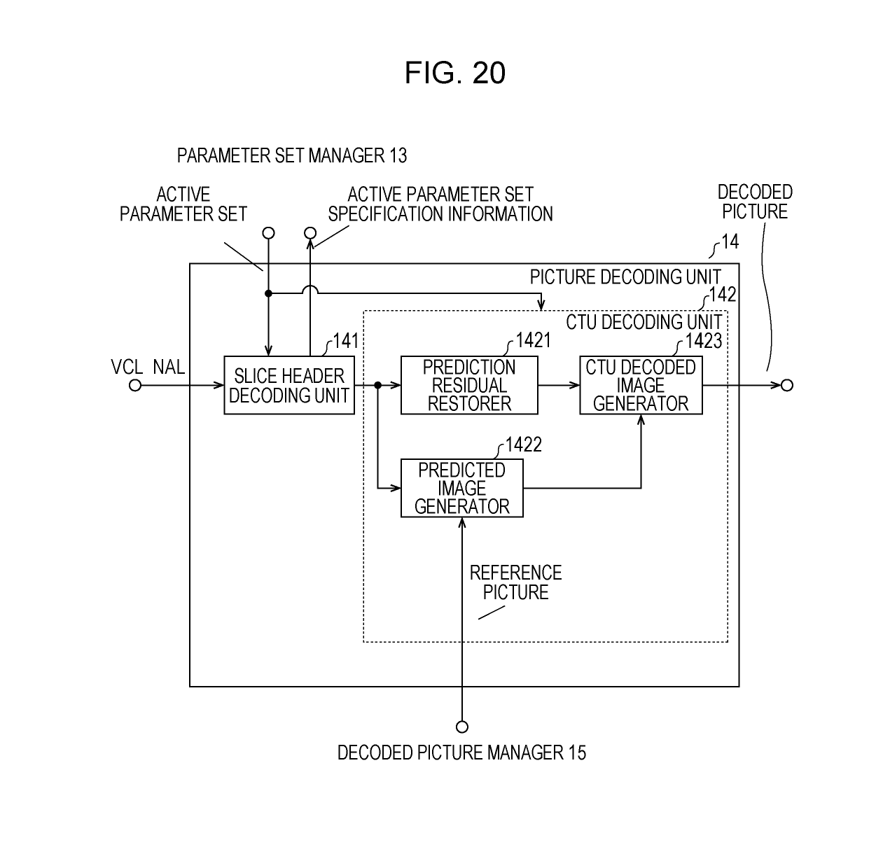

A schematic configuration of the picture decoding unit 14 will be described by using FIG. 20. FIG. 20 is a functional block diagram illustrating a schematic configuration of the picture decoding unit 14.

The picture decoding unit 14 includes a slice header decoding unit 141 and a CTU decoding unit 142. The CTU decoding unit 142 includes a prediction residual restorer 1421, a predicted image generator 1422, and a CTU decoded image generator 1423.

(Slice Header Decoding Unit 141)

The slice header decoding unit 141 decodes the slice header on the basis of the input VCL NAL unit and the active parameter sets. The decoded slice header is output to the CTU decoding unit 142 along with the input VCL NAL unit.

(CTU Decoding Unit 142)

The CTU decoding unit 142, schematically, generates a decoded image of a slice by decoding a decoded image of a region corresponding to each CTU included in the slices constituting a picture on the basis of the input slice header, the slice data included in the VCL NAL unit, and the active parameter sets. The size of the CTB with respect to the target layer (corresponds to the syntax log2_min_luma_coding_block_size_minus3 and log2_diff_max_min_luma_coding_block_size in SYNSPS03 of FIG. 15) included in the active parameter sets is used as the size of the CTU. The decoded image of the slice is output as a part of a decoded picture to a slice position indicated by the input slice header. The decoded image of the CTU is generated by the prediction residual restorer 1421, the predicted image generator 1422, and the CTU decoded image generator 1423 included in the CTU decoding unit 142.

The prediction residual restorer 1421 decodes prediction residual information (TT information) included in the input slice data to generate and output a prediction residual of the target CTU.

The predicted image generator 1422 generates and outputs a predicted image on the basis of a prediction parameter and a prediction method indicated by prediction information (PT information) included in the input slice data. At this time, if necessary, the decoded image or the coding parameters of the reference picture are used. For example, if inter prediction or inter-layer image prediction is used, the corresponding reference picture is read from the decoded picture manager 15. Of the predicted image generation processes performed by the predicted image generator 1422, a predicted image generation process performed in a case where inter-layer image prediction is selected will be described in detail later.

The CTU decoded image generator 1423 adds the input predicted image and the prediction residual to generate and output the decoded image of the target CTU.

<Details of Predicted Image Generation Process in Layer Image Prediction>

Of the predicted image generation processes performed by the predicted image generator 1422, a predicted image generation process performed in a case where inter-layer image prediction is selected will be described in detail.

A process of generating a predicted pixel value of a target pixel included in the target CTU to which inter-layer image prediction is applied is performed in the following procedure. First, a reference picture position derivation process is performed to derive a corresponding reference position. The corresponding reference position is a position on the reference layer that corresponds to the target pixel on the target layer picture. Since the pixels of the target layer are not necessarily in one-to-one correspondence with the pixels of the reference layer, the corresponding reference position is represented with an accuracy smaller than the size of the unit pixel in the reference layer. Next, an interpolation filtering process is performed with input of the derived corresponding reference position to generate a predicted pixel value of the target pixel.

A corresponding reference position derivation process derives the corresponding reference position on the basis of the picture information and the inter-layer pixel correspondence information included in the parameter sets. A detailed procedure of the corresponding reference position derivation process will be described. The corresponding reference position derivation process is realized by performing the following processes of S101 to S104 in order.

(S101) The size of the reference layer corresponding region and an inter-layer size ratio (ratio of the size of the reference layer picture to the size of the reference layer corresponding region) are calculated on the basis of the size of the target layer picture, the size of the reference layer picture, and the inter-layer pixel correspondence information. First, a width SRLW and a height SRLH of the reference layer corresponding region and a horizontal component scaleX and a horizontal component scaleY of the inter-layer size ratio are calculated by the following equations.

SRLW=currPicW−SRLLeftOffset−SRLRightOffset

SRLH=currPicH−SRLTopOffset−SRLBottomOffset

scaleX=refPicW/SRLW

scaleY=refPicH/SRLH

currPicW and currPicH denote the width and the height of the target picture and, if the target of the corresponding reference position derivation process is a luma pixel, match each syntax value of pic_width_luma_samples and pic_height_in_luma_samples included in the picture information of the SPS in the target layer. If the target is a chroma, values converted from the syntax values are used depending on the type of color format. For example, if the color format is 4:2:2, a half value of each syntax value is used. refPicW and refPicH denote the width and the height of the reference picture and, if the target is a luma pixel, match each syntax value of pic_width_luma_samples and pic_height_in_luma_samples included in the picture information of the SPS in the reference layer. SRLLeftOffset, SRLRightOffset, SRLTopOffset, and SRLBottomOffset denote the inter-layer pixel correspondence offsets described with reference to FIG. 30.

(S102) A corresponding reference position (xRef, yRef) of a target pixel (xP, yP) is calculated on the basis of the inter-layer pixel correspondence information and the inter-layer size ratio. The horizontal component xRef and the vertical component yRef of the reference position corresponding to the target layer pixel are calculated by the equations below. xRef represents a position in the horizontal direction from an upper left pixel of the reference layer picture as a reference in units of pixels of the reference layer picture, and yRef represents a position in the vertical direction from the upper left pixel in units of pixels of the reference layer picture.

xRef=(xP−SRLLeftOffset)*scaleX

yRef=(yP−SRLTopOffset)*scaleY

xP and yP respectively represent a horizontal component and a vertical component of the target layer pixel with respect to an upper left pixel of the target layer picture as a reference in units of pixels of the target layer picture. Floor(X) with respect to a real number X means the maximum integer not exceeding X.

In the above equations, the reference position is set to a value resulting from scaling the position of the target pixel with respect to the upper left pixel of the reference layer corresponding region by the inter-layer size ratio. The above calculation may be performed by an approximating operation using an integer representation. For example, scaleX and scaleY may be calculated as an integer resulting from multiplying an actual magnification value by a predetermined value (for example, 16), and xRef and yRef may be calculated by using the integer value. If the target is a chroma pixel, correction may be performed considering the phase difference between a luma and a chroma.

While the corresponding reference position is calculated in units of pixels in the above equations, the present embodiment is not limited to this. For example, a value (xRef16, yRef16) in units of 1/16 pixels resulting from the integer representation of the corresponding reference position may be calculated by the following equations.

xRef16=Floor(((xP−SRLLeftOffset)*scaleX)*16))

yRef16=Floor(((yP−SRLTopOffset)*scaleY)*16))

Generally, it is preferable to derive the corresponding reference position in units or in a representation preferred for application of the filtering process. For example, it is preferable to derive the target reference position in an integer representation having an accuracy matching the minimum unit referenced by an interpolation filter.

The corresponding reference position derivation process described heretofore can derive the position on the reference layer picture corresponding to the target pixel on the target layer picture as the corresponding reference position.

In the interpolation filtering process, the pixel value at a position corresponding to the corresponding reference position derived by the corresponding reference position derivation process is generated by applying an interpolation filter to the decoded pixel of a pixel near the corresponding reference position on the reference layer picture.

As described heretofore, since the predicted image generator 1422 included in the hierarchical moving image decoding device 1 can derive an accurate position on the reference layer picture corresponding to the predicted target pixel using the inter-layer phase correspondence information, the accuracy of the predicted pixel generated by the interpolation process is improved. Thus, the hierarchical decoding device 1 can output the higher layer decoded picture by decoding coded data of which the amount of coding is smaller than that in the related art.

<Decoding Process Performed by Picture Decoding Unit 14>

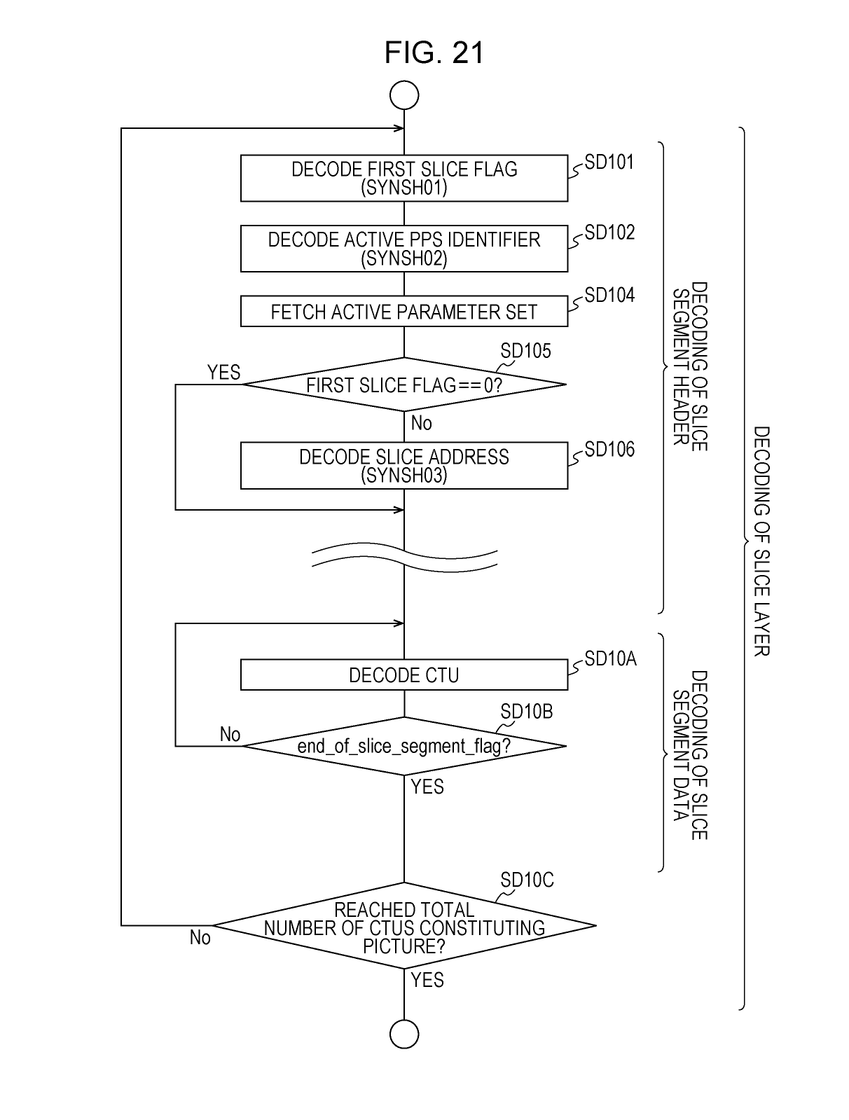

Hereinafter, an operation of decoding a picture of the target layer i in the picture decoding unit 14 will be schematically described with reference to FIG. 21. FIG. 21 is a flowchart illustrating a decoding process that is performed in the picture decoding unit 14 in units of slices constituting a picture of the target layer i.

(SD101) A first slice flag of the decoding target slice (first_slice_segment_pic_flag) is decoded. If the first slice flag is equal to one, the decoding target slice is the first slice in the decoding order (hereinafter, processing order) in the picture, and thus, the position (hereinafter, a CTU address) of the first CTU of the decoding target slice in the raster scan order in the picture is set to zero. A counter numCtb for the number of previously processed CTUs in the picture (hereinafter, a previously processed CTU number numCtb) is set to zero. If the first slice flag is equal to zero, the first CTU address of the decoding target slice is set on the basis of the slice address that is decoded in Step SD106 described below.

(SD102) The active PPS identifier (slice_pic_parameter_set_id) that specifies the active PPS referenced at the time of decoding of the decoding target slice is decoded.

(SD104) The active parameter sets are fetched from the parameter set manager 13. That is, the PPS having the same PPS identifier (pps_pic_parameter_set_id) as the active PPS identifier (slice_pic_parameter_set_id) referenced by the decoding target slice is used as the active PPS, and the coding parameters of the active PPS are fetched (read) from the parameter set manager 13. The SPS having the same SPS identifier (sps_seq_parameter_set_id) as the active SPS identifier (pps_seq_parameter_set_id) in the active PPS is used as the active SPS, and the coding parameters of the active SPS are fetched from the parameter set manager 13. The VPS having the same VPS identifier (vps_video_parameter_set_id) as the active VPS identifier (sps_video_parameter_set_id) in the active SPS is used as the active VPS, and the coding parameters of the active VPS are fetched from the parameter set manager 13.

(SD105) A determination of whether the decoding target slice is the first slice in the processing order in the picture is performed on the basis of the first slice flag. If the first slice flag is equal to zero (Yes in SD105), a transition is made to Step SD106. Otherwise (No in SD105), the process of Step SD106 is skipped. If the first slice flag is equal to one, the slice address of the decoding target slice is equal to zero.

(SD106) The slice address (slice_segment_address) of the decoding target slice is decoded and is set as the first CTU address of the decoding target slice, for example, first slice CTU address=slice_segment_address.

. . . omitted . . .

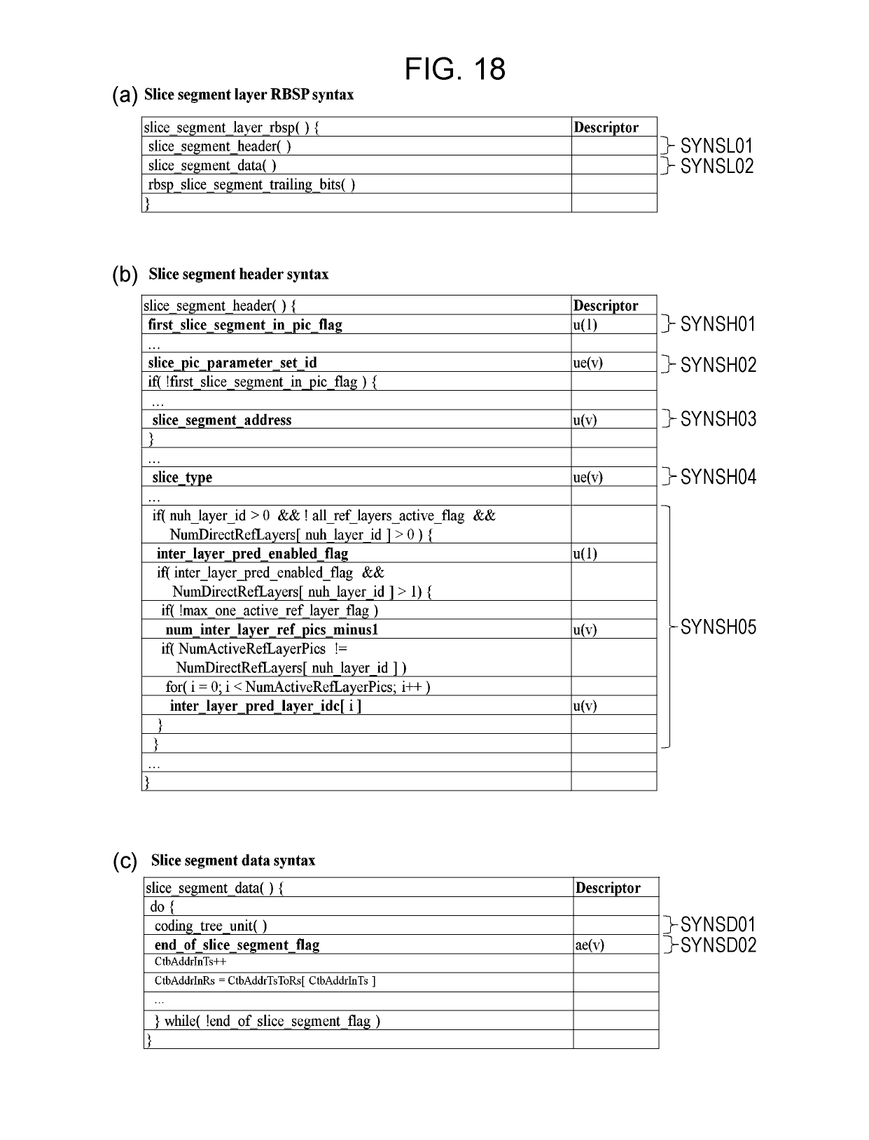

(SD10A) The CTU decoding unit 142 generates a CTU decoded image of a region corresponding to each CTU included in the slices constituting the picture, on the basis of the input slice header, the active parameter sets, and information about each CTU (SYNSD01 in FIG. 18) in the slice data included in the VCL NAL unit. After each CTU information, a slice end flag (end_of_slice_segment_flag) (SYNSD2 in FIG. 18) that indicates whether the CTU is the end of the decoding target slice is decoded. After decoding of each CTU, the value of the previously processed CTU number numCtb is incremented by one (numCtb++).

(SD10B) A determination of whether the CTU is the end of the decoding target slice is performed on the basis of the slice end flag. If the slice end flag is equal to one (Yes in SD10B), a transition is made to Step SD10C. Otherwise (No in SD10B), a transition is made to Step SD10A in order to decode subsequent CTU information.

(SD10C) A determination of whether the previously processed CTU number numCtu reaches the total number of CTUs constituting the picture (PicSizeInCtbsY) is performed. That is, a determination of numCtu==PicSizeInCtbsY is performed. If numCtu is equal to PicSizeInCtbsY (Yes in SD10C), the decoding process performed in units of slices constituting the decoding target picture is ended. Otherwise (numCtu<PicSizeInCtbsY) (No in SD10C), a transition is made to Step SD101 in order to continue the decoding process performed in units of slices constituting the decoding target picture.

While operation of the picture decoding unit 14 according to a first embodiment is described heretofore, the present embodiment is not limited to the above steps, and the steps may be changed to the extent possible.

(Effect of Moving Image Decoding Device 1)

The hierarchical moving image decoding device 1 (hierarchical image decoding device) according to the present embodiment described heretofore can omit a decoding process related to the parameter set of the target layer by sharing the parameter sets used in decoding of the reference layer as the parameter sets (SPS and PPS) used in decoding of the target layer. More specifically, the presence of the dependency type between non-VCLs is newly introduced in the present embodiment as a layer dependency type in addition to the dependency type between VCLs (inter-layer image prediction and inter-layer motion prediction). Types of dependency between non-VCLs include sharing of a parameter set (shared parameter set) between different layers and prediction (inter parameter set syntax prediction) of a part of syntax between parameter sets in different layers.

Explicit notification of the presence of the dependency type indicating the presence of the non-VCL accomplishes the effect that a decoder can recognize which layer in the layer set is a non-VCL dependent layer (non-VCL reference layer) of the target layer by decoding the VPS extension data. That is, what can be resolved is the problem that the layer that uses the parameter sets of the layer A having the layer identifier value of nuhLayerIdA in common (the layer to which a shared parameter set is applied) is not known at the time of the start of coded data decoding.

(Bitstream Constraints According to First Embodiment)

Introduction of the presence of the dependency type between non-VCLs allows explicit representation of the following bitstream constraints between a decoder and an encoder.

That is, a bitstream has to satisfy the following condition CX1 as the bitstream conformance.

CX1: “When the non-VCL having the layer identifier nuhLayerIdA is a non-VCL that is used by the layer having the layer identifier nuhLayerIdB, the layer having the layer identifier nuhLayerIdA is a direct reference layer for the layer identifier nuhLayerIdB and has the non-VCL dependency present flag equal to one”.

If the condition CX1 is limited to a shared parameter set, a bitstream has to satisfy the following condition CX2 as the bitstream conformance.

CX2: “When the parameter sets having the layer identifier nuhLayerIdA are the active parameter sets of the layer j having the layer identifier nuhLayerIdB, the layer i having the layer identifier nuhLayerIdA is a direct reference layer for the layer identifier nuhLayerIdB (direct_dependency_flag[i][j]=1), and the non-VCL dependency present flag thereof derived from the dependency type direct_dependency_type[i][j] between nuhLayerIdA and nuhLayerIdB is equal to one”.

If the constraint condition CX2 is limited to a shared parameter set related to the SPS and a shared parameter set related to the PPS, a bitstream has to satisfy each of the following conditions CX3 and CX4 as the bitstream conformance.

CX3: “When the SPS having the layer identifier nuhLayerIdA is the active SPS of the layer having the layer identifier nuhLayerIdB, the layer having the layer identifier nuhLayerIdA is a direct reference layer for the layer identifier nuhLayerIdB and has the non-VCL dependency present flag equal to one”.

CX4: “When the PPS having the layer identifier nuhLayerIdA is the active PPS of the layer having the layer identifier nuhLayerIdB, the layer having the layer identifier nuhLayerIdA is a direct reference layer for the layer identifier nuhLayerIdB and has the non-VCL dependency present flag equal to one”.

The above conditions CX1 to CX4 can also be respectively represented as the conditions CX1′ to CX4′ that are previously described in (Effect of Non-VCL Dependency Type).

(Effect of Bitstream Constraints According to First Embodiment)

The bitstream constraints, in other words, state that a parameter set that can be used as a shared parameter set is a parameter set having the layer identifier of a direct reference layer for the target layer.

The expression “a parameter set that can be used as a shared parameter set is a parameter set having the layer identifier of a direct reference layer for the target layer” means forbidding “reference of the parameter sets of a layer included in the layer set A but not included in the layer set B by a layer in the layer set B which is a subset of the layer set A”.

That is, since “reference of the parameter sets of a layer included in the layer set A but not included in the layer set B by a layer in the layer set B which is a subset of the layer set A” can be forbidden when the layer set B, which is a subset, is extracted from the layer set A by using the bitstream extraction, the parameter sets of a direct reference layer that is referenced by a layer included in the layer set B are not destroyed. Therefore, what can be resolved is the problem that a layer that uses a shared parameter set cannot be decoded in a sub-bitstream generated by the bitstream extraction. That is, the problem that may arise at the time of the bitstream extraction in the technology of the related art described with FIG. 1 can be resolved.

### Modification Example 1 of Non-VCL Dependency Type

While each non-VCL dependency type such as inter parameter set prediction and a shared parameter set is represented by the non-VCL dependency present flag without distinction in the example of FIG. 14(a), the present embodiment is not limited to this. For example, by distinguishing each non-VCL dependency type, the dependency type may be configured to represent a flag for the presence of a shared parameter set (SharedParamSetEnabledFlag) with the value of the second bit from the least significant bit and the presence of inter parameter set prediction (ParamSetPredEnabledFlag) with the value of the third bit from the least significant bit as illustrated in FIG. 14(b). In this case, the flags for the presence of each layer dependency type of the reference layer j with respect to the target layer i (layer identifier iNuhLId=layer_id_in_nuh[i]) are derived by the following expression.

SamplePredEnabledFlag[iNuhLId][j]=((direct_dependency_type[i][j]+1)&1);

MotionPredEnabledFlag[iNuhLId][j]=((direct_dependency_type[i][j]+1)&2)>>1;

SharedParamSetEnabledFlag[iNuhLid][j]=((direct_dependency_type[i][j]+1)&4)>>2;

ParamSetPredEnabledFlag[iNuhLid][j]=((direct_dependency_type[i][j]+1)&8)>>3;

Alternatively, the flags can be represented by the following expression by using the variable DirectDepType[i][j] instead of (direct_dependency_type[i][j]+1).

SamplePredEnabledFlag[iNuhLId][j]=((DirectDepType[i][j])&1);

MotionPredEnabledFlag[iNuhLId][j]=((DirectDepType[i][j])&2)>>1;

SharedParamSetEnabledFlag[iNuhLid][j]=((DirectDepType[i][j])&4)>>2;

ParamSetPredEnabledFlag[iNuhLid][j]=((DirectDepType[i][j])&8)>>3;

The position of the bit indicating the flag for the presence of each dependency type may be changed to the extent possible.

(Effect of Modification Example 1 of Non-VCL Dependency Type)

As described heretofore, the present embodiment newly includes, as the dependency type between non-VCLs, a shared parameter set present flag that indicates the presence of sharing of a parameter set (shared parameter set) between different layers and an inter parameter set syntax prediction present flag that indicates the presence of prediction (inter parameter set syntax prediction) of a part of the syntax between the parameter sets in different layers, in addition to the dependency type between VCLs (inter-layer image prediction and inter-layer motion prediction).

Explicit notification of the presence of each non-VCL dependency type accomplishes the effect that a decoder can recognize which layer in the layer set is a shared parameter set dependent layer or an inter parameter set prediction dependent layer of the target layer by decoding the VPS extension data. That is, what can be resolved is the problem that the layer that uses the parameter sets of the layer A having the layer identifier value of nuhLayerIdA in common (the layer to which a shared parameter set is applied) is not known at the time of the start of coded data decoding. Furthermore, what can be resolved is the problem that the layer of which the syntax of the parameter sets is referenced by the parameter sets of the layer A having the layer identifier value of nuhLayerIdA is not known at the time of the start of coded data decoding.

(Bitstream Constraints According to Modification Example 1 of Non-VCL Dependency Type)

Introduction of the presence of each non-VCL dependency type allows explicit representation of the following bitstream constraints between a decoder and an encoder.

That is, a bitstream has to satisfy the following conditions CW1 and CW2 as the bitstream conformance.

CW1: “When the parameter sets having the layer identifier nuhLayerIdA are the active parameter sets of the layer having the layer identifier nuhLayerIdB, the layer having the layer identifier nuhLayerIdA is a direct reference layer for the layer identifier nuhLayerIdB and has the shared parameter set present flag equal to one”.

CW2: “When the parameter sets having the layer identifier nuhLayerIdA are the parameter sets that are referenced in inter parameter set prediction of the layer having the layer identifier nuhLayerIdB, the layer having the layer identifier nuhLayerIdA is a direct reference layer for the layer identifier nuhLayerIdB and has the inter parameter set prediction present flag equal to one”.

The conditions CW1 and CW2 can also be respectively represented as the following conditions CW1′ and CW2′.

CW1′: “When the parameter sets having the layer identifier nuh_layer_id equal to nuhLayerIdA are the active parameter sets of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

CW2′: “When the parameter sets having the layer identifier nuh_layer_id equal to nuhLayerIdA are the parameter sets that are referenced in inter parameter set prediction of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

If the constraint condition CW1 is limited to a shared parameter set related to the SPS and a shared parameter set related to the PPS, a bitstream has to satisfy each of the following conditions CW3 and CW4 as the bitstream conformance.

CW3: “When the SPS having the layer identifier nuhLayerIdA is the active SPS of the layer having the layer identifier nuhLayerIdB, the layer having the layer identifier nuhLayerIdA is a direct reference layer for the layer identifier nuhLayerIdB and has the shared parameter set present flag equal to one”.

CW4: “When the PPS having the layer identifier nuhLayerIdA is the active PPS of the layer having the layer identifier nuhLayerIdB, the layer having the layer identifier nuhLayerIdA is a direct reference layer for the layer identifier nuhLayerIdB and has the shared parameter set present flag equal to one”.

The above conditions CW3 and CW4 can also be respectively represented as the following conditions CW3′ and CW4′.

CW3′: “When the SPS having the layer identifier nuh_layer_id equal to nuhLayerIdA is the active SPS of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

CW4′: “When the PPS having the layer identifier nuh_layer_id equal to nuhLayerIdA is the active PPS of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

The bitstream constraints, in other words, state that a parameter set that can be used as a shared parameter set is a parameter set of a direct reference layer for the target layer.

(Effect of Bitstream Constraints According to Modification Example 1 of Non-VCL Dependency Type)

A parameter set that can be used as a shared parameter set is a parameter set having the layer identifier of a direct reference layer for the target layer. That is, since “reference of the parameter sets of a layer included in the layer set A but not included in the layer set B by a layer in the layer set B which is a subset of the layer set A” can be forbidden when the layer set B, which is a subset, is extracted from the layer set A by using the bitstream extraction, the parameter sets of a direct reference layer that is referenced by a layer included in the layer set B are not destroyed. Therefore, what can be resolved is the problem that a layer that uses a shared parameter set cannot be decoded in a sub-bitstream generated by the bitstream extraction. That is, the problem that may arise at the time of the bitstream extraction in the technology of the related art described with FIG. 1 can be resolved.

### Modification Example of Bitstream Constraints According to Modification Example 1 of Non-VCL Dependency Type

If the constraint condition CW2 is limited to inter parameter set prediction between SPSs and inter parameter set prediction between PPSs, a bitstream has to satisfy each of the following conditions CW5 and CW6 as the bitstream conformance.

CW5: “When the SPS having the layer identifier nuhLayerIdA is the SPS that is referenced in inter parameter set prediction of the SPS of the layer having the layer identifier nuhLayerIdB, the layer having the layer identifier nuhLayerIdA is a direct reference layer for the layer identifier nuhLayerIdB and has the inter parameter set prediction present flag equal to one”.

CW6: “When the PPS having the layer identifier nuhLayerIdA is the PPS that is referenced in inter parameter set prediction of the PPS of the layer having the layer identifier nuhLayerIdB, the layer having the layer identifier nuhLayerIdA is a direct reference layer for the layer identifier nuhLayerIdB and has the inter parameter set prediction present flag equal to one”.

The above conditions CW5 and CW6 can also be respectively represented as the following conditions CW5′ and CW6′.

CW5′: “When the SPS having the layer identifier nuh_layer_id equal to nuhLayerIdA is the SPS that is referenced in inter parameter set prediction of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

CW6′: “When the PPS having the layer identifier nuh_layer_id equal to nuhLayerIdA is the PPS that is referenced in inter parameter set prediction of the layer having the layer identifier nuh_layer_id equal to nuhLayerIdB, the layer having the layer identifier nuh_layer_id equal to nuhLayerIdA is a direct reference layer for the layer having the layer identifier nuh_layer_id equal to nuhLayerIdB and has the non-VCL dependency present flag equal to one”.

The bitstream constraints, in other words, state that a parameter set that can be used in inter parameter set prediction is a parameter set of a direct reference layer for the target layer.

(Effect of Modification Example of Bitstream Constraints According to Modification Example 1 of Non-VCL Dependency Type)

A parameter set that can be used in inter parameter set prediction is a parameter set having the layer identifier of a direct reference layer for the target layer. That is, since “reference of the parameter sets of a layer included in the layer set A but not included in the layer set B by a layer in the layer set B which is a subset of the layer set A” can be forbidden when the layer set B, which is a subset, is extracted from the layer set A by using the bitstream extraction, the parameter sets of a direct reference layer that is referenced by a layer included in the layer set B are not destroyed. Therefore, what can be resolved is the problem that a layer that uses a shared parameter set cannot be decoded in a sub-bitstream generated by the bitstream extraction. That is, the problem that may arise at the time of the bitstream extraction in the technology of the related art described with FIG. 1 can be resolved.

### Modification Example 2 of Non-VCL Dependency Type

While non-VCL dependency is represented by the flag for the presence of each non-VCL dependency type such as inter parameter set prediction and a shared parameter set or by the non-VCL dependency present flag in the first embodiment and Modification Example 1 of the Non-VCL dependency type, non-VCL dependency may be represented by the direct dependency flag without explicitly signaling the flags for the presence of the non-VCL dependency types. More specifically, the non-VCL dependency present flag (NonVCLDepEnabledFlag[i][j]) is derived (estimated) by the following expression on the basis of the value of the direct dependency flag. That is, if the direct_dependency_flag is equal to one, the non-VCL dependency present flag is set to one, and if the direct_dependency_flag is equal to zero, the non-VCL dependency present flag is set to zero.

NonVCLDepEnabledFlag[iNuhLid][j]=direct_dependency_type[i][j]?1:0;

Alternatively, the non-VCL dependency present flag (NonVCLDepEnabledFlag[i][j]) may be derived (estimated) by the following expression on the basis of the value of the dependency flag (DependencyFlag[i][j]) indicating a dependency relationship in a case where the i-th layer is directly dependent on the j-th layer (if the direct dependency flag is equal to one, the j-th layer is said to be a direct reference layer for the i-th layer) or in a case where the i-th layer is indirectly dependent on the j-th layer (the j-th layer is said to be an indirect reference layer for the i-th layer). That is, if the dependency flag (DependencyFlag[i][j]) is equal to one, the non-VCL dependency present flag is set to one, and if the dependency flag (DependencyFlag[i][j]) is equal to zero, the non-VCL dependency present flag is set to zero.

NonVCLDepEnabledFlag[iNuhLid][j]=DependencyFlag[i][j]?1:0;

(Effect of Modification Example 2 of Non-VCL Dependency Type)

As described heretofore, in Modification Example 2 of the non-VCL dependency type, estimation of the non-VCL dependency present flag based on the direct_dependency_flag or the dependency flag allows a reduction in the amount of coding related to the flag for the presence of the non-VCL dependency type (non-VCL dependency present flag) and in the amount of processing related to decoding/coding thereof.

(Bitstream Constraints According to Modification Example 2 of Non-VCL Dependency Type)

In Modification Example 2 of the non-VCL dependency type, the following bitstream constraints are further added between a decoder and an encoder.

That is, a bitstream has to satisfy the following condition CZ1 as the bitstream conformance.

CZ1: “When the non-VCL having the layer identifier nuhLayerIdA is a non-VCL that is used by the layer having the layer identifier nuhLayerIdB, the layer having the layer identifier nuhLayerIdA is a direct reference layer or an indirect reference layer for the layer identifier nuhLayerIdB”.

The condition CZ1 can also be represented as the following condition CZ1′.

CZ1′: “When the non-VCL having the layer identifier nuh_layer_id equal to nuhLayerIdA is a non-VCL that is used by the layer having the layer identifier nuh_layer_id equal to nuhLayerIdB, the layer having the layer identifier nuh_layer_id equal to nuhLayerIdA is a direct reference layer or an indirect reference layer for the layer having the layer identifier nuh_layer_id equal to nuhLayerIdB”.

The expression “the layer having the layer identifier nuhLayerIdA is a direct reference layer or an indirect reference layer for the layer identifier nuhLayerIdB” in the above condition can also be represented as “the dependency flag (DependencyFlag[i][j]) of the layer having the layer identifier nuhLayerIdA and the layer j having the layer identifier nuhLayerIdB is equal to one” by using the dependency flag (DependencyFlag[i][j]). This alternative representation can also be applied to subsequent conditions CZ2 to CZ4 and CZ1′ to CZ4′ and to other conditions using similar representations.

### Modification Example 1 of Bitstream Constraints According to Modification Example 2 of Non-VCL Dependency Type

If the condition CZ1 is limited to a shared parameter set, a bitstream has to satisfy the following condition CX2 as the bitstream conformance.

CZ2: “When the parameter sets having the layer identifier nuhLayerIdA are the active parameter sets of the layer having the layer identifier nuhLayerIdB, the layer having the layer identifier nuhLayerIdA is a direct reference layer, a direct reference layer, or an indirect reference layer for the layer identifier nuhLayerIdB”.

The condition CZ2 can also be represented as the following condition CZ2′.

CZ2′: “When the parameter sets having the layer identifier nuh_layer_id equal to nuhLayerIdA are the active parameter sets of the layer having the layer identifier nuh_layer_id equal to nuhLayerIdB, the layer having the layer identifier nuh_layer_id equal to nuhLayerIdA is a direct reference layer or an indirect reference layer for the layer having the layer identifier nuh_layer_id equal to nuhLayerIdB”.

### Modification Example 2 of Bitstream Constraints According to Modification Example 2 of Non-VCL Dependency Type

If the constraint condition CZ2 is limited to a shared parameter set related to the SPS and a shared parameter set related to the PPS, a bitstream has to satisfy each of the following conditions CZ3 and CZ4 as the bitstream conformance.

CZ3: “When the SPS having the layer identifier nuhLayerIdA is the active SPS of the layer having the layer identifier nuhLayerIdB, the layer having the layer identifier nuhLayerIdA is a direct reference layer or an indirect reference layer for the layer identifier nuhLayerIdB”.

CZ4: “When the PPS having the layer identifier nuhLayerIdA is the active PPS of the layer having the layer identifier nuhLayerIdB, the layer having the layer identifier nuhLayerIdA is a direct reference layer or an indirect reference layer for the layer identifier nuhLayerIdB”.

The above conditions CZ3 and CZ4 can also be respectively represented as the following conditions CZ3′ and CZ4′.

CZ3′: “When the SPS having the layer identifier nuh_layer_id equal to nuhLayerIdA is the active SPS of the layer having the layer identifier nuh_layer_id equal to nuhLayerIdB, the layer having the layer identifier nuh_layer_id equal to nuhLayerIdA is a direct reference layer or an indirect reference layer for the layer having the layer identifier nuh_layer_id equal to nuhLayerIdB”.

CZ4′: “When the PPS having the layer identifier nuh_layer_id equal to nuhLayerIdA is the active PPS of the layer having the layer identifier nuh_layer_id equal to nuhLayerIdB, the layer having the layer identifier nuh_layer_id equal to nuhLayerIdA is a direct reference layer or an indirect reference layer for the layer having the layer identifier nuh_layer_id equal to nuhLayerIdB”.

(Effect of Modification Example 2 of Non-VCL Dependency Type and Bitstream Constraints)

As described heretofore, in Modification Example 2 of the non-VCL dependency type, estimation of the non-VCL dependency present flag based on the direct_dependency_flag or the dependency flag allows a reduction in the amount of coding related to the flag for the presence of the non-VCL dependency type (non-VCL dependency present flag) and a reduction in the amount of processing related to decoding/coding thereof.

The bitstream constraints CZ1 to CZ4 (includes CZ1′ to CZ4′), in other words, state that a parameter set that can be used as a shared parameter set is a parameter set of a direct reference layer or an indirect reference layer for the target layer.

A parameter set that can be used as a shared parameter set is a parameter set having the layer identifier of a direct reference layer or an indirect reference layer for the target layer. That is, since “reference of the parameter sets of a layer included in the layer set A but not included in the layer set B by a layer in the layer set B which is a subset of the layer set A” can be forbidden when the layer set B, which is a subset, is extracted from the layer set A by using the bitstream extraction, the parameter sets of a direct reference layer or an indirect reference layer that is referenced by a layer included in the layer set B are not destroyed. Therefore, what can be resolved is the problem that a layer that uses a shared parameter set cannot be decoded in a sub-bitstream generated by the bitstream extraction. That is, the problem that may arise at the time of the bitstream extraction in the technology of the related art described with FIG. 1 can be resolved.

### Modification Example 1 of Shared Parameter Set

### Slice Header in Modification Example 1 of Shared Parameter Set

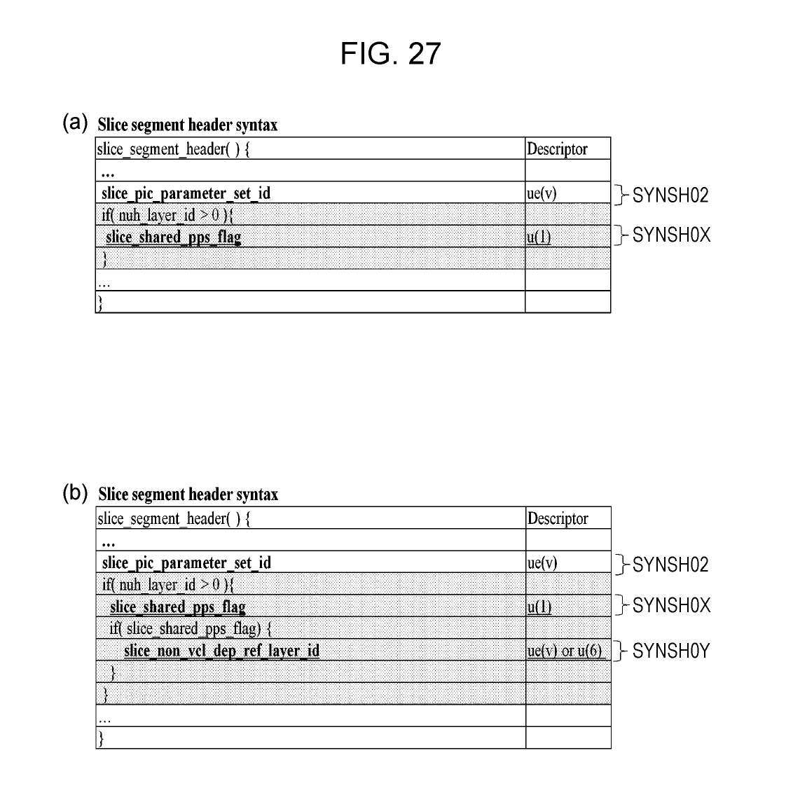

The slice header may include a shared PPS utilization flag (slice_shared_pps_flag) (for example, SYNSH0X in FIG. 27(a)) that indicates that the PPS is referenced between layers if the number of non-VCL direct reference layers which may be referenced as a shared parameter set by the target layer i is one (NumNonVCLDepRefLayers[i]==1). That is, in the example of FIG. 27(a), the slice header decoding unit 141 decodes the shared PPS utilization flag (slice_shared_pps_flag) immediately after the active PPS identifier (slice_pic_parameter_set_id) (SYNSH02 in FIG. 27(a)) if the layer identifier nuhLayerId (nuh_layer_id) of the target layer i is greater than zero. If the shared PPS utilization flag is equal to true, the coded data of the target layer i does not include the PPS that has the layer ID of the target layer i. Thus, the PPS that has the layer ID of the non-VCL dependent layer NonVCLDepRefLayerId[i][0] and is specified by the active PPS identifier (slice_pic_parameter_set_id) is set as the active PPS. If the shared PPS utilization flag is equal to false, the coded data of the target layer i includes the PPS that has the layer ID of the target layer i. Thus, the slice header decoding unit 141 sets the PPS having the layer ID of the target layer i and specified by the active PPS identifier (slice_pic_parameter_set_id) as the active PPS. That is, the slice header decoding unit 141 sets the PPS specified on the basis of the active PPS identifier and the shared PPS utilization flag as the active PPS to be referenced at the time of decoding subsequent syntax and the like and reads (fetches; activates the PPS) the coding parameters of the active PPS from the parameter manager 13.

(Effect of Slice Header in Modification Example 1 of Shared Parameter Set)

The same effect as the introduction of the presence of the non-VCL dependency type in the moving image decoding device 1 can be accomplished, and it is possible to choose whether to use a shared parameter set related to the PPS in units of pictures. For example, if the optimal parameters of the PPS used in coding of the picture between layers are different from the parameters of the reference layer, referencing the PPS having the layer ID of the target layer with slice_shared_pps_flag=0 in the target layer allows a reduction in the amount of coding of the coded data of the target layer picture and a reduction in the amount of processing related to decoding/coding of the coded data of the target layer picture. In addition, referencing the PPS having the layer ID of the reference layer with slice_shared_pps_flag=1 in the target layer allows omission of coding of the PPS having the layer ID of the target layer, thereby leading to a reduction in the amount of coding related to the PPS and a reduction in the amount of processing required for decoding/coding of the PPS.

(PPS in Modification Example 1 of Shared Parameter Set)

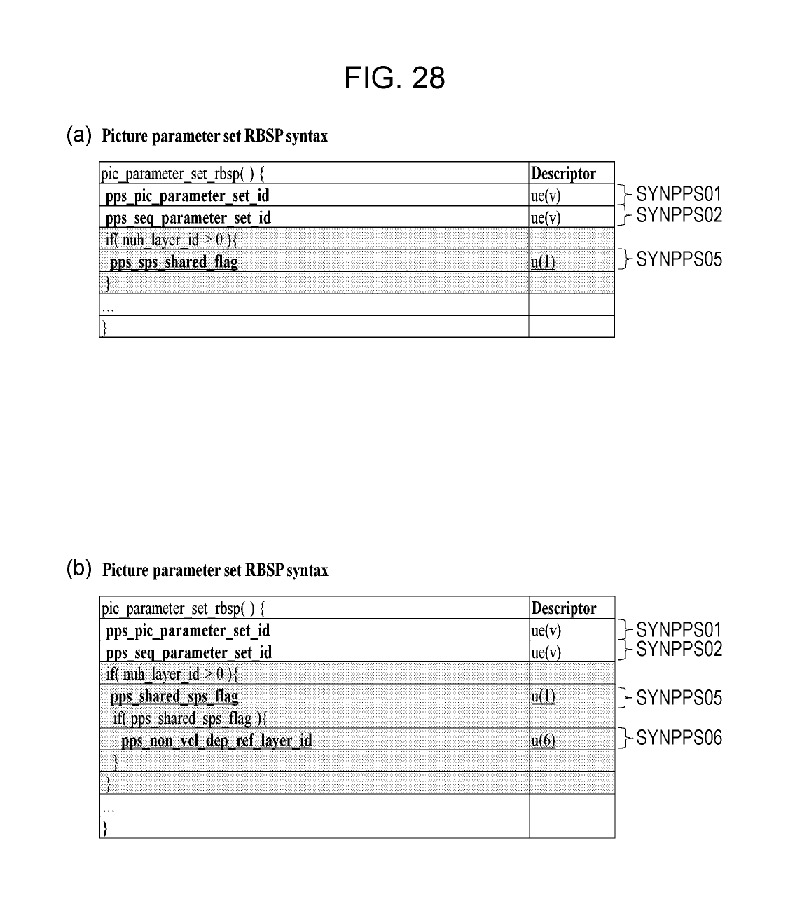

The picture parameter set PPS may include a shared SPS utilization flag (pps_shared_sps_flag) (for example, SYNPPS05 in FIG. 28(a)) that indicates that the SPS is referenced between layers if the number of non-VCL direct reference layers which may be referenced as a shared parameter by the target layer i is one (NumNonVCLDepRefLayers[i]==1). That is, in the example of FIG. 28(a), the parameter set decoding unit 12 decodes the shared SPS utilization flag (pps_shared_sps_flag) immediately after the PPS identifier (pps_pic_parameter_set_id) (SYNPPS01 in FIG. 28(a)) and the active SPS identifier (pps_seq_parameter_set_id) (SYNPPS02 in FIG. 28(a)) if the layer identifier nuhLayerId (nuh_layer_id) of the target layer i is greater than zero. If the shared SPS utilization flag is equal to true, the coded data of the target layer i does not include the SPS having the layer ID of the target layer i. Thus, the SPS that has the layer ID of the non-VCL dependent layer NonVCLDepRefLayerId[i][0] and is specified by the active SPS identifier (pps_seq_parameter_set_id) of the active PPS is set as the active SPS. If the shared SPS utilization flag is equal to false, the coded data of the target layer i includes the SPS having the layer ID of the target layer Thus, the SPS that has the layer ID of the target layer i and is specified by the active SPS identifier (pps_seq_parameter_set_id) of the active PPS is set as the active SPS. That is, the parameter set decoding unit 12 may set the SPS specified on the basis of the active SPS identifier and the shared SPS utilization flag as the active SPS to be referenced at the time of decoding subsequent syntax and the like and read (fetches; activates the SPS) the coding parameters of the active SPS from the parameter manager 13. If each syntax of the decoding target PPS is not dependent on the coding parameters of the active SPS, the activation process for the SPS is not required at the time of decoding the active SPS identifier and the shared SPS utilization flag of the decoding target PPS.

Similarly, the slice header decoding unit 141, since the coded data of the target layer i does not include the SPS having the layer ID of the target layer i if the shared SPS utilization flag is equal to true, sets the SPS having the layer ID of the non-VCL dependent layer NonVCLDepRefLayerIdx[i][0] and specified by the active SPS identifier (pps_seq_parameter_set_id) of the active PPS as the active SPS. If the shared SPS utilization flag is equal to false, the coded data of the target layer i includes the SPS having the layer ID of the target layer i. Thus, the slice header decoding unit 141 sets the SPS having the layer ID of the target layer i and specified by the active SPS identifier (pps_seq_parameter_set_id) of the active PPS as the active SPS. That is, the slice header decoding unit 141 sets the SPS specified on the basis of the active SPS identifier (pps_seq_parameter_set_id) and the shared SPS utilization flag of the active PPS as the active SPS and reads (fetches; activates the SPS) the coding parameters of the active SPS from the parameter set manager 13.

(Effect of PPS in Modification Example 1 of Shared Parameter Set)

The same effect as the introduction of the presence of the non-VCL dependency type in the moving image decoding device 1 can be accomplished, and it is possible to choose whether to use a shared parameter set related to the SPS in units of pictures. For example, if the optimal parameters of the SPS used in coding of the picture between layers are different from the parameters of the reference layer, referencing the SPS having the layer ID of the target layer with pps_shared_sps_flag=0 in the target layer allows a reduction in the amount of coding of the coded data of the target layer picture and a reduction in the amount of processing related to decoding/coding of the coded data of the target layer picture. In addition, referencing the SPS having the layer ID of the reference layer (non-VCL dependent layer) with pps_shared_sps_flag=1 in the target layer allows omission of coding of the SPS having the layer ID of the target layer, thereby leading to a reduction in the amount of coding related to the SPS and a reduction in the amount of processing required for decoding/coding of the SPS.

### Modification Example 2 of Shared Parameter Set

### Slice Header in Modification Example 2 of Shared Parameter Set

The slice header may include a shared PPS utilization flag (slice_shared_pps_flag) (for example, SYNSH0X in FIG. 27(b)) that indicates that the PPS is referenced between layers if the number of non-VCL direct reference layers which may be referenced as a shared parameter set by the target layer i is greater than one (NumNonVCLDepRefLayers[i]>1) and include non-VCL dependent layer specification information (slice_non_vol_dep_ref_layer_id (SYNSH0Y in FIG. 27(b)) of NonVCLDepRefLayerId[i][slice_non_vol_dep_ref_layer_id]) that specifies the layer identifier of a non-VCL dependent layer.

That is, in the example of FIG. 27(b), the slice header decoding unit 141 decodes the shared PPS utilization flag (slice_shared_pps_flag) immediately after the active PPS identifier (slice_pic_parameter_set_id) (SYNSH02 in FIG. 27(b)) if the layer identifier nuhLayerId (nuh_layer_id) of the target layer i is greater than zero. Furthermore, the slice header decoding unit 141 decodes the non-VCL dependent layer specification information (slice_non_vol_dep_ref_layer_id) if the shared PPS utilization flag is equal to true. Since the coded data of the target layer i does not include the PPS having the layer ID of the target layer i, the slice header decoding unit 141 sets the PPS having the layer ID of the non-VCL dependent layer NonVCLDepRefLayerId[i][slice_non_vcl_dep_ref_layer_id] and specified by the active PPS identifier (slice_pic_parameter_set_id) and the non-VCL dependent layer specification information (NonVCLDepRefLayerId[i][slice_non_vcl_dep_ref_layer_id]) as the active PPS. If the shared PPS utilization flag is equal to false, the coded data of the target layer i includes the PPS that has the layer ID of the target layer i. Thus, the slice header decoding unit 141 sets the PPS having the layer ID of the target layer i and specified by the active PPS identifier (slice_pic_parameter_set_id) as the active PPS. That is, the slice header decoding unit 141 sets the PPS specified on the basis of the active PPS identifier, the shared PPS utilization flag, and reference layer specification information as the active PPS to be referenced at the time of decoding subsequent syntax and the like and reads (fetches; activates the PPS) the coding parameters of the active PPS from the parameter manager 13.

(Effect of Slice Header in Modification Example 2 of Shared Parameter Set)

The same effect as the introduction of the presence of the non-VCL dependency type in the moving image decoding device 1 and the same effect as Modification Example 1 of the shared parameter set can be accomplished, and a shared parameter set related to the PPS can be selected in units of pictures from a plurality of layers. For example, if the optimal parameters of the PPS used in coding of the picture between layers are different from the parameters of the reference layer, referencing the PPS having the layer ID of the target layer with slice_shared_pps_flag=0 in the target layer allows a reduction in the amount of coding of the coded data of the target layer picture and a reduction in the amount of processing related to decoding/coding of the coded data of the target layer picture. In addition, referencing the PPS having the layer ID of the non-VCL dependent layer specified by the non-VCL dependent layer specification information (NonVCLDepRefLayerId[i][slice_non_vcl_dep_ref_layer_id]) with slice_shared_pps_flag=1 in the target layer allows omission of coding of the PPS having the layer ID of the target layer, thereby leading to a reduction in the amount of coding related to the PPS and a reduction in the amount of processing required for decoding/coding of the PPS.

(PPS in Modification Example 2 of Shared Parameter Set) The picture parameter set PPS may include a shared SPS utilization flag (pps_shared_sps_flag) (for example, SYNPPS05 in FIG. 28(b)) that indicates that the SPS is referenced between layers if the number of non-VCL direct reference layers which may be referenced as a shared parameter by the target layer i is greater than one (NumNonVCLDepRefLayers[i]>1) and include non-VCL dependent layer specification information (pps_non_vcl_dep_ref_layer_id (SYNPPS06 in FIG. 28(b)) of NonVCLDepRefLayerId[i][pps_non_vcl_dep_ref_layer_id]) that specifies the layer identifier of a non-VCL dependent layer.

That is, in the example of FIG. 28(b), the parameter set decoding unit 12 decodes the shared SPS utilization flag (pps_shared_sps_flag) immediately after the PPS identifier (pps_pic_parameter_set_id) (SYNPPS01 in FIG. 28(b)) and the active SPS identifier (pps_seq_parameter_set_id) (SYNPPS02 in FIG. 28(b)) if the layer identifier nuhLayerId (nuh_layer_id) of the target layer i is greater than zero. Furthermore, the parameter set decoding unit 12 decodes the non-VCL dependent layer specification information (pps_non_vcl_dep_ref_layer_id) if the shared SPS utilization flag is equal to true. The parameter set decoding unit 12, since the coded data of the target layer i does not include the SPS having the layer ID of the target layer i, sets the SPS having the layer ID of the non-VCL dependent layer NonVCLDepRefLayerId[i][pps_non_vcl_dep_ref_layer_id] and having the active SPS identifier (pps_seq_parameter_set_id) of the active PPS as the active SPS.

If the shared SPS utilization flag is equal to false, the coded data of the target layer i includes the SPS having the layer ID of the target layer i. Thus, the parameter set decoding unit 12 sets the SPS having the layer ID of the target layer i and specified by the active SPS identifier (pps_seq_parameter_set_id) of the active PPS as the active SPS. That is, the parameter set decoding unit 12 may set the SPS specified on the basis of the active SPS identifier, the shared SPS utilization flag (pps_shared_sps_flag), and the non-VCL dependent layer specification information (pps_non_vcl_dep_ref_layer_id) as the active SPS to be referenced at the time of decoding subsequent syntax and the like and read (fetches; activates the SPS) the coding parameters of the active SPS from the parameter manager 13. If each syntax of the decoding target PPS is not dependent on the coding parameters of the active SPS, the activation process for the SPS is not required at the time of decoding the active SPS identifier, the shared SPS utilization flag, and the non-VCL dependent layer specification information of the decoding target PPS.

Similarly, the slice header decoding unit 141, since the coded data of the target layer i does not include the SPS having the layer ID of the target layer i if the shared SPS utilization flag is equal to true, sets the SPS having the layer ID of the non-VCL dependent layer NonVCLDepRefLayerId[i][pps_non_vcl_dep_ref_layer_id] and having the active SPS identifier (pps_seq_parameter_set_id) of the active PPS as the active SPS. If the shared SPS utilization flag is equal to false, the coded data of the target layer i includes the SPS having the layer ID of the target layer i. Thus, the slice header decoding unit 141 sets the SPS having the layer ID of the target layer i and specified by the active SPS identifier (pps_seq_parameter_set_id) of the active PPS as the active SPS. That is, the slice header decoding unit 141 sets the SPS specified on the basis of the active SPS identifier (pps_seq_parameter_set_id), the shared SPS utilization flag, and the non-VCL dependent layer specification information (pps_nov_vol_dep_ref_layer_id) of the active PPS as the active SPS and reads (fetches; activates the SPS) the coding parameters of the active SPS from the parameter set manager 13.

(Effect of PPS in Modification Example 2 of Shared Parameter Set)

The same effect as the introduction of the presence of the non-VCL dependency type in the moving image decoding device 1 and the same effect as Modification Example 1 of the shared parameter set can be accomplished, and a shared parameter set related to the SPS can be selected in units of pictures from a plurality of layers. For example, if the optimal parameters of the SPS used in coding of the picture between layers are different from the parameters of the reference layer, referencing the SPS having the layer ID of the target layer with pps_shared_sps_flag=0 in the target layer allows a reduction in the amount of coding of the coded data of the target layer picture and a reduction in the amount of processing related to decoding/coding of the coded data of the target layer picture. In addition, referencing the SPS having the layer ID of the non-VCL dependent layer specified by NonVCLDepRefLayerId[i][pps_nov_vol_dep_ref_layer_id] with pps_shared_sps_flag=1 in the target layer allows omission of coding of the SPS having the layer ID of the target layer, thereby leading to a reduction in the amount of coding related to the SPS and a reduction in the amount of processing required for decoding/coding of the SPS.

(Supplementary Matters)

While the parameter set decoding unit 12 included in the hierarchical moving image decoding device 1 decodes the value of the syntax “direct_dependency_type[i][j]” (SYNVPS0D in FIG. 13), which indicates a layer dependency type indicating a reference relationship between the i-th layer and the j-th layer, as layer dependency type value−1 described in the example of FIG. 14, that is, the value of “DirectDepType[i][j]−1”, for the inter-layer dependency information, the present embodiment is not limited to this. Instead, the value of the syntax “direct_dependency_type[i][j]” may be directly decoded as the layer dependency type value, that is, the value of “DirectDepType[i][j]”. In this case, the following constraint CV1 is added with respect to the value of the syntax “direct_dependency_type[i][j]” that indicates a layer dependency type. That is, a bitstream has to satisfy the following condition CV1 as the bitstream conformance.

CV1: “If the value of the direct_dependency_flag “direct_dependency_flag[i][j]” is one, the value of the syntax “direct_dependency_type[i][j]” that indicates a layer dependency type is an integer greater than zero”. That is, if the range of the value of the layer dependency type “direct_dependency_type[i][j]” is represented by the bit length M of the layer dependency type and N determined by the total number of layer dependency types, the range of the value of direct_dependency_type[i][j] is from 1 to (2̂M−N).

Even in the above case, the same effect as the effect described in (Effect of Non-VCL Dependency Type) is accomplished. Furthermore, since the value of the syntax “direct_dependency_type[i][j]” is directly set to the layer dependency type value, that is, the value of “DirectDepType[i][j]”, the number of addition (subtraction) operations can be reduced compared with a case of setting the value of the syntax to “DirectDepType[i][j]−1”. That is, a derivation process and a decoding process performed on the layer dependency type “DirectDepType[i][j]” can be simplified. The above change can be applied to a parameter set coding unit 22 included in the hierarchical moving image coding device 2, and the same effect is accomplished.

[Hierarchical Moving Image Coding Device]

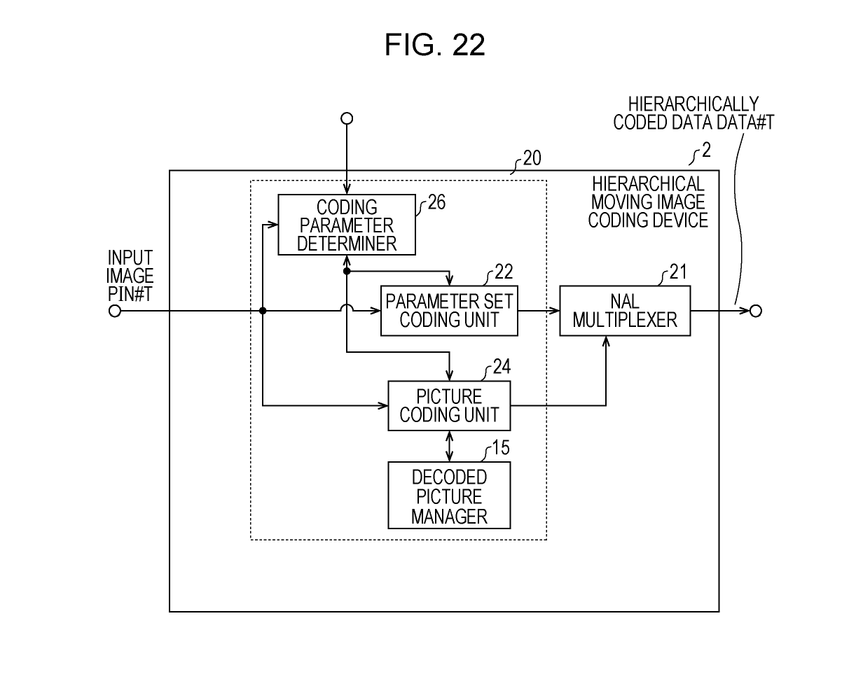

Hereinafter, a configuration of the hierarchical moving image coding device 2 according to the present embodiment will be described with reference to FIG. 22.

(Configuration of Hierarchical Moving Image Coding Device)

A schematic configuration of the hierarchical moving image coding device 2 will be described by using FIG. 22. FIG. 22 is a functional block diagram illustrating a schematic configuration of the hierarchical moving image coding device 2. The hierarchical moving image coding device 2 codes an input image PIN#T (picture) of each layer included in a coding target layer set (target layer set) to generate the hierarchically coded data DATA of the target layer set. That is, the moving image coding device 2 codes a picture of each layer in ascending order from the lowermost layer ID to the highermost layer ID included in the target layer set and generates the coded data of the picture. In other words, a picture of each layer is coded in the order of the layer ID list LayerSetLayerIdList[0] . . . LayerSetIdList[N−1] (where N is the number of layers included in the target layer set) of the target layer set.

The hierarchical moving image coding device 2 includes a target layer set picture coding unit 20 and an NAL multiplexer 21 as illustrated in FIG. 22. The target layer set picture coding unit 20 is configured to include a parameter set coding unit 22, a picture coding unit 24, the decoded picture manager 15, and a coding parameter determiner 26.

The decoded picture manager 15 is the same constituent as the previously described decoded picture manager 15 included in the hierarchical moving image decoding device 1. However, since the decoded picture manager 15 included in the hierarchical moving image coding device 2 is not required to output a picture recorded in the internal DPB as an output picture, the output can be omitted. The description of the decoded picture manager 15 of the hierarchical moving image decoding device 1 can also be applied to the decoded picture manager 15 of the hierarchical moving image coding device 2 by replacing the word “decoded” with “coded” in the description.

The NAL multiplexer 21 generates the hierarchical moving image coded data DATA#T that is multiplexed in the NAL by storing the VCL and the non-VCL of each layer of the input target layer set in the NAL units and outputs the hierarchical moving image coded data DATA#T to an external unit. In other words, the NAL multiplexer 21 generates the hierarchically coded data DATA#T that is multiplexed in the NAL by storing (coding) in the NAL units the non-VCL coded data, the VCL coded data, and the NAL unit type, the layer identifier, and the temporal identifier corresponding to each of the non-VCL and the VCL supplied from the target layer set picture coding unit 20.

The coding parameter determiner 26 selects one set from a plurality of coding parameter sets. Coding parameters include various parameters related to each parameter set (VPS, SPS, and PPS), prediction parameters for coding of a picture, and coding target parameters that are generated with respect to the prediction parameters. The coding parameter determiner 26 calculates a cost value that indicates the magnitude of the amount of information and a coding error for each of the plurality of coding parameter sets. The cost value is, for example, the sum of the amount of coding and a value resulting from multiplying a squared error by a coefficient λ. The amount of coding is the amount of information of the coded data in each layer of the target layer set obtained by coding a quantization error and a coding parameter in a variable-length code. The squared error is the total sum of the square value of the difference value between the input image PIN#T and a predicted image between pixels. The coefficient λ is a real number greater than zero that is set in advance. The coding parameter determiner 26 selects a coding parameter set of which the calculated cost value is the smallest and supplies each selected coding parameter set to the parameter set coding unit 22 and the picture coding unit 24.

The parameter set coding unit 22 sets parameter sets (VPS, SPS, and SPS) used in coding of the input image on the basis of each coding parameter set input from the coding parameter determiner 26 and the input image and supplies each parameter set as data to be stored in the non-VCL NAL unit to the NAL multiplexer 21. A parameter set that is coded by the parameter set coding unit 22 includes the inter-layer dependency information (the direct dependency flag, the bit length of the layer dependency type, and the layer dependency type) and the inter-layer positional correspondence information described in the description of the parameter set decoding unit 12 included in the hierarchical moving image decoding device 1. The parameter set coding unit 22 codes the non-VCL dependency present flag as a part of the layer dependency type. The parameter set coding unit 22 also outputs the NAL unit type, the layer identifier, and the temporal identifier corresponding to the non-VCL when supplying the non-VCL coded data to the NAL multiplexer 21.

A parameter set that is generated by the parameter set coding unit 22 includes an identifier for identification of the parameter set and an active parameter set identifier that specifies a parameter set (active parameter set) referenced by the parameter set for decoding of a picture in each layer. Specifically, for the video parameter set VPS, the VPS identifier for identification of the VPS is included in the VPS. For the sequence parameter set SPS, the SPS identifier (sps_seq_parameter_set_id) for identification of the SPS and the active VPS identifier (sps_video_parameter_set_id) that specifies the VPS referenced by the SPS or other syntax are included in the SPS. For the picture parameter set PPS, the PPS identifier (pps_pic_parameter_set_id) for identification of the PPS and the active SPS identifier (pps_seq_parameter_set_id) that specifies the SPS referenced by the PPS or other syntax are included in the PPS.

The picture coding unit 24 codes a part of the input image in each layer corresponding to the slices constituting a picture on the basis of the input image PIN#T in each layer, the parameter sets supplied from the coding parameter determiner 26, and the reference picture recorded in the decoded picture manager 15, which are input, to generate the coded data of the part and supplies the coded data as data to be stored in the VCL NAL unit to the NAL multiplexer 21. A detailed description of the picture coding unit 24 will be described later. The picture coding unit 24 also outputs the NAL unit type, the layer identifier, and the temporal identifier corresponding to the VCL when supplying the VCL coded data to the NAL multiplexer 21.

(Picture Coding Unit 24)

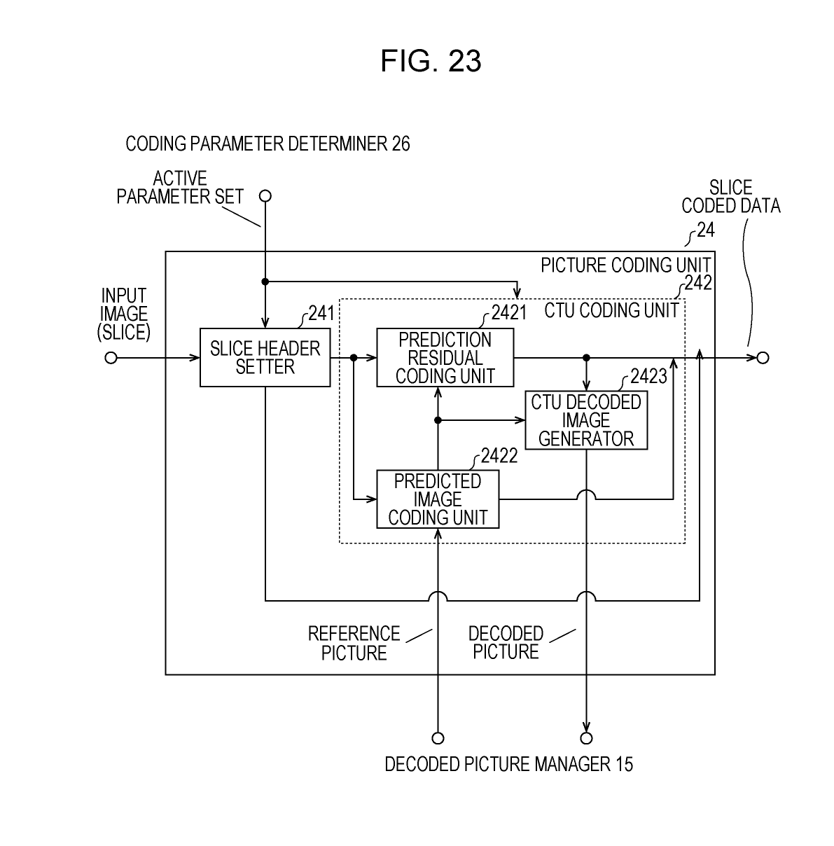

A detailed configuration of the picture coding unit 24 will be described with reference to FIG. 23. FIG. 23 is a functional block diagram illustrating a schematic configuration of the picture coding unit 24.

The picture coding unit 24 is configured to include a slice header setter 241 and a CTU coding unit 242 as illustrated in FIG. 23.

The slice header setter 241 generates the slice header that is used in coding of the input image in each layer which is input in units of slices, on the basis of the input active parameter sets. The generated slice header is output as a part of slice coded data and is supplied to the CTU coding unit 242 along with the input image. The slice header generated by the slice header setter 241 includes the active PPS identifier that specifies the picture parameter set PPS (active PPS) referenced for decoding of the picture in each layer.

The CTU coding unit 242 codes the input image (target slice part) in units of CTUs on the basis of the input active parameter sets and the slice header to generate and output the slice data and the decoded image (decoded picture) related to the target slice. More specifically, the CTU coding unit 242 splits the input image of the target slice in units of CTBs, each having the size of the CTB included in the parameter sets, and codes the image corresponding to each CTB as one CTU. Coding of the CTU is performed by a prediction residual coding unit 2421, a predicted image coding unit 2422, and a CTU decoded image generator 2423.

The prediction residual coding unit 2421 outputs quantized residual information (TT information) obtained by transforming and quantizing the difference image between the input image and the predicted image as a part of the slice data included in the slice coded data. In addition, inverse transformation and inverse quantization are applied to the quantized residual information to restore the prediction residual, and the restored prediction residual is output to the CTU decoded image generator 2423.

The predicted image coding unit 2422 generates a predicted image on the basis of a prediction scheme and prediction parameters determined by the coding parameter determiner 26 for the target CTU included in the target slice and outputs the predicted image to the prediction residual coding unit 2421 and the CTU decoded image generator 2423. Information about the prediction scheme and the prediction parameters is coded in a variable-length code as the prediction information (PT information) and is output as a part of the slice data included in the slice coded data. Types of prediction schemes that can be selected by the predicted image coding unit 2422 include at least inter-layer image prediction.

The predicted image coding unit 2422, if inter-layer image prediction is selected as the prediction scheme, performs the corresponding reference position derivation process to determine the position of the reference layer pixel corresponding to the predicted target pixel and determines the predicted pixel value using the interpolation process based on the position. As the corresponding reference position derivation process, each process described for the predicted image generator 1422 of the hierarchical moving image decoding device 1 can be applied. For example, the processes described in <Details of Predicted Image Generation Process In Layer Image Prediction> are applied. If inter prediction or inter-layer image prediction is used, the corresponding reference picture is read from the decoded picture manager 15.

As described heretofore, the predicted image coding unit 2422 included in the hierarchical moving image coding device 2 can derive an accurate position on the reference layer picture corresponding to the predicted target pixel by using the inter-layer phase correspondence information. Thus, the accuracy of the predicted pixel generated by the interpolation process is improved. Therefore, the hierarchical moving image coding device 2 can generate and output the coded data with a smaller amount of coding than the related art.

The CTU decoded image generator 2423 is the same constituent as the CTU decoded image generator 1423 included in the hierarchical moving image decoding device 1 and thus will not be described. The decoded image of the target CTU is supplied to the decoded picture manager 15 and is recorded in the internal DPB.

<Coding Process Performed by Picture Coding Unit 24>

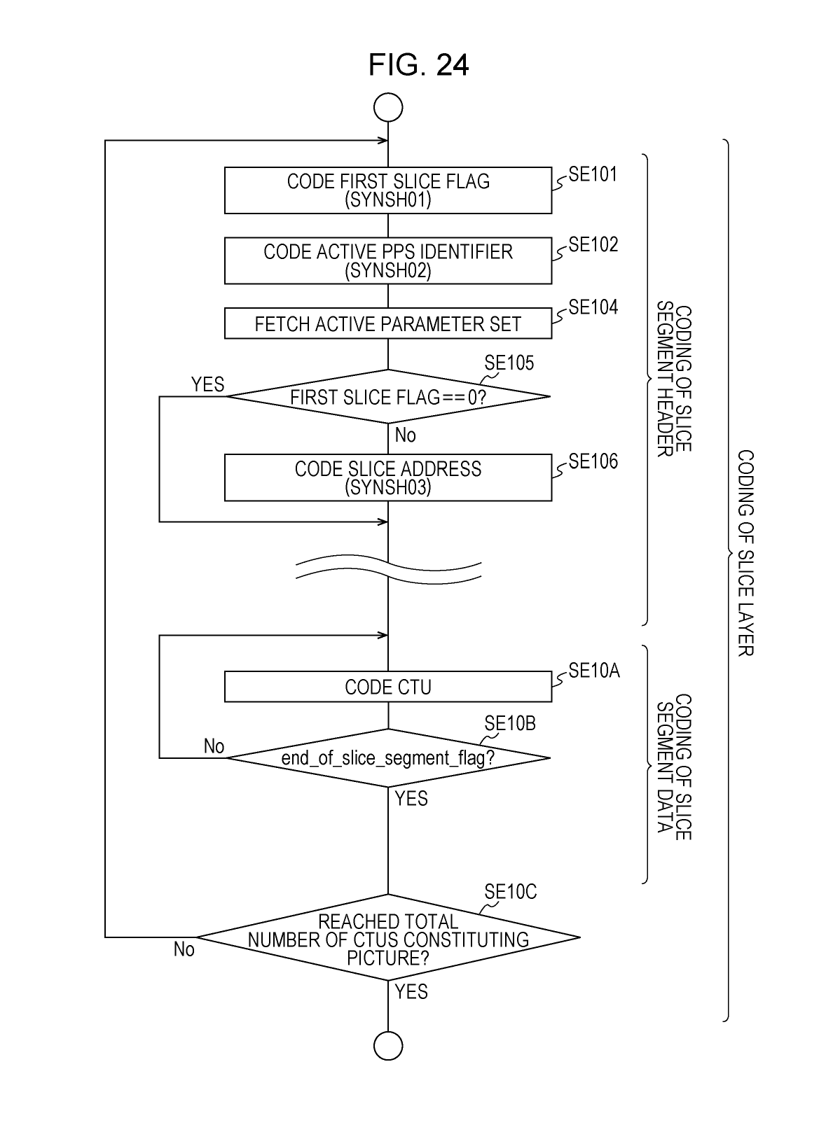

Hereinafter, an operation of coding a picture of the target layer i in the picture coding unit 24 will be schematically described with reference to FIG. 24. FIG. 24 is a flowchart illustrating a coding process that is performed in the picture coding unit 24 in units of slices constituting a picture of the target layer i.

(SE101) The first slice flag of the coding target slice (first_slice_segment_pic_flag) is coded. That is, if the input image that is split in units of slices (hereinafter, a coding target slice) is the first slice in a coding order (decoding order) (hereinafter, processing order) in the picture, the first slice flag (first_slice_segment_pic_flag) is equal to one. If the coding target slice is not the first slice, the first slice flag is equal to zero. If the first slice flag is equal to one, the first CTU address of the coding target slice is set to zero. The counter numCtb for the number of previously processed CTUs in the picture is set to zero. If the first slice flag is equal to zero, the first CTU address of the coding target slice is set on the basis of the slice address that is coded in Step SD106 described below.

(SE102) The active PPS identifier (slice_pic_parameter_set_id) that specifies the active PPS referenced at the time of coding of the coding target slice is coded.

(SE104) The active parameter sets that are determined by the coding parameter determiner 26 are fetched. That is, the PPS having the same PPS identifier (pps_pic_parameter_set_id) as the active PPS identifier (slice_pic_parameter_set_id) referenced by the coding target slice is used as the active PPS, and the coding parameters of the active PPS are fetched (read) from the coding parameter determiner 26. The SPS having the same SPS identifier (sps_seq_parameter_set_id) as the active SPS identifier (pps_seq_parameter_set_id) in the active PPS is used as the active SPS, and the coding parameters of the active SPS are fetched from the coding parameter determiner 26. The VPS having the same VPS identifier (vps_video_parameter_set_id) as the active VPS identifier (sps_video_parameter_set_id) in the active SPS is used as the active VPS, and the coding parameters of the active VPS are fetched from the coding parameter determiner 26.

(SE105) A determination of whether the coding target slice is the first slice in the processing order in the picture is performed on the basis of the first slice flag. If the first slice flag is equal to zero (Yes in SE105), a transition is made to Step SE106. Otherwise (No in SE105), the process of Step SE106 is skipped. If the first slice flag is equal to one, the slice address of the coding target slice is equal to zero.

(SE106) The slice address (slice_segment_address) of the coding target slice is coded. The slice address of the coding target slice (first CUT address of the coding target slice) can be set on the basis of, for example, the counter numCtb for the number of previously processed CTUs in the picture. In this case, the slice address slice_segment_address is set to numCtb. That is, the first CTU address of the coding target slice is set to numCtb. The method for determination of the slice address is not limited to this and can be changed to the extent possible.

. . . omitted . . .

(SE10A) The CTU coding unit 242 codes the input image (coding target slice) in units of CTUs on the basis of the input active parameter sets and the slice header and outputs the coded data of the CTU information (SYNSD01 in FIG. 18) as a part of the slice data of the coding target slice. The CTU coding unit 242 generates and outputs the CTU decoded image of a region corresponding to each CTU. After the coded data of each CTU information, the slice end flag (end_of_slice_segment_flag) (SYNSD2 in FIG. 18) that indicates whether the CTU is the end of the coding target slice is coded. If the CTU is the end of the coding target slice, the slice end flag is set to one and coded, and otherwise, the slice end flag is set to zero and coded. After coding of each CTU, the value of the previously processed CTU number numCtb is incremented by one (numCtb++).

(SE10B) A determination of whether the CTU is the end of the coding target slice is performed on the basis of the slice end flag. If the slice end flag is equal to one (Yes in SE10B), a transition is made to Step SE10C. Otherwise (No in SE10B), a transition is made to Step SE10A in order to code subsequent CTU information.

(SE10C) A determination of whether the previously processed CTU number numCtu reaches the total number of CTUs constituting the picture (PicSizeInCtbsY) is performed. That is, a determination of numCtu==PicSizeInCtbsY is performed. If numCtu is equal to PicSizeInCtbsY (Yes in SE10C), the coding process performed in units of slices constituting the coding target picture is ended. Otherwise (numCtu<PicSizeInCtbsY) (No in SE10C), a transition is made to Step SE101 in order to continue the coding process performed in units of slices constituting the coding target target picture.

While operation of the picture coding unit 24 according to the first embodiment is described heretofore, the present embodiment is not limited to the above steps, and the steps may be changed to the extent possible.

(Effect of Moving Image Coding Device 2)

The hierarchical moving image coding device 2 according to the present embodiment described heretofore can reduce the amount of coding related to the parameter sets of the target layer by sharing the parameter sets used in coding of the reference layer as the parameter sets (SPS and PPS) used in coding of the target layer. More specifically, the presence of the dependency type between non-VCLs is newly introduced in the present embodiment as a layer dependency type in addition to the dependency type between VCLs (inter-layer image prediction and inter-layer motion prediction). Types of dependency between non-VCLs include sharing of a parameter set (shared parameter set) between different layers and prediction (inter parameter set syntax prediction) of a part of syntax between parameter sets in different layers.

Explicit notification of the presence of the dependency type indicating the presence of the non-VCL accomplishes the effect that a decoder can recognize which layer in the layer set is a non-VCL dependent layer (non-VCL reference layer) of the target layer by decoding the VPS extension data. That is, what can be resolved is the problem that the layer that uses the parameter sets of the layer A having the layer identifier value of nuhLayerIdA in common (the layer to which a shared parameter set is applied) is not known at the time of the start of coded data decoding.

Introduction of the presence of the dependency type between non-VCLs allows explicit representation of the following bitstream constraints between a decoder and an encoder.

That is, a bitstream has to satisfy the following condition CX1 as the bitstream conformance.

CX1: “When the non-VCL having the layer identifier nuhLayerIdA is a non-VCL that is used by the layer having the layer identifier nuhLayerIdB, the layer having the layer identifier nuhLayerIdA is a direct reference layer for the layer identifier nuhLayerIdB and has the non-VCL dependency present flag equal to one”.

If the condition CX1 is limited to a shared parameter set, a bitstream has to satisfy the following condition CX2 as the bitstream conformance.

CX2: “When the parameter sets having the layer identifier nuhLayerIdA are the active parameter sets of the layer having the layer identifier nuhLayerIdB, the layer having the layer identifier nuhLayerIdA is a direct reference layer for the layer identifier nuhLayerIdB and has the non-VCL dependency present flag equal to one”.

If the constraint condition CX2 is limited to a shared parameter set related to the SPS and a shared parameter set related to the PPS, a bitstream has to satisfy each of the following conditions CX3 and CX4 as the bitstream conformance.

CX3: “When the SPS having the layer identifier nuhLayerIdA is the active SPS of the layer having the layer identifier nuhLayerIdB, the layer having the layer identifier nuhLayerIdA is a direct reference layer for the layer identifier nuhLayerIdB and has the non-VCL dependency present flag equal to one”.

CX4: “When the PPS having the layer identifier nuhLayerIdA is the active PPS of the layer having the layer identifier nuhLayerIdB, the layer having the layer identifier nuhLayerIdA is a direct reference layer for the layer identifier nuhLayerIdB and has the non-VCL dependency present flag equal to one”.

The bitstream constraints, in other words, state that a parameter set that can be used as a shared parameter set is a parameter set of a direct reference layer for the target layer.

The expression that a parameter set that can be used as a shared parameter set is a parameter set of a direct reference layer for the target layer means forbidding reference from a layer included in the layer set A but not included in the layer set B in the layer set B which is a subset of the layer set A.

That is, since sharing of a parameter set that references a layer not included in the layer set B can be forbidden when the layer set B, which is a subset, is extracted from the layer set A by using the bitstream extraction, the parameter sets having the layer ID of a direct reference layer that is referenced by a certain layer included in the layer set B are not destroyed. Therefore, what can be resolved is the problem that a layer that uses a shared parameter set cannot be decoded in a sub-bitstream generated by the bitstream extraction. That is, the problem that may arise at the time of the bitstream extraction in the technology of the related art described with FIG. 1 can be resolved.

### Modification Example 1 of Non-VCL Dependency Type

Modification Example 1 of the non-VCL dependency type in the moving image coding device 1 corresponds to Modification Example 1 of the non-VCL dependency type in the moving image decoding device 1 and has the same content and thus will not be described. The same effect as Modification Example 1 of the non-VCL dependency type in the moving image decoding device 1 is accomplished.

### Modification Example 2 of Non-VCL Dependency Type

Modification Example 2 of the non-VCL dependency type in the moving image coding device 1 corresponds to Modification Example 2 of the non-VCL dependency type in the moving image decoding device 1 and has the same content and thus will not be described. The same effect as Modification Example 2 of the non-VCL dependency type in the moving image decoding device 1 is accomplished.

### Modification Example 1 of Shared Parameter Set

Modification Example 1 of the shared parameter set in the moving image coding device 2 is the inverse of the process corresponding to Modification Example 1 of the shared parameter set in the moving image decoding device 1.

(Slice Header According to Modification Example 1 of Shared Parameter Set)

The slice header may include a shared PPS utilization flag (slice_shared_pps_flag) (for example, SYNSH0X in FIG. 27(a)) that indicates that the PPS is referenced between layers if the number of non-VCL direct reference layers which may be referenced as a shared parameter set by the target layer i is one (NumNonVCLDepRefLayers[i]==1). That is, in the example of FIG. 27(a), the slice header setter 241 codes the shared PPS utilization flag (slice_shared_pps_flag) immediately after the active PPS identifier (slice_pic_parameter_set_id) (SYNSH02 in FIG. 27(a)) if the layer identifier nuhLayerId (nuh_layer_id) of the target layer i is greater than zero. If the shared PPS utilization flag is equal to true, coding of the PPS having the layer ID of the target layer i as a part of the coded data of the target layer i is omitted in the parameter set code unit 22, and the slice header setter 241 sets the previously coded PPS having the layer ID of the non-VCL dependent layer NonVCLDepRefLayerId[i][0] and specified by the active PPS identifier (slice_pic_parameter_set_id) as the active PPS. If the shared PPS utilization flag is equal to false, the PPS having the layer ID of the target layer i is previously coded as a part of the coded data of the target layer i in the parameter set code unit 22, and thus, the slice header setter 241 sets the previously coded PPS having the layer ID of the target layer i and specified by the active PPS identifier (slice_pic_parameter_set_id) as the active PPS. That is, the slice header setter 241 sets the PPS specified on the basis of the active PPS identifier and the shared PPS utilization flag as the active PPS to be referenced at the time of coding subsequent syntax and the like and reads (fetches; activates the PPS) the coding parameters of the active PPS from the coding parameter determiner 26.

(Effect of Slice Header According to Modification Example 1 of Shared Parameter Set)

The same effect as the introduction of the presence of the non-VCL dependency type in the moving image decoding device 1 can be accomplished, and it is possible to choose whether to use a shared parameter set related to the PPS in units of pictures. For example, if the optimal parameters of the PPS used in coding of the picture between layers are different from the parameters of the reference layer, referencing the PPS having the layer ID of the target layer with slice_shared_pps_flag=0 in the target layer allows a reduction in the amount of coding of the coded data of the target layer picture and a reduction in the amount of processing related to decoding/coding of the coded data of the target layer picture. In addition, referencing the PPS having the layer ID of the reference layer with slice_shared_pps_flag=1 in the target layer allows omission of coding of the PPS having the layer ID of the target layer, thereby leading to a reduction in the amount of coding related to the PPS and a reduction in the amount of processing required for decoding/coding of the PPS.

(PPS According to Modification Example 1 of Shared Parameter Set)

The picture parameter set PPS may include a shared SPS utilization flag (pps_shared_pps_flag) that indicates that the SPS is referenced between layers if the number of non-VCL direct reference layers which may be referenced as a shared parameter by the target layer i is one (NumNonVCLDepRefLayers[i]==1). That is, in the example of FIG. 28(a), the parameter set coding unit 22 codes the shared SPS utilization flag (pps_shared_sps_flag) immediately after the PPS identifier (pps_pic_parameter_set_id) (SYNPPS01 in FIG. 28(a)) and the active SPS identifier (pps_seq_parameter_set_id) (SYNPPS02 in FIG. 28(a)) if the layer identifier nuhLayerId (nuh_layer_id) of the target layer i is greater than zero. If the shared SPS utilization flag (pps_shared_sps_flag) is equal to true, the parameter set coding unit 22 omits coding of the SPS having the layer ID of the target layer i as a part of the coded data of the target layer i and sets the previously coded SPS having the layer ID of the non-VCL dependent layer NonVCLDepRefLayerId[i][0] and specified by the active SPS identifier (pps_seq_parameter_set_id) as the active SPS. If the shared SPS utilization flag is equal to false, the parameter set coding unit 22 codes the SPS that has the layer ID of the target layer i and specified by the active SPS identifier (pps_seq_parameter_set_id) as a part of the coded data of the target layer i and sets the SPS specified by the active SPS identifier (pps_seq_parameter_set_id) as the active SPS. That is, the parameter set coding unit 22 may set the SPS specified on the basis of the active SPS identifier and the shared SPS utilization flag as the active SPS to be referenced at the time of coding subsequent syntax and the like and read (fetches; activates the SPS) the coding parameters of the active SPS from the coding parameter determiner 26. If each syntax of the coding target PPS is not dependent on the coding parameters of the active SPS, the activation process for the SPS is not required at the time of the start of coding of the coding target PPS.

If the shared SPS utilization flag is equal to true, coding of the SPS having the layer ID of the target layer i as a part of the coded data of the target layer i is omitted in the parameter set code unit 22, and the slice header setter 241 sets the previously coded SPS having the layer ID of the non-VCL dependent layer NonVCLDepRefLayerId[i][0] and specified by the active SPS identifier (pps_seq_parameter_set_id) of the active PPS as the active SPS. If the shared SPS utilization flag is equal to false, the SPS having the layer ID of the target layer i is previously coded as a part of the coded data of the target layer i in the parameter set code unit 22, and thus, the slice header setter 241 sets the previously coded SPS having the layer ID of the target layer i and specified by the active SPS identifier (pps_seq_parameter_set_id) of the active PPS as the active SPS. That is, the slice header setter 241 sets the SPS specified on the basis of the active SPS identifier (pps_seq_parameter_set_id) and the shared SPS utilization flag of the active PPS as the active SPS to be referenced at the time of coding subsequent syntax and the like and reads (fetches; activates the SPS) the coding parameters of the active SPS from the coding parameter determiner 26.

(Effect of PPS According to Modification Example 1 of Shared Parameter Set)

The same effect as the introduction of the presence of the non-VCL dependency type in the moving image decoding device 1 can be accomplished, and it is possible to choose whether to use a shared parameter set related to the SPS in units of pictures. For example, if the optimal parameters of the SPS used in coding of the picture between layers are different from the parameters of the reference layer, referencing the SPS having the layer ID of the target layer with pps_shared_sps_flag=0 in the target layer allows a reduction in the amount of coding of the coded data of the target layer picture and a reduction in the amount of processing related to decoding/coding of the coded data of the target layer picture. In addition, referencing the SPS having the layer ID of the reference layer with pps_shared_sps_flag=1 in the target layer allows omission of coding of the SPS having the layer ID of the target layer, thereby leading to a reduction in the amount of coding related to the SPS and a reduction in the amount of processing required for decoding/coding of the SPS.

### Modification Example 2 of Shared Parameter Set

Modification Example 2 of the shared parameter set in the moving image coding device 2 is the inverse of the process corresponding to Modification Example 2 of the shared parameter set in the moving image decoding device 1.

(Slice Header According to Modification Example 2 of Shared Parameter Set)

The slice header may include a shared PPS utilization flag (slice_shared_pps_flag) (for example, SYNSH0X in FIG. 27(b)) that indicates that the PPS is referenced between layers if the number of non-VCL direct reference layers which may be referenced as a shared parameter set by the target layer i is greater than one (NumNonVCLDepRefLayers[i]>1) and include non-VCL dependent layer specification information (slice_non_vol_dep_ref_layer_id (SYNSH0Y in FIG. 27(b)) of NonVCLDepRefLayerId[i][slice_non_vol_dep_ref_layer_id]) that specifies a non-VCL dependent layer.

That is, in the example of FIG. 27(b), the slice header setter 241 codes the shared PPS utilization flag (slice_shared_pps_flag) immediately after the active PPS identifier (slice_pic_parameter_set_id) if the layer identifier nuhLayerId (nuh_layer_id) of the target layer i is greater than zero. If the shared PPS utilization flag is equal to true, coding of the PPS having the layer ID of the target layer i as a part of the coded data of the target layer i is omitted in the parameter set code unit 22, and the slice header setter 241 sets the previously coded PPS having the layer ID of the non-VCL dependent layer NonVCLDepRefLayerId[i][slice_non_vol_dep_ref_layer_id] and specified by the active PPS identifier (slice_pic_parameter_set_id) and the non-VCL dependent layer specification information (slice_non_vol_dep_ref_layer_id of NonVCLDepRefLayerId[i][slice_non_vol_dep_ref_layer_id]) as the active PPS. If the shared PPS utilization flag is equal to false, the PPS having the layer ID of the target layer i is previously coded as a part of the coded data of the target layer i in the parameter set coding unit 22, and thus, the slice header setter 241 sets the previously coded PPS having the layer ID of the target layer i and specified by the active PPS identifier (slice_pic_parameter_set_id) as the active PPS.

(Effect of Slice Header According to Modification Example 2 of Shared Parameter Set)

The same effect as the introduction of the presence of the non-VCL dependency type in the moving image decoding device 1 and the same effect as Modification Example 1 of the shared parameter set can be accomplished, and a shared parameter set related to the PPS can be selected in units of pictures from a plurality of layers. For example, if the optimal parameters of the PPS used in coding of the picture between layers are different from the parameters of the reference layer, referencing the PPS having the layer ID of the target layer with slice_shared_pps_flag=0 in the target layer allows a reduction in the amount of coding of the coded data of the target layer picture and a reduction in the amount of processing related to decoding/coding of the coded data of the target layer picture. In addition, referencing the PPS having the layer ID of the non-VCL dependent layer specified by NonVCLDepRefLayerId[i][slice_non_vol_dep_ref_layer_id] with slice_shared_pps_flag=1 in the target layer allows omission of coding of the PPS having the layer ID of the target layer, thereby leading to a reduction in the amount of coding related to the PPS and a reduction in the amount of processing required for decoding/coding of the PPS.

(PPS According to Modification Example 2 of Shared Parameter Set)

The picture parameter set PPS may include a shared SPS utilization flag (pps_shared_sps_flag) (for example, SYNPPS05 in FIG. 28(b)) that indicates that the SPS is referenced between layers if the number of non-VCL direct reference layers which may be referenced as a shared parameter by the target layer i is greater than one (NumNonVCLDepRefLayers[i]>1) and include non-VCL dependent layer specification information (pps_non_vcl_dep_ref_layer_id (SYNPPS06 in FIG. 28(b)) of NonVCLDepRefLayerId[i][pps_non_vcl_dep_ref_layer_id]) that specifies a non-VCL dependent layer.

That is, in the example of FIG. 28(b), the parameter set coding unit 22 codes the shared SPS utilization flag (pps_shared_sps_flag) immediately after the PPS identifier (pps_pic_parameter_set_id) (SYNPPS01 in FIG. 28(b)) and the active SPS identifier (pps_seq_parameter_set_id) (SYNPPS02 in FIG. 28(b)) if the layer identifier nuhLayerId (nuh_layer_id) of the target layer i is greater than zero. Furthermore, the parameter set coding unit 22 codes the non-VCL dependent layer specification information (pps_non_vcl_dep_ref_layer_id) if the shared SPS utilization flag is equal to true. The parameter set coding unit 22 omits coding of the SPS having the layer ID of the target layer i as a part of the coded data of the target layer i and sets the previously coded SPS having the layer ID of the non-VCL dependent layer NonVCLDepRefLayerId[i][pps_non_vcl_dep_ref_layer_id] and having the active SPS identifier (pps_seq_parameter_set_id) of the active PPS as the active SPS. If the shared SPS utilization flag is equal to false, the parameter set coding unit 22 codes the SPS that has the layer ID of the target layer i and specified by the active SPS identifier (pps_seq_parameter_set_id) as a part of the coded data of the target layer i and sets the SPS specified by the active SPS identifier (pps_seq_parameter_set_id) as the active SPS. That is, the parameter set coding unit 22 may set the SPS specified on the basis of the active SPS identifier, the shared SPS utilization flag (pps_shared_pps_flag), and the non-VCL dependent layer specification information (pps_non_vcl_dep_ref_layer_id) as the active SPS to be referenced at the time of coding subsequent syntax and the like and read (fetches; activates the SPS) the coding parameters of the active SPS from the coding parameter determiner 26. If each syntax of the coding target PPS is not dependent on the coding parameters of the active SPS, the activation process for the SPS is not required at the time of the start of coding of the coding target PPS.

If the shared SPS utilization flag is equal to true, coding of the SPS having the layer ID of the target layer i as a part of the coded data of the target layer i is omitted in the parameter set coding unit 22, and the slice header setter 241 sets the previously coded SPS having the layer ID of the non-VCL dependent layer NonVCLDepRefLayerId[i][pps_non_vol_ref_layer_id] and specified by the active SPS identifier (pps_seq_parameter_set_id) of the active PPS as the active SPS. If the shared SPS utilization flag is equal to false, the SPS having the layer ID of the target layer i is previously coded as a part of the coded data of the target layer i in the parameter set coding unit 22, and thus, the slice header setter 241 sets the previously coded SPS having the layer ID of the target layer i and specified by the active SPS identifier (pps_seq_parameter_set_id) of the active PPS as the active SPS. That is, the slice header setter 241 sets the SPS specified on the basis of the active SPS identifier, the shared SPS utilization flag (pps_shared_sps_flag), and the non-VCL dependent layer specification information (pps_non_vol_ref_layer_id) of the active PPS as the active SPS to be referenced at the time of coding subsequent syntax and the like and reads (fetches; activates the SPS) the coding parameters of the active SPS from the coding parameter determiner 26.

(Effect of PPS According to Modification Example 2 of Shared Parameter Set)

The same effect as the introduction of the presence of the non-VCL dependency type in the moving image decoding device 1 and the same effect as Modification Example 1 of the shared parameter set can be accomplished, and a shared parameter set related to the SPS can be selected in units of pictures from a plurality of layers. For example, if the optimal parameters of the SPS used in coding of the picture between layers are different from the parameters of the reference layer, referencing the SPS having the layer ID of the target layer with pps_shared_sps_flag=0 in the target layer allows a reduction in the amount of coding of the coded data of the target layer picture and a reduction in the amount of processing related to decoding/coding of the coded data of the target layer picture. In addition, referencing the SPS having the layer ID of the non-VCL dependent layer specified by NonVCLDepRefLayerId[i][pps_non_vol_dep_ref_layer_id] with pps_shared_sps_flag=1 in the target layer allows omission of coding of the SPS having the layer ID of the target layer, thereby leading to a reduction in the amount of coding related to the SPS and a reduction in the amount of processing required for decoding/coding of the SPS.

(Supplementary Matters)

While the parameter set coding unit 22 included in the hierarchical moving image coding device 2 codes the value of the syntax “direct_dependency_type[i][j]” (SYNVPS0D in FIG. 13), which indicates a layer dependency type indicating a reference relationship between the i-th layer and the j-th layer, as layer dependency type value−1 described in the example of FIG. 14, that is, the value of “DirectDepType[i][j]−1”, for the inter-layer dependency information, the present embodiment is not limited to this. Instead, the value of the syntax “direct_dependency_type[i][j]” may be directly coded as the layer dependency type value, that is, the value of “DirectDepType[i][j]”. In this case, the following constraint CV1 is added with respect to the value of the syntax “direct_dependency_type[i][j]” that indicates a layer dependency type. That is, a bitstream has to satisfy the following condition CV1 as the bitstream conformance.

CV1: “If the value of the direct_dependency_flag “direct_dependency_flag[i][j]” is one, the value of the syntax “direct_dependency_type[i][j]” that indicates a layer dependency type is an integer greater than zero”. That is, if the range of the value of the layer dependency type “direct_dependency_type[i][j]” is represented by the bit length M of the layer dependency type and N determined by the total number of layer dependency types, the range of the value of direct_dependency_type[i][j] is from 1 to (2̂M−N). Even in the above case, the same effect as the effect described in (Effect of Non-VCL Dependency Type) is accomplished. Furthermore, since the value of the syntax “direct_dependency_type[i][j]” is directly set to the layer dependency type value, that is, the value of “DirectDepType[i][j]”, the number of addition (subtraction) operations can be reduced compared with a case of setting the value of the syntax to “DirectDepType[i][j]−1”. That is, a derivation process and a coding process performed on the layer dependency type “DirectDepType[i][j]” can be simplified. The above change is the inverse of the process corresponding to (Supplementary Matters) described with the hierarchical moving image decoding device 1.

### Application Example for Other Hierarchical Moving Image Coding/Decoding Systems

The hierarchical moving image coding device 2 and the hierarchical moving image decoding device 1 described above can be used as being mounted on various apparatuses performing transmission, reception, recording, and reproduction of a moving image. The moving image may be a natural moving image captured by a camera or the like or may be an artificial moving image (includes CG and GUI) generated by a computer or the like.

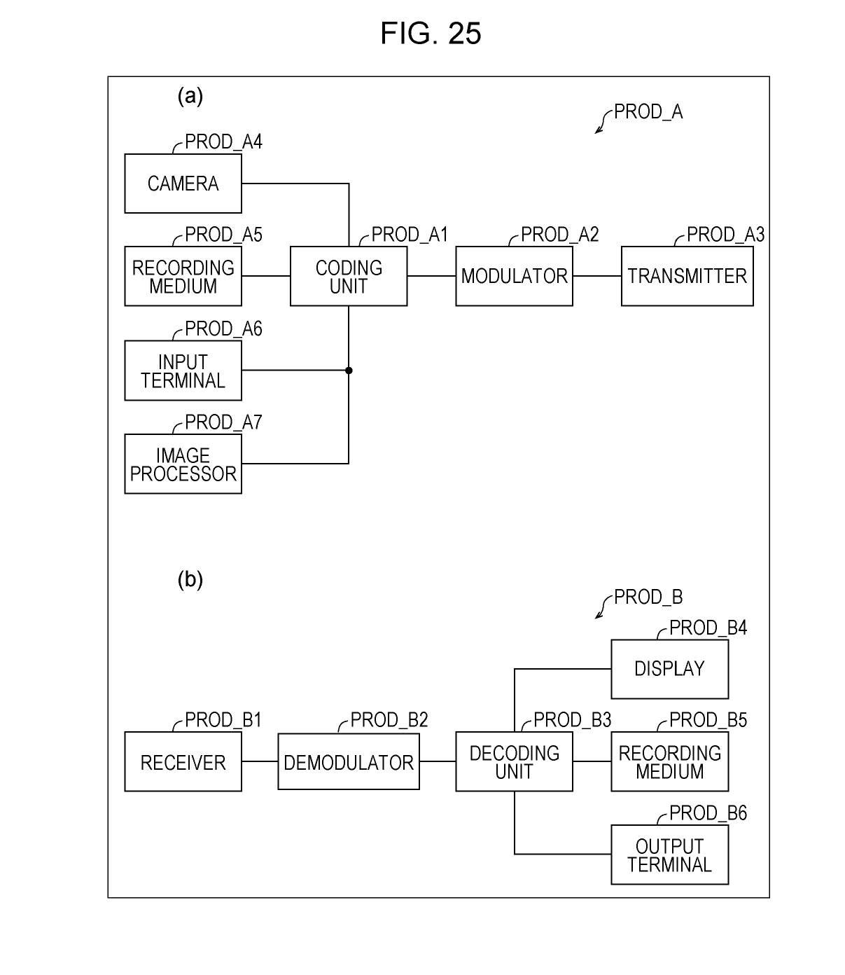

Transmission and reception of a moving image that can use the hierarchical moving image coding device 2 and the hierarchical moving image decoding device 1 described above will be described on the basis of FIG. 25. FIG. 25(a) is a block diagram illustrating a configuration of a transmission apparatus PROD_A on which the hierarchical moving image coding device 2 is mounted.

As illustrated in FIG. 25(a), the transmission apparatus PROD_A includes a coding unit PROD_A1 that codes a moving image to obtain coded data, a modulator PROD_A2 that modulates a carrier wave with the coded data obtained by the coding unit PROD_A1 to obtain a modulated signal, and a transmitter PROD_A3 that transmits the modulated signal obtained by the modulator PROD_A2. The hierarchical moving image coding device 2 described above is used as the coding unit PROD_A1.

The transmission apparatus PROD_A may further include a camera PROD_A4 that captures a moving image, a recording medium PROD_A5 on which a moving image is recorded, an input terminal PROD_A6 for inputting of a moving image from an external unit, and an image processor A7 that generates or processes an image, as supply sources of a moving image to be input into the coding unit PROD_A1. While FIG. 25(a) illustrates a configuration in which the transmission apparatus PROD_A includes all of these elements, a part of the elements may be omitted.

The recording medium PROD_A5 may be a type on which an uncoded moving image is recorded or may be a type on which a moving image coded by a coding scheme for recording that is different from a coding scheme for transmission is recorded. In the latter case, a decoding unit (not illustrated) that decodes coded data read from the recording medium PROD_A5 in accordance with the coding scheme for recording may be interposed between the recording medium PROD_A5 and the coding unit PROD_A1.

FIG. 25(b) is a block diagram illustrating a configuration of a reception apparatus PROD_B on which the hierarchical moving image decoding device 1 is mounted. As illustrated in FIG. 25(b), the reception apparatus PROD_B includes a receiver PROD_B1 that receives a modulated signal, a demodulator PROD_B2 that demodulates the modulated signal received by the receiver PROD_B1 to obtain coded data, and a decoding unit PROD_B3 that decodes the coded data obtained by the demodulator PROD_B2 to obtain a moving image. The hierarchical moving image decoding device 1 described above is used as the decoding unit PROD_B3.

The reception apparatus PROD_B may further include a display PROD_B4 that displays a moving image, a recording medium PROD_B5 for recording of a moving image, and an output terminal PROD_B6 for outputting of a moving image to an external unit, as supply destinations of a moving image output by the decoding unit PROD_B3. While FIG. 25(b) illustrates a configuration in which the reception apparatus PROD_B includes all of these elements, a part of the elements may be omitted.

The recording medium PROD_B5 may be a type for recording of an uncoded moving image or may be a type coded by a coding scheme for recording that is different from a coding scheme for transmission. In the latter case, a coding unit (not illustrated) that codes a moving image obtained from the decoding unit PROD_B3 in accordance with the coding scheme for recording may be interposed between the decoding unit PROD_B3 and the recording medium PROD_B5.

A transmission medium for transmission of the modulated signal may be wired or wireless. A transmission form in which the modulated signal is transmitted may be broadcasting (indicates a transmission form in which a transmission destination is not specified in advance) or may be communication (indicates a transmission form in which a transmission destination is specified in advance). That is, transmission of the modulated signal may be realized by any of wireless broadcasting, wired broadcasting, wireless communication, and wired communication.

A broadcasting station (broadcasting facility or the like)/reception station (television receiver or the like) for terrestrial digital broadcasting, for example, is an example of the transmission apparatus PROD_A/reception apparatus PROD_B transmitting or receiving the modulated signal using wireless broadcasting. A broadcasting station (broadcasting facility or the like)/reception station (television receiver or the like) for cable television broadcasting is an example of the transmission apparatus PROD_A/reception apparatus PROD_B transmitting or receiving the modulated signal using wired broadcasting.

A server (workstation or the like)/client (television receiver, personal computer, smartphone, or the like) for a video on demand (VOD) service, a moving image sharing service, or the like using the Internet is an example of the transmission apparatus PROD_A/reception apparatus PROD_B transmitting or receiving the modulated signal using communication (generally, any of a wireless type and a wired type is used as a transmission medium in a LAN, and a wired type is used as a transmission medium in a WAN). Types of personal computers include a desktop PC, a laptop PC, and a tablet PC. Types of smartphones include a multifunctional mobile phone terminal.

The client of a moving image sharing service has a function of coding a moving image captured by a camera and uploading the moving image to the server in addition to a function of decoding coded data downloaded from the server and displaying the decoded data on a display. That is, the client of a moving image sharing service functions as both of the transmission apparatus PROD_A and the reception apparatus PROD_B.

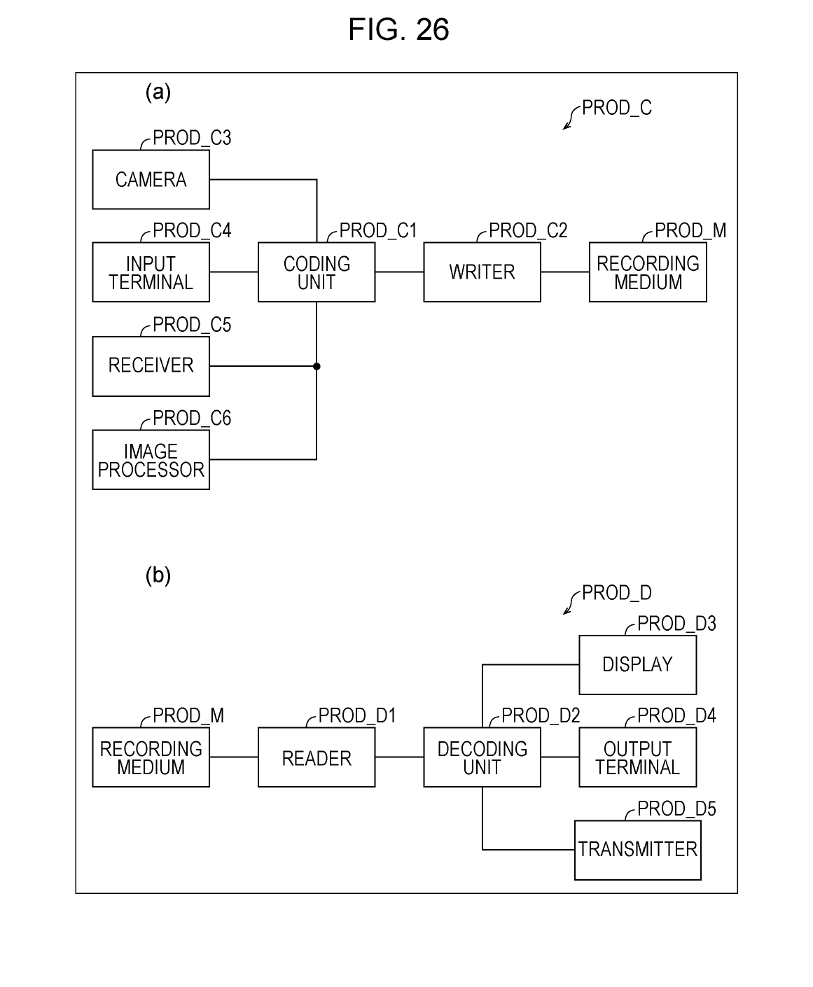

Recording and reproduction of a moving image that can use the hierarchical moving image coding device 2 and the hierarchical moving image decoding device 1 described above will be described on the basis of FIG. 26. FIG. 26(a) is a block diagram illustrating a configuration of a recording apparatus PROD_C on which the hierarchical moving image coding device 2 described above is mounted.

As illustrated in FIG. 26(a), the recording apparatus PROD_C includes a coding unit PROD_C1 that codes a moving image to obtain coded data and a writer PROD_C2 that writes the coded data obtained by the coding unit PROD_C1 onto a recording medium PROD_M. The hierarchical moving image coding device 2 described above is used as the coding unit PROD_C1.

The recording medium PROD_M may be (1) a type incorporated into the recording apparatus PROD_C, such as a hard disk drive (HDD) or a solid state drive (SSD), (2) a type connected to the recording apparatus PROD_C, such as an SD memory card or a Universal Serial Bus (USB) flash memory, or (3) a type mounted in a drive device (not illustrated) incorporated into the recording apparatus PROD_C, such as a digital versatile disc (DVD) or a Blu-ray Disc (BD; registered trademark).

The recording apparatus PROD_C may further include a camera PROD_C3 that captures a moving image, an input terminal PROD_C4 for inputting of a moving image from an external unit, a receiver PROD_C5 for reception of a moving image, and an image processor C6 that generates or processes an image, as supply sources of a moving image to be input into the coding unit PROD_C1. While FIG. 26(a) illustrates a configuration in which the recording apparatus PROD_C includes all of these elements, a part of the elements may be omitted.

The receiver PROD_C5 may be a type that receives an uncoded moving image or may be a type that receives coded data coded by using a coding scheme for transmission which is different from a coding scheme for recording. In the latter case, a decoding unit for transmission (not illustrated) that decodes coded data coded by using the coding scheme for transmission may be interposed between the receiver PROD_C5 and the coding unit PROD_C1.

Such a recording apparatus PROD_C is exemplified by, for example, a DVD recorder, a BD recorder, or a hard disk drive (HDD) recorder (in this case, either the input terminal PROD_C4 or the receiver PROD_C5 serves as a main supply source of a moving image). A camcorder (in this case, the camera PROD_C3 is a main supply source of a moving image), a personal computer (in this case, either the receiver PROD_C5 or the image processor C6 serves as a main supply source of a moving image), a smartphone (in this case, either the camera PROD_C3 or the receiver PROD_C5 serves as a main supply source of a moving image), and the like are also examples of such a recording apparatus PROD_C.

FIG. 26(b) is a block illustrating a configuration of a reproduction apparatus PROD_D on which the hierarchical moving image decoding device 1 described above is mounted. As illustrated in FIG. 26(b), the reproduction apparatus PROD_D includes a reader PROD_D1 that reads coded data written on the recording medium PROD_M and a decoding unit PROD_D2 that decodes the coded data read by the reader PROD_D1 to obtain a moving image. The hierarchical moving image decoding device 1 is used as the decoding unit PROD_D2.

The recording medium PROD_M may be (1) a type incorporated into the reproduction apparatus PROD_D, such as an HDD or an SSD, (2) a type connected to the reproduction apparatus PROD_D, such as an SD memory card or a USB flash memory, or (3) a type mounted in a drive device (not illustrated) incorporated into the reproduction apparatus PROD_D, such as a DVD or a BD.

The reproduction apparatus PROD_D may further include a display PROD_D3 that displays a moving image, an output terminal PROD_D4 for outputting of a moving image to an external unit, and a transmitter PROD_D5 that transmits a moving image, as supply destinations of a moving image output by the decoding unit PROD_D2. While FIG. 26(b) illustrates a configuration in which the reproduction apparatus PROD_D includes all of these elements, a part of the elements may be omitted.

The transmitter PROD_D5 may be a type that transmits an uncoded moving image or may be a type that transmits coded data coded by using a coding scheme for transmission which is different from a coding scheme for recording. In the latter case, a coding unit (not illustrated) that codes a moving image using the coding scheme for transmission may be interposed between the decoding unit PROD_D2 and the transmitter PROD_D5.

Such a reproduction apparatus PROD_D is exemplified by, for example, a DVD player, a BD player, or an HDD player (in this case, the output terminal PROD_D4 to which a television receiver or the like is connected serves as a main supply destination of a moving image). A television receiver (in this case, the display PROD_D3 serves as a main supply destination of a moving image), digital signage (refers to an electronic signboard or an electronic bulletin board; either the display PROD_D3 or the transmitter PROD_D5 serves as a main supply destination of a moving image), a desktop PC (in this case, either the output terminal PROD_D4 or the transmitter PROD_D5 serves as a main supply destination of a moving image), a laptop or tablet PC (in this case, either the display PROD_D3 or the transmitter PROD_D5 serves as a main supply destination of a moving image), a smartphone (in this case, either the display PROD_D3 or the transmitter PROD_D5 serves as a main supply destination of a moving image), and the like are also examples of such a reproduction apparatus PROD_D.

(Hardware Realization and Software Realization)

Finally, each block of the hierarchical moving image decoding device 1 and the hierarchical moving image coding device 2 may be realized in a hardware manner by a logic circuit formed on an integrated circuit (IC chip) or may be realized in a software manner by using a central processing unit (CPU).

In the latter case, each device includes a CPU that executes instructions of a control program realizing each function, a read-only memory (ROM) that stores the program, a random access memory (RAM) in which the program is loaded, a storage (recording medium) such as a memory that stores the program and a variety of data, and the like. The object of the present invention can also be achieved in such a manner that a recording medium in which program codes of a control program (executable format program, intermediate code program, or source program) which is software realizing the functions described above for each device are recorded in a manner readable by a computer is supplied to each device and that the computer (or a CPU or a microprocessing unit (MPU)) reads and executes the program codes recorded in the recording medium.

As the recording medium, tapes such as a magnetic tape and a cassette tape, disks including magnetic disks such as a Floppy (registered trademark) disk/hard disk and optical disks such as a compact disc read-only memory (CD-ROM)/magneto-optical (MO) disk/mini disc (MD)/digital versatile disk (DVD)/CD recordable (CD-R), cards such as an IC card (includes a memory card)/optical card, semiconductor memories such as a mask ROM/erasable programmable read-only memory (EPROM)/electrically erasable and programmable read-only memory (EEPROM; registered trademark)/flash ROM, or logic circuits such as a programmable logic device (PLD) or a field programmable gate array (FPGA) can be used.

Each device may be configured to be connectable to a communication network, and the program codes may be supplied through the communication network. The communication network is not particularly limited provided that the communication network is capable of transmitting the program codes. For example, the Internet, an intranet, an extranet, a local area network (LAN), an integrated services digital network (ISDN), a value-added network (VAN), a community antenna television (CATV) communication network, a virtual private network, a telephone line network, a mobile communication network, or a satellite communication network can be used. A transmission medium constituting the communication network is not limited to a specific configuration or a type provided that the transmission medium is a medium capable of transmitting the program codes. For example, either a wired type such as Institute of Electrical and Electronic Engineers (IEEE) 1394, USB, power-line communication, a cable TV line, a telephone line, and an asymmetric digital subscriber line (ADSL) line or a wireless type such as an infrared ray including infrared data association (IrDA) and remote control, Bluetooth (registered trademark), the IEEE802.11 wireless protocol, high data rate (HDR), near field communication (NFC), Digital Living Network Alliance (DLNA; registered trademark), a mobile phone network, a satellite line, and a terrestrial digital network can be used. The present invention may be realized in a form of a computer data signal embedded in a carrier wave, the signal into which the program codes are implemented by electronic transmission.

### CONCLUSION

An image decoding device according to a first aspect of the present invention is an image decoding device that includes layer identifier decoding means for decoding a layer identifier, layer dependency flag decoding means for decoding a layer dependency flag which indicates a reference relationship between a target layer and a reference layer, and non-VCL decoding means for decoding a non-VCL. The image decoding device is characterized by decoding image coded data that satisfies a conformance condition stating that a layer identifier of a non-VCL that is referenced from a target layer is the same layer identifier as the target layer or a layer identifier of a layer which is directly referenced from the target layer.

The above image decoding device decodes the image coded data that satisfies the expression “a non-VCL of a layer that can be referenced by a target layer is a non-VCL having a layer identifier of a direct reference layer for the target layer”. The expression “a non-VCL of a layer that can be referenced by a target layer is a non-VCL having a layer identifier of a direct reference layer for the target layer” means forbidding “reference of a non-VCL of a layer included in a layer set A but not included in a layer set B by a layer in the layer set B which is a subset of the layer set A”.

That is, since “reference of a non-VCL of a layer included in the layer set A but not included in the layer set B by a layer in the layer set B which is a subset of the layer set A” can be forbidden when the layer set B, which is a subset, is extracted from the layer set A by using the bitstream extraction, a non-VCL of a direct reference layer that is referenced by a layer included in the layer set B is not destroyed. Therefore, what can be resolved is the problem that a non-VCL of a direct reference layer is destroyed in a sub-bitstream generated by bitstream extraction and that a layer referencing the direct reference layer cannot be decoded.

An image decoding device according to a second aspect of the present invention is characterized by, in the first aspect, decoding the image coded data that satisfies a conformance condition stating that the layer identifier of the referenced non-VCL is a layer identifier which is indirectly referenced from the target layer.

The above image decoding device decodes the image coded data in which a non-VCL of a reference layer that can be referenced by a target layer is a non-VCL of a direct reference layer or an indirect reference layer for the target layer. Therefore, what can be resolved is the problem that a non-VCL of a direct reference layer or an indirect reference layer is destroyed in a sub-bitstream generated by bitstream extraction and that a layer referencing the direct reference layer or the indirect reference layer cannot be decoded.

An image decoding device according to a third aspect of the present invention is characterized by, in the first or second aspect, decoding the image coded data that is characterized in that the reference layer is specified by the layer dependency flag.

The above image coded data is limited to the expression “the direct reference layer or the indirect reference layer is a reference layer that is specified by the layer dependency flag indicating a reference relationship between the target layer and the reference layer”. That is, the image coded data is limited to the expression “a non-VCL of a reference layer that can be referenced by a target layer is a reference layer that is specified by the layer dependency flag indicating a reference relationship between the target layer and the reference layer”. Therefore, the image coded data can resolve the problem that a non-VCL of a direct reference layer or an indirect reference layer specified by the layer dependency flag is destroyed in a sub-bitstream generated by bitstream extraction and that a layer referencing the non-VCL of the direct reference layer or the indirect reference layer cannot be decoded.

An image decoding device according to a fourth aspect of the present invention is characterized by, in the first aspect, further including layer dependency type decoding means for decoding a layer dependency type, in which the layer dependency type includes a non-VCL dependency type that indicates the presence of dependency between the non-VCL of the target layer and the non-VCL of the reference layer.

The above image decoding device decodes the image coded data that is limited to the expression “the direct reference layer is a reference layer for which the non-VCL dependency type indicates dependency between non-VCLs”. That is, the image coded data is limited to the expression “a reference layer that can be referenced by a target layer is a direct reference layer that has dependency between non-VCLs of the target layer and the direct reference layer”. Therefore, what can be resolved is the problem that a non-VCL of a direct reference layer that has dependency between non-VCLs of the target layer and the direct reference layer is destroyed in a sub-bitstream generated by bitstream extraction and that a layer referencing the direct reference layer cannot be decoded.

An image decoding device according to a fifth aspect of the present invention is characterized by, in the fourth aspect, decoding the image decoded data that satisfies a conformance condition stating that a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB.

The above image decoding device decodes the image coded data that is limited to the expression “a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB”. Therefore, what can be resolved is the problem that a non-VCL of a direct reference layer having nuh_layer_id equal to nuhLayerIdA is destroyed in a sub-bitstream generated by bitstream extraction and that a layer having nuh_layer_id equal to nuhLayerIdB and referencing the direct reference layer cannot be decoded.

An image decoding device according to a sixth aspect of the present invention is characterized by, in the fourth or fifth aspect, decoding the image coded data in which the non-VCL dependency type includes the presence of dependency on a shared parameter set.

The above image decoding device decodes the image coded data that is limited to the expression “a parameter set that can be referenced as a shared parameter set by the target layer is a parameter set of a direct reference layer for which the non-VCL dependency types of the target layer and the direct reference layer indicate dependency on a shared parameter set”. Therefore, what can be resolved is the problem that a parameter set of a direct reference layer for which the non-VCL dependency types of the target layer and the direct reference layer indicate dependency on a shared parameter set is destroyed in a sub-bitstream generated by bitstream extraction and that a layer referencing the direct reference layer cannot be decoded.

An image decoding device according to a seventh aspect of the present invention is characterized by, in the fourth or fifth aspect, decoding the image coded data in which the non-VCL dependency type includes the presence of dependency on inter parameter set prediction.

The above image decoding device decodes the image coded data that is limited to the expression “a parameter set that can be referenced as inter parameter set prediction by the target layer is a parameter set of a direct reference layer for which the non-VCL dependency types of the target layer and the direct reference layer indicate dependency on inter parameter set prediction”. Therefore, what can be resolved is the problem that a parameter set of a direct reference layer for which the non-VCL dependency types of the target layer and the direct reference layer indicate dependency on inter parameter set prediction is destroyed in a sub-bitstream generated by bitstream extraction and that a layer referencing the direct reference layer cannot be decoded.

An image decoding device according to an eighth aspect of the present invention is characterized by, in the first to seventh aspects, decoding the image coded data in which the non-VCL includes a parameter set.

The above image decoding device decodes the parameter set as the non-VCL. Therefore, what can be resolved is the problem that a parameter set of the reference layer is destroyed in a sub-bitstream generated by bitstream extraction and that a layer referencing the reference layer cannot be decoded.

Image coded data according to a ninth aspect of the present invention is image coded data that is characterized by satisfying a conformance condition stating that a layer identifier of a non-VCL of a reference layer that is referenced from a target layer is the same layer identifier as the target layer or a layer identifier of a direct reference layer for the target layer.

The above image coded data is limited to the expression “a non-VCL of a layer that can be referenced by a target layer is a non-VCL of a direct reference layer for the target layer”. The expression “a non-VCL of a layer that can be referenced by a target layer is a non-VCL having a layer identifier of a direct reference layer for the target layer” means forbidding “reference of a non-VCL of a layer included in a layer set A but not included in a layer set B by a layer in the layer set B which is a subset of the layer set A”.

That is, since “reference of a non-VCL of a layer included in the layer set A but not included in the layer set B by a layer in the layer set B which is a subset of the layer set A” can be forbidden when the layer set B, which is a subset, is extracted from the layer set A by using the bitstream extraction, a non-VCL of a direct reference layer that is referenced by a layer included in the layer set B is not destroyed. Therefore, the image coded data can resolve the problem that a non-VCL of a direct reference layer is destroyed in a sub-bitstream generated by bitstream extraction and that a layer referencing the direct reference layer cannot be decoded.

Image coded data according to a tenth aspect of the present invention is image coded data that is characterized by, in the ninth aspect, satisfying a conformance condition stating that a layer identifier of a non-VCL of a reference layer that is referenced from the target layer is a layer identifier of an indirect reference layer for the target layer.

The above image coded data is limited to the expression “a non-VCL of a reference layer that can be referenced by a target layer is a non-VCL of a direct reference layer or an indirect reference layer for the target layer”. Therefore, the image coded data can resolve the problem that a non-VCL of a direct reference layer or an indirect reference layer is destroyed in a sub-bitstream generated by bitstream extraction and that a layer referencing the direct reference layer or the indirect reference layer cannot be decoded.

Image coded data according to an eleventh aspect of the present invention is characterized by, in the ninth or tenth aspect, further including a layer dependency flag that indicates a reference relationship between the target layer and the reference layer, in which the reference layer is specified by the layer dependency flag.

According to the above image coded data, the image coded data that is limited to the expression “the direct reference layer or the indirect reference layer is a reference layer that is specified by the layer dependency flag indicating a reference relationship between the target layer and the reference layer” is decoded. That is, the image coded data is limited to the expression “a non-VCL of a reference layer that can be referenced by a target layer is a reference layer that is specified by the layer dependency flag indicating a reference relationship between the target layer and the reference layer”. Therefore, what can be resolved is the problem that a non-VCL of a direct reference layer or an indirect reference layer specified by the layer dependency flag is destroyed in a sub-bitstream generated by bitstream extraction and that a layer referencing the non-VCL of the direct reference layer or the indirect reference layer cannot be decoded.

Image coded data according to a twelfth aspect of the present invention is characterized by, in the ninth aspect, further including a layer dependency flag that indicates types of reference relationships between the target layer and the reference layer, in which the layer dependency type includes a non-VCL dependency type between the non-VCL of the target layer and the non-VCL of the reference layer.

The above image coded data is limited to the expression “the direct reference layer is a reference layer for which the non-VCL dependency type indicates dependency between non-VCLs”. That is, the image coded data is limited to the expression “a reference layer that can be referenced by a target layer is a direct reference layer that has dependency between non-VCLs of the target layer and the direct reference layer”. Therefore, the image coded data can resolve the problem that a non-VCL of a direct reference layer that has dependency between non-VCLs of the target layer and the direct reference layer is destroyed in a sub-bitstream generated by bitstream extraction and that a layer referencing the direct reference layer cannot be decoded.

Image coded data according to a thirteenth aspect of the present invention is characterized in that, in the twelfth aspect, a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB.

The above image coded data is limited to the expression “a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB”. Therefore, the image coded data can resolve the problem that a non-VCL of a direct reference layer having nuh_layer_id equal to nuhLayerIdA is destroyed in a sub-bitstream generated by bitstream extraction and that a layer having nuh_layer_id equal to nuhLayerIdB and referencing the direct reference layer cannot be decoded.

Image coded data according to a fourteenth aspect of the present invention is characterized in that, in the ninth or tenth aspect, the non-VCL dependency type includes the presence of dependency on a shared parameter set.

The above image coded data is limited to the expression “a parameter set that can be referenced as a shared parameter set by a target layer is a parameter set of a direct reference layer for which the non-VCL dependency flags of the target layer and the direct reference layer indicate dependency on a shared parameter set”. Therefore, the image coded data can resolve the problem that a parameter set of a direct reference layer for which the non-VCL dependency types of the target layer and the direct reference layer indicate dependency on a shared parameter set is destroyed in a sub-bitstream generated by bitstream extraction and that a layer referencing the direct reference layer cannot be decoded.

Image coded data according to a fifteenth aspect of the present invention is characterized in that, in the twelfth or thirteenth aspect, the non-VCL dependency type includes the presence of dependency on inter parameter set prediction.

The above image coded data is limited to the expression “a parameter set that can be referenced as inter parameter set prediction by a target layer is a parameter set of a direct reference layer for which the non-VCL dependency flags of the target layer and the direct reference layer indicate dependency on inter parameter set prediction”. Therefore, the image coded data can resolve the problem that a parameter set of a direct reference layer for which the non-VCL dependency types of the target layer and the direct reference layer indicate dependency on inter parameter set prediction is destroyed in a sub-bitstream generated by bitstream extraction and that a layer referencing the direct reference layer cannot be decoded.

Image coded data according to a sixteenth aspect of the present invention is characterized in that, in the ninth to fifteenth aspects, the non-VCL includes a parameter set.

The above image coded data is image coded data that includes a parameter set as a non-VCL. Therefore, the image coded data can resolve the problem that a parameter set of the reference layer is destroyed in a sub-bitstream generated by bitstream extraction and that a layer referencing the reference layer cannot be decoded.

Image coded data according to a seventeenth aspect of the present invention is characterized in that, in the sixteenth aspect, the parameter set includes a sequence parameter set.

The above image coded data is image coded data that includes a sequence parameter set as a parameter set. Therefore, the image coded data can resolve the problem that a sequence parameter set of the reference layer is destroyed in a sub-bitstream generated by bitstream extraction and that a layer referencing the reference layer cannot be decoded.

Image coded data according to an eighteenth aspect of the present invention is characterized in that, in the sixteenth aspect, the parameter set includes a picture parameter set.

The above image coded data is image coded data that includes a picture parameter set as a parameter set. Therefore, the image coded data can resolve the problem that a picture parameter set of the reference layer is destroyed in a sub-bitstream generated by bitstream extraction and that a layer referencing the reference layer cannot be decoded.

Image coded data according to a nineteenth aspect of the present invention is characterized in that, in the eighteenth aspect, the picture parameter set includes a shared SPS utilization flag that indicates whether the sequence parameter set of a non-VCL dependent layer is referenced as a shared parameter set, in which the shared SPS utilization flag, if equal to true, indicates that the sequence parameter set of the non-VCL dependent layer is referenced as a shared parameter set, and the shared SPS utilization flag, if equal to false, indicates that the sequence parameter set of the non-VCL dependent layer is not referenced as a shared parameter set.

According to the above image coded data, it is possible to choose whether to use a shared parameter set related to the SPS in units of pictures. For example, if the optimal parameters of the SPS used in coding of a picture between layers are different from the parameters of the reference layer, referencing the SPS having the layer ID of the target layer with pps_shared_sps_flag=0 in the target layer allows generation of the coded data of a picture in the target layer with a smaller amount of coding. Therefore, the amount of processing related to decoding/coding of the image coded data can be reduced. In addition, referencing the SPS having the layer ID of the reference layer (non-VCL dependent layer) with pps_shared_sps_flag=1 in the target layer allows omission of coding of the SPS having the layer ID of the target layer, thereby leading to a reduction in the amount of coding related to the SPS and a reduction in the amount of processing required for decoding/coding of the SPS.

Image coded data according to a twentieth aspect of the present invention is characterized by, in the nineteenth aspect, further including a slice that constitutes a picture of the target layer, in which a slice header included in the slice includes a shared PPS utilization flag that indicates whether the picture parameter set of the non-VCL dependent layer is referenced as a shared parameter set, the shared PPS utilization flag, if equal to true, indicates that the picture parameter set of the non-VCL dependent layer is referenced as a shared parameter set, and the shared PPS utilization flag, if equal to false, indicates that the picture parameter set of the non-VCL dependent layer is not referenced as a shared parameter set.

According to the above image coded data, it is possible to choose whether to use a shared parameter set related to the PPS in units of pictures. For example, if the optimal parameters of the PPS used in coding of the picture between layers are different from the parameters of the reference layer, referencing the PPS having the layer ID of the target layer with slice_shared_pps_flag=0 in the target layer allows a reduction in the amount of coding of the coded data of the target layer picture and a reduction in the amount of processing related to decoding/coding of the coded data of the target layer picture. In addition, referencing the PPS having the layer ID of the reference layer with slice_shared_pps_flag=1 in the target layer allows omission of coding of the PPS having the layer ID of the target layer, thereby leading to a reduction in the amount of coding related to the PPS and a reduction in the amount of processing required for decoding/coding of the PPS.

Image coded data according to a twenty-first aspect of the present invention is characterized in that, in the seventeenth aspect, the sequence parameter set includes inter-layer pixel correspondence information between a layer having a layer identifier nuhLayerIdB and a direct reference layer for the layer identifier nuhLayerIdB for each layer having the layer identifier nuhLayerIdB and referencing the sequence parameter set of a layer having a layer identifier nuhLayerIdA (nuhLayerIdB>=nuhLayerIdA).

According to the above image coded data, the inter-layer positional correspondence information included in the sequence parameter set includes the number of layers (parameter set referencing layers) that reference the SPS (SPS of the layer having the layer identifier nuhLayerIdA) as a shared parameter set at the time of decoding a sequence belonging to the layer having the layer identifier nuhLayerIdB (nuhLayerIdB>=nuhLayerIdA). Furthermore, the inter-layer positional correspondence information is configured to include pieces of inter-layer pixel correspondence information in number corresponding to the number of layers on which the layer having the layer identifier of each parameter set referencing layer is dependent. Therefore, the above problems arising in the technology of the related art can be resolved. That is, a problem that arises, in a case where a layer having a higher layer identifier than the layer identifier of the SPS (higher layer) references the SPS as a shared parameter set, in that there is no layer pixel correspondence position information between the higher layer and a reference layer for the higher layer is resolved. Therefore, since the inter-layer pixel correspondence information that is required for accurate performance of inter-layer image prediction in the higher layer is included, the effect of an improvement in coding efficiency is accomplished in contrast to the technology of the related art. In addition, since the higher layer can reference the SPS as a shared parameter set without being limited to the case of non-inclusion of the inter-layer image correspondence information (num_scaled_ref_layer_offsets=0), the amount of coding related to the parameter sets of the higher layer can be reduced, and the amount of processing related to decoding/coding of the parameter set can be reduced.

An image coding device according to a twenty-second aspect of the present invention is an image coding device that includes layer identifier coding means for coding a layer identifier, layer dependency flag coding means for coding a layer dependency flag which indicates a reference relationship between a target layer and a reference layer, and non-VCL coding means for coding a non-VCL. The image coding device is characterized by generating coded data that satisfies a conformance condition stating that a layer identifier of a non-VCL that is referenced from a target layer is the same layer identifier as the target layer or a layer identifier of a layer which is directly referenced from the target layer.

The above image coding device generates the coded data in which a non-VCL of a reference layer that can be referenced by a target layer is a non-VCL of a direct reference layer for the target layer. The expression “a non-VCL of a layer that can be referenced by a target layer is a non-VCL having a layer identifier of a direct reference layer for the target layer” means forbidding “reference of a non-VCL of a layer included in a layer set A but not included in a layer set B by a layer in the layer set B which is a subset of the layer set A”.

That is, since “reference of a non-VCL of a layer included in the layer set A but not included in the layer set B by a layer in the layer set B which is a subset of the layer set A” can be forbidden when the layer set B, which is a subset, is extracted from the layer set A by using the bitstream extraction, a non-VCL of a direct reference layer that is referenced by a layer included in the layer set B is not destroyed. Therefore, the image coded data can resolve the problem that a non-VCL of a direct reference layer is destroyed in a sub-bitstream generated by bitstream extraction from the image coded data generated by the image coding device and that a layer referencing the direct reference layer cannot be decoded. That is, the problem that may arise at the time of the bitstream extraction in the technology of the related art described with FIG. 1 can be resolved.

The present invention is not limited to each embodiment described above, and various modifications can be carried out within the scope disclosed in the claims. Embodiments obtained by an appropriate combination of each technical means disclosed in different embodiments are to be included in the technical scope of the present invention.

### SUPPLEMENTARY MATTERS

The present invention can also be represented as follows.

In order to resolve the above problems, an image decoding device according to a first aspect of the present invention is an image decoding device that includes layer identifier decoding means for decoding a layer identifier, layer dependency flag decoding means for decoding a layer dependency flag which indicates a reference relationship between a target layer and a reference layer, and non-VCL decoding means for decoding a non-VCL. The image decoding device is characterized by decoding image coded data that satisfies a conformance condition stating that a layer identifier of a non-VCL that is referenced from a target layer is the same layer identifier as the target layer or a layer identifier of a layer which is directly referenced from the target layer.

The above image decoding device decodes the image coded data that satisfies the expression “a non-VCL of a layer that can be referenced by a target layer is a non-VCL having a layer identifier of a direct reference layer for the target layer”. The expression “a non-VCL of a layer that can be referenced by a target layer is a non-VCL having a layer identifier of a direct reference layer for the target layer” means forbidding “reference of a non-VCL of a layer included in a layer set A but not included in a layer set B by a layer in the layer set B which is a subset of the layer set A”.

That is, since “reference of a non-VCL of a layer included in the layer set A but not included in the layer set B by a layer in the layer set B which is a subset of the layer set A” can be forbidden when the layer set B, which is a subset, is extracted from the layer set A by using the bitstream extraction, a non-VCL of a direct reference layer that is referenced by a layer included in the layer set B is not destroyed. Therefore, what can be resolved is the problem that a non-VCL of a direct reference layer is destroyed in a sub-bitstream generated by bitstream extraction and that a layer referencing the direct reference layer cannot be decoded.

In order to resolve the above problems, an image decoding device according to a second aspect of the present invention is characterized by, in the first aspect, decoding the image coded data that satisfies a conformance condition stating that the layer identifier of the referenced non-VCL is a layer identifier which is indirectly referenced from the target layer.

The above image decoding device decodes the image coded data in which a non-VCL of a reference layer that can be referenced by a target layer is a non-VCL of a direct reference layer or an indirect reference layer for the target layer. Therefore, what can be resolved is the problem that a non-VCL of a direct reference layer or an indirect reference layer is destroyed in a sub-bitstream generated by bitstream extraction and that a layer referencing the direct reference layer or the indirect reference layer cannot be decoded.

In order to resolve the above problems, an image decoding device according to a third aspect of the present invention is characterized by, in the first or second aspect, decoding the image coded data that is characterized in that the reference layer is specified by the layer dependency flag.

The above image coded data is limited to the expression “the direct reference layer or the indirect reference layer is a reference layer that is specified by the layer dependency flag indicating a reference relationship between the target layer and the reference layer”. That is, the image coded data is limited to the expression “a non-VCL of a reference layer that can be referenced by a target layer is a reference layer that is specified by the layer dependency flag indicating a reference relationship between the target layer and the reference layer”. Therefore, the image coded data can resolve the problem that a non-VCL of a direct reference layer or an indirect reference layer specified by the layer dependency flag is destroyed in a sub-bitstream generated by bitstream extraction and that a layer referencing the non-VCL of the direct reference layer or the indirect reference layer cannot be decoded.

In order to resolve the above problems, an image decoding device according to a fourth aspect of the present invention is characterized by, in the first aspect, further including layer dependency type decoding means for decoding a layer dependency type, in which the layer dependency type includes a non-VCL dependency type that indicates the presence of dependency between the non-VCL of the target layer and the non-VCL of the reference layer.

The above image decoding device decodes the image coded data that is limited to the expression “the direct reference layer is a reference layer for which the non-VCL dependency type indicates dependency between non-VCLs”. That is, the image coded data is limited to the expression “a reference layer that can be referenced by a target layer is a direct reference layer that has dependency between non-VCLs of the target layer and the direct reference layer”. Therefore, what can be resolved is the problem that a non-VCL of a direct reference layer that has dependency between non-VCLs of the target layer and the direct reference layer is destroyed in a sub-bitstream generated by bitstream extraction and that a layer referencing the direct reference layer cannot be decoded.

In order to resolve the above problems, an image decoding device according to a fifth aspect of the present invention is characterized by, in the fourth aspect, decoding the image decoded data that satisfies a conformance condition stating that a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB.

The above image decoding device decodes the image coded data that is limited to the expression “a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB”. Therefore, what can be resolved is the problem that a non-VCL of a direct reference layer having nuh_layer_id equal to nuhLayerIdA is destroyed in a sub-bitstream generated by bitstream extraction and that a layer having nuh_layer_id equal to nuhLayerIdB and referencing the direct reference layer cannot be decoded.

In order to resolve the above problems, an image decoding device according to a sixth aspect of the present invention is characterized by, in the fourth or fifth aspect, decoding the image coded data in which the non-VCL dependency type includes the presence of dependency on a shared parameter set.

The above image decoding device decodes the image coded data that is limited to the expression “a parameter set that can be referenced as a shared parameter set by the target layer is a parameter set of a direct reference layer for which the non-VCL dependency types of the target layer and the direct reference layer indicate dependency on a shared parameter set”. Therefore, what can be resolved is the problem that a parameter set of a direct reference layer for which the non-VCL dependency types of the target layer and the direct reference layer indicate dependency on a shared parameter set is destroyed in a sub-bitstream generated by bitstream extraction and that a layer referencing the direct reference layer cannot be decoded.

In order to resolve the above problems, an image decoding device according to a seventh aspect of the present invention is characterized by, in the fourth or fifth aspect, decoding the image coded data in which the non-VCL dependency type includes the presence of dependency on inter parameter set prediction.

The above image decoding device decodes the image coded data that is limited to the expression “a parameter set that can be referenced as inter parameter set prediction by the target layer is a parameter set of a direct reference layer for which the non-VCL dependency types of the target layer and the direct reference layer indicate dependency on inter parameter set prediction”. Therefore, what can be resolved is the problem that a parameter set of a direct reference layer for which the non-VCL dependency types of the target layer and the direct reference layer indicate dependency on inter parameter set prediction is destroyed in a sub-bitstream generated by bitstream extraction and that a layer referencing the direct reference layer cannot be decoded.

In order to resolve the above problems, an image decoding device according to an eighth aspect of the present invention is characterized by, in the first to seventh aspects, decoding the image coded data in which the non-VCL includes a parameter set.

The above image decoding device decodes the parameter set as the non-VCL. Therefore, what can be resolved is the problem that a parameter set of the reference layer is destroyed in a sub-bitstream generated by bitstream extraction and that a layer referencing the reference layer cannot be decoded.

In order to resolve the above problems, image coded data according to a ninth aspect of the present invention is image coded data that is characterized by satisfying a conformance condition stating that a layer identifier of a non-VCL of a reference layer that is referenced from a target layer is the same layer identifier as the target layer or a layer identifier of a direct reference layer for the target layer.

The above image coded data is limited to the expression “a non-VCL of a layer that can be referenced by a target layer is a non-VCL of a direct reference layer for the target layer”. The expression “a non-VCL of a layer that can be referenced by a target layer is a non-VCL having a layer identifier of a direct reference layer for the target layer” means forbidding “reference of a non-VCL of a layer included in a layer set A but not included in a layer set B by a layer in the layer set B which is a subset of the layer set A”.

That is, since “reference of a non-VCL of a layer included in the layer set A but not included in the layer set B by a layer in the layer set B which is a subset of the layer set A” can be forbidden when the layer set B, which is a subset, is extracted from the layer set A by using the bitstream extraction, a non-VCL of a direct reference layer that is referenced by a layer included in the layer set B is not destroyed. Therefore, the image coded data can resolve the problem that a non-VCL of a direct reference layer is destroyed in a sub-bitstream generated by bitstream extraction and that a layer referencing the direct reference layer cannot be decoded.

In order to resolve the above problems, image coded data according to a tenth aspect of the present invention is image coded data that is characterized by, in the ninth aspect, satisfying a conformance condition stating that a layer identifier of a non-VCL of a reference layer that is referenced from the target layer is a layer identifier of an indirect reference layer for the target layer.

The above image coded data is limited to the expression “a non-VCL of a reference layer that can be referenced by a target layer is a non-VCL of a direct reference layer or an indirect reference layer for the target layer”. Therefore, the image coded data can resolve the problem that a non-VCL of a direct reference layer or an indirect reference layer is destroyed in a sub-bitstream generated by bitstream extraction and that a layer referencing the direct reference layer or the indirect reference layer cannot be decoded.

In order to resolve the above problems, image coded data according to an eleventh aspect of the present invention is characterized by, in the ninth or tenth aspect, further including a layer dependency flag that indicates a reference relationship between the target layer and the reference layer, in which the reference layer is specified by the layer dependency flag.

According to the above image coded data, the image coded data that is limited to the expression “the direct reference layer or the indirect reference layer is a reference layer that is specified by the layer dependency flag indicating a reference relationship between the target layer and the reference layer” is decoded. That is, the image coded data is limited to the expression “a non-VCL of a reference layer that can be referenced by a target layer is a reference layer that is specified by the layer dependency flag indicating a reference relationship between the target layer and the reference layer”. Therefore, what can be resolved is the problem that a non-VCL of a direct reference layer or an indirect reference layer specified by the layer dependency flag is destroyed in a sub-bitstream generated by bitstream extraction and that a layer referencing the non-VCL of the direct reference layer or the indirect reference layer cannot be decoded.

In order to resolve the above problems, image coded data according to a twelfth aspect of the present invention is characterized by, in the ninth aspect, further including a layer dependency flag that indicates types of reference relationships between the target layer and the reference layer, in which the layer dependency type includes a non-VCL dependency type between the non-VCL of the target layer and the non-VCL of the reference layer.

The above image coded data is limited to the expression “the direct reference layer is a reference layer for which the non-VCL dependency type indicates dependency between non-VCLs”. That is, the image coded data is limited to the expression “a reference layer that can be referenced by a target layer is a direct reference layer that has dependency between non-VCLs of the target layer and the direct reference layer”. Therefore, the image coded data can resolve the problem that a non-VCL of a direct reference layer that has dependency between non-VCLs of the target layer and the direct reference layer is destroyed in a sub-bitstream generated by bitstream extraction and that a layer referencing the direct reference layer cannot be decoded.

In order to resolve the above problems, image coded data according to a thirteenth aspect of the present invention is characterized in that, in the twelfth aspect, a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB.

The above image coded data is limited to the expression “a layer having nuh_layer_id equal to nuhLayerIdA is a direct reference layer for a layer having nuh_layer_id equal to nuhLayerIdB if a non-VCL having nuh_layer_id equal to a layer identifier nuhLayerIdA of the reference layer is a non-VCL that is used in the target layer having nuh_layer_id equal to nuhLayerIdB”. Therefore, the image coded data can resolve the problem that a non-VCL of a direct reference layer having nuh_layer_id equal to nuhLayerIdA is destroyed in a sub-bitstream generated by bitstream extraction and that a layer having nuh_layer_id equal to nuhLayerIdB and referencing the direct reference layer cannot be decoded.

In order to resolve the above problems, image coded data according to a fourteenth aspect of the present invention is characterized in that, in the ninth or tenth aspect, the non-VCL dependency type includes the presence of dependency on a shared parameter set.

The above image coded data is limited to the expression “a parameter set that can be referenced as a shared parameter set by a target layer is a parameter set of a direct reference layer for which the non-VCL dependency flags of the target layer and the direct reference layer indicate dependency on a shared parameter set”. Therefore, the image coded data can resolve the problem that a parameter set of a direct reference layer for which the non-VCL dependency types of the target layer and the direct reference layer indicate dependency on a shared parameter set is destroyed in a sub-bitstream generated by bitstream extraction and that a layer referencing the direct reference layer cannot be decoded.

In order to resolve the above problems, image coded data according to a fifteenth aspect of the present invention is characterized in that, in the twelfth or thirteenth aspect, the non-VCL dependency type includes the presence of dependency on inter parameter set prediction.

The above image coded data is limited to the expression “a parameter set that can be referenced as inter parameter set prediction by a target layer is a parameter set of a direct reference layer for which the non-VCL dependency flags of the target layer and the direct reference layer indicate dependency on inter parameter set prediction”. Therefore, the image coded data can resolve the problem that a parameter set of a direct reference layer for which the non-VCL dependency types of the target layer and the direct reference layer indicate dependency on inter parameter set prediction is destroyed in a sub-bitstream generated by bitstream extraction and that a layer referencing the direct reference layer cannot be decoded.

In order to resolve the above problems, image coded data according to a sixteenth aspect of the present invention is characterized in that, in the ninth to fifteenth aspects, the non-VCL includes a parameter set.

The above image coded data is image coded data that includes a parameter set as a non-VCL. Therefore, the image coded data can resolve the problem that a parameter set of the reference layer is destroyed in a sub-bitstream generated by bitstream extraction and that a layer referencing the reference layer cannot be decoded.

In order to resolve the above problems, image coded data according to a seventeenth aspect of the present invention is characterized in that, in the sixteenth aspect, the parameter set includes a sequence parameter set.

The above image coded data is image coded data that includes a sequence parameter set as a parameter set. Therefore, the image coded data can resolve the problem that a sequence parameter set of the reference layer is destroyed in a sub-bitstream generated by bitstream extraction and that a layer referencing the reference layer cannot be decoded.

In order to resolve the above problems, image coded data according to an eighteenth aspect of the present invention is characterized in that, in the sixteenth aspect, the parameter set includes a picture parameter set.

The above image coded data is image coded data that includes a picture parameter set as a parameter set. Therefore, the image coded data can resolve the problem that a picture parameter set of the reference layer is destroyed in a sub-bitstream generated by bitstream extraction and that a layer referencing the reference layer cannot be decoded.

In order to resolve the above problems, image coded data according to a nineteenth aspect of the present invention is characterized in that, in the eighteenth aspect, the picture parameter set includes a shared SPS utilization flag that indicates whether the sequence parameter set of a non-VCL dependent layer is referenced as a shared parameter set, in which the shared SPS utilization flag, if equal to true, indicates that the sequence parameter set of the non-VCL dependent layer is referenced as a shared parameter set, and the shared SPS utilization flag, if equal to false, indicates that the sequence parameter set of the non-VCL dependent layer is not referenced as a shared parameter set.

According to the above image coded data, it is possible to choose whether to use a shared parameter set related to the SPS in units of pictures. For example, if the optimal parameters of the SPS used in coding of a picture between layers are different from the parameters of the reference layer, referencing the SPS having the layer ID of the target layer with pps_shared_sps_flag=0 in the target layer allows generation of the coded data of a picture in the target layer with a smaller amount of coding. Therefore, the amount of processing related to decoding/coding of the image coded data can be reduced. In addition, referencing the SPS having the layer ID of the reference layer (non-VCL dependent layer) with pps_shared_sps_flag=1 in the target layer allows omission of coding of the SPS having the layer ID of the target layer, thereby leading to a reduction in the amount of coding related to the SPS and a reduction in the amount of processing required for decoding/coding of the SPS.

In order to resolve the above problems, image coded data according to a twentieth aspect of the present invention is characterized by, in the nineteenth aspect, further including a slice that constitutes a picture of the target layer, in which a slice header included in the slice includes a shared PPS utilization flag that indicates whether the picture parameter set of the non-VCL dependent layer is referenced as a shared parameter set, the shared PPS utilization flag, if equal to true, indicates that the picture parameter set of the non-VCL dependent layer is referenced as a shared parameter set, and the shared PPS utilization flag, if equal to false, indicates that the picture parameter set of the non-VCL dependent layer is not referenced as a shared parameter set.

According to the above image coded data, it is possible to choose whether to use a shared parameter set related to the PPS in units of pictures. For example, if the optimal parameters of the PPS used in coding of the picture between layers are different from the parameters of the reference layer, referencing the PPS having the layer ID of the target layer with slice_shared_pps_flag=0 in the target layer allows a reduction in the amount of coding of the coded data of the target layer picture and a reduction in the amount of processing related to decoding/coding of the coded data of the target layer picture. In addition, referencing the PPS having the layer ID of the reference layer with slice_shared_pps_flag=1 in the target layer allows omission of coding of the PPS having the layer ID of the target layer, thereby leading to a reduction in the amount of coding related to the PPS and a reduction in the amount of processing required for decoding/coding of the PPS.

In order to resolve the above problems, image coded data according to a twenty-first aspect of the present invention is characterized in that, in the seventeenth aspect, the sequence parameter set includes inter-layer pixel correspondence information between a layer having a layer identifier nuhLayerIdB and a direct reference layer for the layer identifier nuhLayerIdB for each layer having the layer identifier nuhLayerIdB and referencing the sequence parameter set of a layer having a layer identifier nuhLayerIdA (nuhLayerIdB>=nuhLayerIdA).

According to the above image coded data, the inter-layer positional correspondence information included in the sequence parameter set includes the number of layers (parameter set referencing layers) that reference the SPS (SPS of the layer having the layer identifier nuhLayerIdA) as a shared parameter set at the time of decoding a sequence belonging to the layer having the layer identifier nuhLayerIdB (nuhLayerIdB>=nuhLayerIdA). Furthermore, the inter-layer positional correspondence information is configured to include pieces of inter-layer pixel correspondence information in number corresponding to the number of layers on which the layer having the layer identifier of each parameter set referencing layer is dependent. Therefore, the above problems arising in the technology of the related art can be resolved. That is, a problem that arises, in a case where a layer having a higher layer identifier than the layer identifier of the SPS (higher layer) references the SPS as a shared parameter set, in that there is no layer pixel correspondence position information between the higher layer and a reference layer for the higher layer is resolved. Therefore, since the inter-layer pixel correspondence information that is required for accurate performance of inter-layer image prediction in the higher layer is included, the effect of an improvement in coding efficiency is accomplished in contrast to the technology of the related art. In addition, since the higher layer can reference the SPS as a shared parameter set without being limited to the case of non-inclusion of the inter-layer image correspondence information (num_scaled_ref_layer_offsets=0), the amount of coding related to the parameter sets of the higher layer can be reduced, and the amount of processing related to decoding/coding of the parameter set can be reduced.

In order to resolve the above problems, an image coding device according to a twenty-second aspect of the present invention is an image coding device that includes layer identifier coding means for coding a layer identifier, layer dependency flag coding means for coding a layer dependency flag which indicates a reference relationship between a target layer and a reference layer, and non-VCL coding means for coding a non-VCL. The image coding device is characterized by generating coded data that satisfies a conformance condition stating that a layer identifier of a non-VCL that is referenced from a target layer is the same layer identifier as the target layer or a layer identifier of a layer which is directly referenced from the target layer.

The above image coding device generates the coded data in which a non-VCL of a reference layer that can be referenced by a target layer is a non-VCL of a direct reference layer for the target layer. The expression “a non-VCL of a layer that can be referenced by a target layer is a non-VCL having a layer identifier of a direct reference layer for the target layer” means forbidding “reference of a non-VCL of a layer included in a layer set A but not included in a layer set B by a layer in the layer set B which is a subset of the layer set A”.

That is, since “reference of a non-VCL of a layer included in the layer set A but not included in the layer set B by a layer in the layer set B which is a subset of the layer set A” can be forbidden when the layer set B, which is a subset, is extracted from the layer set A by using the bitstream extraction, a non-VCL of a direct reference layer that is referenced by a layer included in the layer set B is not destroyed. Therefore, the image coded data can resolve the problem that a non-VCL of a direct reference layer is destroyed in a sub-bitstream generated by bitstream extraction from the image coded data generated by the image coding device and that a layer referencing the direct reference layer cannot be decoded. That is, the problem that may arise at the time of the bitstream extraction in the technology of the related art described with FIG. 1 can be resolved.

### INDUSTRIAL APPLICABILITY

The present invention can be exemplarily applied to a hierarchical moving image decoding device that decodes coded data in which image data is hierarchically coded and to a hierarchical moving image coding device that generates coded data in which image data is hierarchically coded. In addition, the present invention can be exemplarily applied to a data structure of hierarchically coded data that is generated by the hierarchical moving image coding device and referenced by the hierarchical moving image decoding device.

### REFERENCE SIGNS LIST

1 HIERARCHICAL MOVING IMAGE DECODING DEVICE
2 HIERARCHICAL MOVING IMAGE CODING DEVICE
10 TARGET LAYER SET PICTURE DECODING UNIT
11 NAL DEMULTIPLEXER
12 PARAMETER SET DECODING UNIT
13 PARAMETER SET MANAGER
14 PICTURE DECODING UNIT
141 SLICE HEADER DECODING UNIT
142 CTU DECODING UNIT
1421 PREDICTION RESIDUAL RESTORER
1422 PREDICTED IMAGE GENERATOR
1423 CTU DECODED IMAGE GENERATOR
15 DECODED PICTURE MANAGER
20 TARGET LAYER SET PICTURE CODING UNIT
21 NAL MULTIPLEXER
22 PARAMETER SET CODING UNIT
24 PICTURE CODING UNIT
26 CODING PARAMETER DETERMINER
241 SLICE HEADER SETTER
242 CTU CODING UNIT
2421 PREDICTION RESIDUAL CODING UNIT
2422 PREDICTED IMAGE CODING UNIT
2423 CTU DECODED IMAGE GENERATOR

1. An image decoding device that decodes hierarchical image coded data including a plurality of layers, the device comprising:
circuitry that decodes a parameter set;
decodes a slice header;
specifies an active parameter set from the parameter set on the basis of an active parameter set identifier that is included in the slice header or the parameter set;
decodes a direct dependency flag that indicates whether a first layer of the plurality of layers is a direct reference layer for a second layer; and
derives a dependency flag that indicates whether the first layer is a direct reference layer or an indirect reference layer of the second layer, by referencing the decoded direct dependency flag,
wherein a layer identifier of the active parameter set is a layer identifier of a target layer, or a layer identifier of either a direct reference layer or an indirect reference layer of a target layer.

2.-3. (canceled)

4. The image decoding device according to claim 1,
wherein the active parameter set is a picture parameter set that has a PPS identifier equal to an active PPS identifier included in the slice header.

5. The image decoding device according to claim 1,
wherein the active parameter set is a sequence parameter set that has an SPS identifier equal to an active SPS identifier included in the picture parameter set.
